(19) United States
(12) Patent Application Publication
(10) Pub. No.: US 2025/0105881 A1
(43) Pub. Date: Mar. 27, 2025

(54) COMMUNICATION ARRANGEMENT, METHOD OF COMMUNICATION AND COMPUTER PROPGRAM FOR PERFORMING THE SAME

(71) Applicant: HUAWEI TECHNOLOGIES CO., LTD., Shenzhen (CN)

(72) Inventors: Melissa DUARTE GELVEZ, Boulogne Billancourt (FR); Mustapha AMARA, Boulogne Billancourt (FR); Mohamed KAMOUN, Boulogne Billancourt (FR); Sami MEKKI, Boulogne Billancourt (FR)

(73) Assignee: HUAWEI TECHNOLOGIES CO., LTD., Shenzhen (CN)

(21) Appl. No.: 18/967,296

(22) Filed: Dec. 3, 2024

Related U.S. Application Data
(63) Continuation of application No. PCT/EP2022/065163, filed on Jun. 3, 2022.

(51) Int. Cl. H04B 7/04; H04L 27/26

(52) U.S. Cl. CPC H04B 7/04013; H04L 27/2626

(57) ABSTRACT

A communication arrangement, a method for the operation thereof and a computer program including instructions causing a computer to perform the method for the operation of the communication arrangement are disclosed. The communication arrangement includes one or more digitally controllable scatterers, DCSs, an assignment circuitry and a DCS control circuitry. The assignment circuitry is configured to assign a respective base phase shift pattern to each of the one or more DCSs. The DCS control circuitry is configured to operate, during a sequence of time intervals, each DCS of the one or more DCSs to provide a respective sequence of phase shift patterns that is obtained by applying, during each time interval of the sequence of time intervals, a respective additional phase shift from a sequence of additional phase shifts for the respective DCS to the base phase shift pattern assigned to the respective DCS.

### CROSS-REFERENCE TO RELATED APPLICATIONS

This application is a continuation of International Application No. PCT/EP2022/065163, filed on Jun. 3, 2022, the disclosure of which is hereby incorporated by reference in its entirety.

### TECHNICAL FIELD

This application relates to the technical field of communication arrangements, more specifically to communication arrangements including digitally controllable scatterers, and to methods and computer programs for the operation thereof.

### BACKGROUND

In the technical field of radio communication, a capacity of a radio channel between communication nodes (CNs) can be improved by providing multiple antennas in some or all of the communication nodes. Such techniques are denoted as Multiple-Input and Multiple-Output (MIMO) technologies. A CN can, for example, be a Base Station (BS) or a User Equipment (UE). MIMO technologies allow to exploit a spatial diversity of the communication channel of electromagnetic waves for improving channel capacity compared to Single-Input Single-Output (SISO) techniques wherein a single antenna is provided at each communication node.

For further improving radio communication, it has been proposed to move from solutions where channel diversity that occurs due to the propagation of electromagnetic waves in the environment of the communication nodes is exploited to solutions where the communication channel can be manipulated and adapted to specific needs. This can be done by introducing programmable surfaces called Digitally Controllable Scatterers (DCS), wherein a large number of reflective or scattering elements is provided on large surfaces. DCSs can, for example, be implemented in the form of so-called Reflective Intelligent Surfaces (RIS), Intelligent Reflective Surfaces (IRS), or Large Intelligent Surfaces (LIS). The scattering phase shift of each element composing the surface can be controlled on its own. This enables shaping the communication channel by adapting to the requirements and the environment.

FIG. 1 schematically illustrates a DCS 100, a first CN 101, and a second CN102. The CNS 101, 102 can be part of a set of CNs including further CNs which can have features similar to those of the first CN 101 and/or the second CN 102.

The DCS 100 includes a plurality of scattering elements 103, one of which is exemplarily denoted by reference numeral 104 in FIG. 1. The scattering elements 103 are adapted such that incident electromagnetic radiation, in particular electromagnetic radiation in a particular frequency range that is used for radio communication is reflected with a phase shift that can be electronically controlled. Examples of scattering elements include antennas connected to phase shifting circuitry and meta-materials.

In FIG. 1, electromagnetic radiation emitted by the first CN 101 is schematically illustrated by dotted arrows. Electromagnetic radiation from the first CN 101 that is reflected by the DCS 100 towards the second CN 102 is schematically illustrated by dashed arrows. The reflection of electromagnetic radiation at the DCS 100 contributes to a communication channel from the first CN 101 to the second CN 102. The overall communication channel can be decomposed into two main components, which are the non-DCS channel 106, where electromagnetic radiation propagates from the first CN 101 to the second CN 102 without reflection at the DCS 100 and the DCS channel 105 where electromagnetic radiation is reflected at the DCS 100. For resource allocation, it can be desirable to know the direct channel between the first CN 101 and the second CN 102 and the channel 105 via the DCS 105. Additionally, it can be desirable to separate a signal component of a signal transmitted by the first CN 101 that is received by the second CN 102 via the non-DCS channel 106 from a component of the signal transmitted by the first CN 101 that is received by the second CN via the DCS channel 105.

In an arrangement wherein a plurality of DCSs similar to the DCS 100 is provided, there can be a plurality of communication channels between the first CN 101 and the second CN 102. In addition to the non-DCS channel 106, there is a DCS channel similar to the DCS channel 105 via each of the DCSs. Thus, when the first CN 101 transmits a signal, the signal received at the second CN 102 can have signal components received via each of the DCS channels, in addition to a signal component received via the non-DCS channel.

In applications, it can be desirable to estimate each of the DCS channels as well as the non-DCS channel. Knowing the contribution of each DCS to the communication channel can be helpful for the design of communication algorithms that exploit the presence of DCS for improved downlink and uplink performance. However, estimating said contributions may result in undesirable training overhead that reduces the resources allocated for communication. Since the reflective or scattering elements that compose the DCSs are typically not connected to radio frequency (RF) chains, the DCS cannot estimate the propagation conditions and cannot transmit pilots either. This means that the contribution of each DCS to the communication channel can only be measured either at the first CN 101 or at the second CN 102 via signals transmitted by the first CN or the second CN. This complicates the task of characterizing the communication channel via each DCS.

Furthermore, when communication between the first CN 101 and the second CN 102 is performed using a plurality of different frequencies, a separate determination of each of the communication channels may be required for each of the coherence bands.

In the prior art, techniques employing a subsequent activation of individual DCSs as well as techniques employing frequency modulations wherein the phase shifts provided by the scattering elements of the DCSs are modulated in time so that a frequency shift of electromagnetic radiation reflected/scattered at the DCSs is obtained have been proposed. However, the techniques according to the state of the art are not efficient in time resource utilization for channel estimation and/or can have difficulties relating to the allocation of frequency resources associated therewith. Employing frequency modulations can lead to a relatively large spectral noise, since the phase shifts that can be applied at the scattering elements of the DCSs may be limited to a small number of different values for implementation simplicity purposes. This may compromise the quality of DCS-based frequency modulations.

In other prior art techniques, codes are used for creating a phase modulation of the individual scattering elements of the DCSs, wherein the phase shift provided by each scattering element in a DCS is modulated differently in time in accordance with a codeword of the respective scattering element. In such techniques, codewords that are orthogonal between different time intervals for each DCS and between different scattering elements of each DCS are used. The number of codewords and the length of the codewords is, thus, on the order of magnitude of the number of scattering elements of the DCSs, so that a very large number of very long codewords is required. Additionally, applying different phase modulations to the phase shifts of the individual scattering elements in a DCS changes the scattering pattern of the DCS between time intervals, which can have the consequence that scattering patterns which are undesirable in view of a signal-to-noise ratio are obtained in some time intervals. Furthermore, in solutions according to the state of the art, applying the DCS coding requires an extra overhead since it is applied during dedicated training periods.

### SUMMARY

The present disclosure provides communication arrangements and methods of communication over a plurality of frequency resources which help to address some or all of the above-mentioned issues. In particular, in embodiments disclosed herein, channel qualities of non-DCS and DCS communication channels can be measured on the same resources while communicating, and signals received via non-DCS and DCS communication channels can be obtained while communicating through these signals. Additionally, channel estimates of non-DCS and DCS communication channels can be determined by using the information contained in the signals.

According to a first aspect, a communication arrangement includes one or more digitally controllable scatterers, DCSs, an assignment circuitry and a DCS control circuitry. The assignment circuitry is configured to assign a respective base phase shift pattern to each of the one or more DCSs. The DCS control circuitry is configured to operate, during a sequence of time intervals, each DCS of the one or more DCSs to provide a respective sequence of phase shift patterns that is obtained by applying, during each time interval of the sequence of time intervals, a respective additional phase shift from a sequence of additional phase shifts for the respective DCS to the base phase shift pattern assigned to the respective DCS.

In a possible implementation, each of the one or more DCSs includes a plurality of scattering elements. The base phase shift pattern assigned to the respective DCS defines a respective phase shift value for each scattering element of at least a part of the plurality of scattering elements of the respective DCS. For each time interval of the sequence of time intervals, applying the respective additional phase shift from the sequence of additional phase shifts for the respective DCS to the base phase shift pattern assigned to the respective DCS includes adding, for each scattering element of the at least a part of the plurality of scattering elements, the respective additional phase shift for the respective time interval from the sequence of additional phase shifts for the respective DCS to the phase shift value for the respective scattering element defined by the base phase shift pattern.

In a possible implementation, for at least one of the one or more DCSs, the at least a part of the plurality of scattering elements of the respective DCS is a first part of the plurality of scattering elements of the respective DCS. A second part of the plurality of scattering elements of the respective DCS provides a virtual DCS. The assignment circuitry is configured to assign a base phase shift pattern of the virtual DCS to the virtual DCS. The base phase shift pattern of the virtual DCS defines a respective phase shift value for each scattering element of the second part of the plurality of scattering elements. The DCS control circuitry is configured to add, during each time interval of the sequence of time intervals, a respective additional phase shift from a sequence of additional phase shifts for the virtual DCS to each of the phase shift values for the scattering elements of the second part of the plurality of scattering elements that are defined by the base phase shift pattern for the virtual DCS. The sequence of additional phase shifts for the virtual DCS is different from the sequence of additional phase shifts for the respective DCS.

In a possible implementation, the assignment circuitry is further configured to assign a respective codeword from a set of codewords to each of the one or more DCSs. For each DCS, the sequence of additional phase shifts for the respective DCS is based on a sequence of codeword components of the codeword assigned to the respective DCS.

In a possible implementation, the one or more DCSs are a plurality of DCSs, and each DCS is assigned a different codeword from the set of codewords.

In a possible implementation, the codewords from the set of codewords are at least one of orthogonal and semi-orthogonal.

In a possible implementation, for each of the one or more DCSs, each additional phase shift of the sequence of additional phase shifts for the respective DCSs is selected such that by applying the respective additional phase shift to the base phase shift pattern assigned to the respective DCS, a phase shifted scattering pattern of the DCS is obtained which corresponds to a product of a codeword component of the codeword assigned to the respective DCS and a base scattering pattern of the DCS that is obtained when the DCS provides the base phase shift pattern of the DCS.

In a possible implementation, the communication arrangement further includes signal component separation circuitry. The signal component separation circuitry is configured to obtain reception information from one or more first communication nodes, CNs. The reception information is based on a reception, by the one or more first CNs, of one or more transmission signals transmitted by one or more second CNs during the sequence of time intervals. The reception information includes a representation of at least a part of one or more signals received by the one or more first CNs in response to the transmission of the one or more transmission signals by the one or more second CNs during the sequence of time intervals. The signal component separation circuitry is configured to apply a transformation to the representation of the at least a part of the one or more signals received by the one or more first CNs to separate one or more signal components of the at least a part of the one or more signals that were received by the one or more first CNs via the one or more DCSs.

In a possible implementation, the transformation is a linear transformation.

In a possible implementation, the communication arrangement further includes channel estimation circuitry. The channel estimation circuitry is configured to compute, on the basis of the reception information and the set of codewords, a channel estimate. The channel estimate includes, for at least one DCS of the one or more DCSs, an estimate of at least one respective communication channel between at least one of the one or more first CNs and at least one of the one or more second CNs via the at least one of the one or more DCSs.

In a possible implementation, the channel estimation circuitry is further configured to compute a representation of the one or more transmission signals transmitted by the one or more second CNs on the basis of an aggregate communication channel and a result of the transformation, and to compute the channel estimate on the basis of the computed one or more transmission signals and the result of the transformation.

In a possible implementation, the time intervals of the sequence of time intervals are subintervals of a coding time interval.

In a possible implementation, at least one of the one or more second CNs transmits a plurality of orthogonal frequency division multiplexing, OFDM, symbols during the coding time interval.

In a possible implementation, each of the one or more second CNs has one or more antennas. Each of the one or more second CNs transmits, during each time interval of the sequence of time intervals, a number of OFDM symbols that corresponds to a total number of the antennas of the one of more second CNs.

In a possible implementation, the transformation is based on a set of conjugate codewords for the set of codewords.

In a possible implementation, at least one of the one or more second CNs transmits a single OFDM symbol during the coding time interval.

In a possible implementation, the applying of the additional phase shifts of the sequence of additional phase shifts is repeated during each of a plurality of coding time intervals. The reception information is based on a reception, by the one or more first CNs, of one or more transmission signals transmitted by the one or more second CNs during the plurality of coding time intervals. The transformation is applied to a representation of the received one or more transmission signals.

In a possible implementation, each of the one or more second CNs has one or more antennas. Each of the one or more second CNs transmits a single OFDM symbol during each coding time interval of the plurality of coding time intervals. A number of the plurality of coding time intervals corresponds to a total number of the antennas of the one or more first CNs.

In a possible implementation, the transformation is based on a model of phase variations induced by the application of the sequence of additional phase shifts during the transmission of the single OFDM symbol.

In a possible implementation, the coding time interval corresponds to a sampling interval wherein the one or more signals received by the one or more first CNs in response to the transmission of the one or more transmission signals by the one or more second CNs are sampled.

In a possible implementation, at least one of the one or more first CNs is a user equipment and at least one of the one or more second CNs is a base station.

In a possible implementation, at least one of the one or more first CNs is a base station and at least one of the one or more second CNs is a user equipment.

According to a second aspect, in a method of communication, a respective base phase shift pattern is assigned to each of one or more DCSs. During a sequence of time intervals, each DCS of the one or more DCSs is operated to provide a respective sequence of phase shift patterns that is obtained by applying, during each time interval of the sequence of time intervals, a respective additional phase shift from a sequence of additional phase shifts for the respective DCS to the base phase shift pattern assigned to the respective DCS.

According to a third aspect, a computer program includes instructions which, when carried out on a computer, cause the computer to perform the method according to the second aspect.

### BRIEF DESCRIPTION OF DRAWINGS

In the following, embodiments will be described with reference to the drawings, wherein:

FIG. 1 shows communication channels in an arrangement including a DCS and two CNs;

FIG. 2 shows a communication arrangement;

FIG. 3 shows a CN;

FIG. 4 shows a DCS;

FIGS. 5a to 5d show configurations of scattering surfaces of DCSs;

FIG. 6 shows a timing diagram illustrating an embodiment wherein a DCS applies a coded scattering pattern sequence during a transmission of a plurality of orthogonal frequency division multiplexing (OFDM) symbols during a coding time interval;

FIG. 7 shows a timing diagram illustrating a signal sent by a BS on a subcarrier and a signal received at a UE during OFDM symbols without DCS coding outside a coding time interval and with coding during a coding time interval for a downlink SISO case;

FIG. 8 shows a timing diagram illustrating an embodiment wherein a DCS applies a coded scattering pattern sequence during a transmission of a plurality of downlink OFDM symbols during a coding time interval;

FIG. 9 shows a timing diagram illustrating a signal sent by a BS on a subcarrier and a signal received at a UE during OFDM symbols without DCS coding outside a coding time interval and with DCS coding during a coding time interval for a downlink MIMO case;

FIG. 10 shows a timing diagram illustrating an embodiment wherein a DCS applies a coded scattering pattern sequence during a transmission of a plurality of OFDM symbols by a UE in uplink during a coding time interval;

FIG. 11 shows a timing diagram illustrating a signal sent by a UE on a subcarrier and a signal received at a BS from the UE during OFDM symbols without coding outside a coding time interval and with DCS coding during a coding time interval for an uplink MIMO case;

FIG. 12 shows a timing diagram illustrating an embodiment wherein a DCS applies a coded scattering pattern sequence during one downlink OFDM symbol which corresponds to a coding time interval;

FIG. 13 shows a timing diagram illustrating an embodiment wherein a DCS applies a coded scattering pattern sequence during each of a plurality of OFDM symbols, each of which corresponds to one of a plurality of coding time intervals;

FIG. 14 shows a timing diagram illustrating an embodiment wherein a DCS applies a coded scattering pattern sequence during each of a plurality of OFDM symbols, each of which corresponds to one of a plurality of coding time intervals;

FIG. 15 shows a timing diagram illustrating an embodiment wherein a DCS applies a coded scattering pattern sequence during a sampling time interval which corresponds to a coding time interval;

FIG. 16 illustrates signaling according to an embodiment in a downlink scenario wherein a BS performs the configuration steps and uses signaling to inform DCSs and UEs after all the configuration steps are completed;

FIG. 17 illustrates signaling according to an embodiment in a downlink scenario wherein the BS performs the configuration steps and uses multiple signaling to inform DCSs and UEs after each configuration step is completed;

FIG. 18 illustrates signaling according to an embodiment in a downlink scenario wherein one DCS performs the configuration steps and uses multiple signaling to inform the other DCSs and UEs after each configuration step is completed;

FIG. 19 illustrates signaling according to an embodiment in an uplink scenario wherein a BS performs the configuration steps and uses signaling to inform DCSs and UEs after all the configuration steps are completed;

FIG. 20 illustrates signaling according to an embodiment in an uplink scenario wherein a BS performs the configuration steps and uses multiple signaling to inform DCSs and UEs after each configuration step is completed;

FIG. 21 illustrates signaling according to an embodiment in an uplink scenario wherein one DCS performs the configuration steps and uses multiple signaling to inform the other DCSs and UEs after each configuration step is completed; and

FIGS. 22, 23 and 24 illustrate signaling in embodiments wherein configuration steps are performed by extra logical entities.

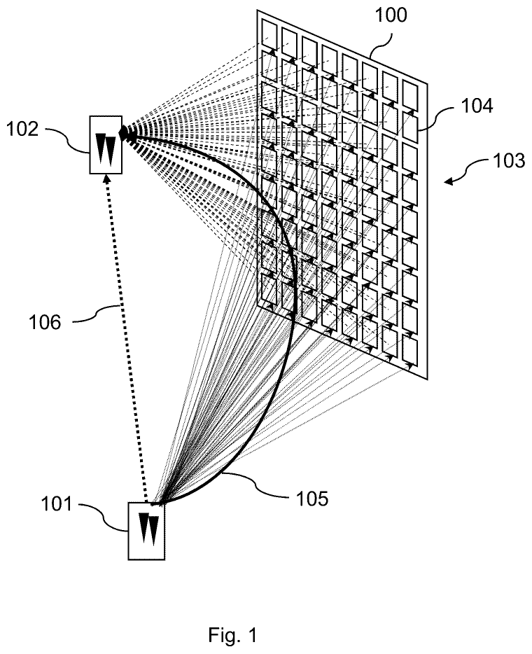

### DESCRIPTION OF EMBODIMENTS

The present disclosure provides embodiments of communication arrangements, methods of communication and computer programs wherein digitally controllable scatterers (DCSs) are used. In embodiments disclosed herein, during a sequence of time intervals, each DCS of one or more DCSs is operated to provide a respective sequence of phase shift patterns that is obtained by applying, during each time interval of the sequence of time intervals, a respective additional phase shift from a sequence of additional phase shifts for the respective DCS to the base phase shift pattern of the respective DCS.

The base phase shift pattern of each DCS is modified only by applying additional phase shifts, so that the resulting radiation pattern of the DCS is a phase shifted version of the pattern obtained when applying the base phase shift pattern.

The sequence of phase shift patterns can be provided on the basis of codes. In each time interval, only one scalar component per DCS is required for providing the additional phase shift for the DCS which is the same for all scattering elements of the DCS. Accordingly, providing only one codeword for each DCS is sufficient, and orthogonality or semi-orthogonality is required only between codewords of different DCSs, but not between individual scattering elements of one DCS. Thus, relatively short codewords can be used since the codeword length does not depend on the number of scattering elements, which is a desirable feature since the number of elements can be quite large (hundreds/thousands).

The coding can be applied during the transmission of data and more than one DCS can be active in each time interval, so that the overall overhead of DCS channel quality measurement can be reduced. Furthermore, in embodiments, codes such as, for example, Hadamard codes can be used. In Hadamard codes each component of the codeword is limited to only a small number (two) of possible values. This means that each phase shift in the sequence of additional phase shifts is limited to only a small number (two) of possible values. This can simplify the implementation.

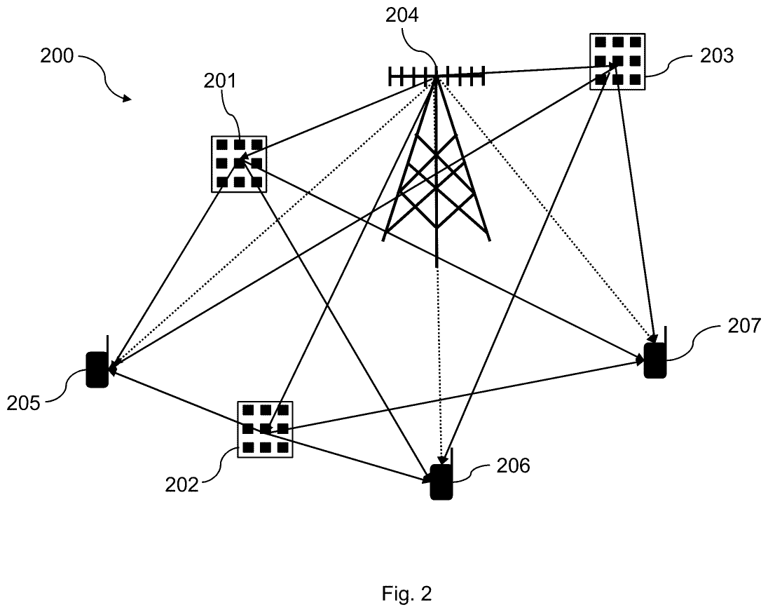

FIG. 2 shows a schematic view of a communication arrangement 200 according to an embodiment. The communication arrangement 200 includes a plurality of DCSs 201, 202, 203 and a plurality of communication nodes (CNs) 204, 205, 206, 207. As shown in FIG. 2, the CN 204 can be a base station (BS) and the CNs 205-207 can be user equipments (UEs) or repeaters. A communication channel between BS 204 and the UEs 205-207 is in part via the DCSs 201, 202, 203. The wireless signals between the BS 204 and UEs 205-207 propagate via non-DCS paths that are illustrated by dotted line arrows and via DCS paths that are illustrated by solid line arrows.

The present disclosure is not limited to embodiments wherein one BS and a plurality of CNs are provided, as shown in FIG. 2. For example, the plurality of CNs 204-207 can include more than one BS, or all the CNs can be UEs. It can also include repeaters, IABs and other network components. Generally, there can be K UEs and D DCSs. In addition to one or more BSs and one or more UEs, the plurality of CNs can include one or more access points (APs).

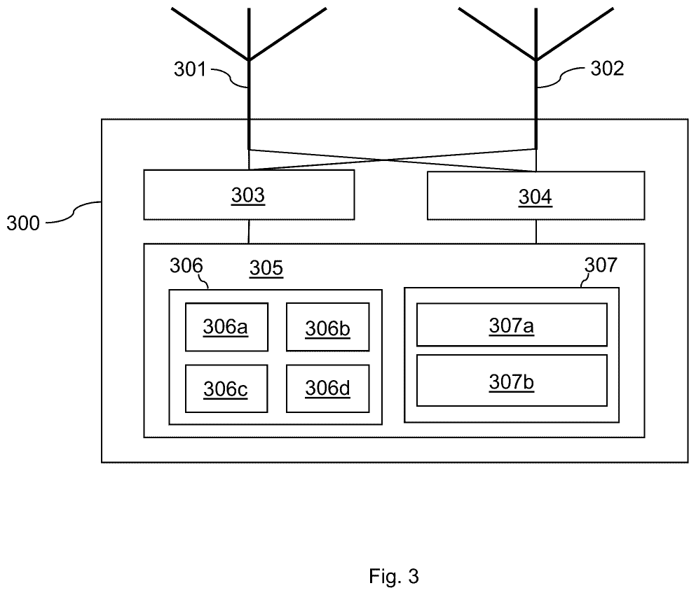

FIG. 3 shows a schematic block diagram of a CN 300 according to an embodiment. The CN 300 can be a UE such as, for example, one of the CNs 205-207 shown in FIG. 2, or a BS such as, for example the BS 204 shown in FIG. 2. The CN 300 can include antennas 301, 302. The number of antennas can be one or two, as shown in FIG. 3. In other embodiments, a greater number of antennas can be provided. Providing two or more antennas can allow performing communication in accordance with multiple input, multiple output (MIMO) technologies. In further embodiments, for example in embodiments wherein the CN 300 is a UE, a single antenna can be provided. However, UEs having more than one antenna can also be used.

The CN 300 can include transmitter circuitry 303 and receiver circuitry 304, which are connected to the antennas 301, 302, and can be used for transmitting and/or receiving pilot signals and data signals for transmitting and/or receiving various types of information. Additionally, the CN 300 can include computation circuitry 305, which can include a processor and memory. The computation circuitry 305 can be used for carrying out various algorithms, as will be described below. The computation circuitry 305 can be used for performing various types of data processing at the CN 300 when methods of communication using the CN are carried out as described in detail below, so that the computation circuitry 305 can be configured so as to include circuitry for various purposes.

In embodiments, the computation circuitry 305 can include assignment circuitry 306. Additionally, the computation circuitry 305 includes signal component separation and channel estimation circuitry 307. The assignment circuitry can include base phase shift pattern assignment circuitry 306a, codeword assignment circuitry 306b, coding time interval assignment circuitry 306c and transmission signal assignment circuitry 306d. The signal component separation and channel estimation circuitry can include signal component separation circuitry 307a and, in embodiments, channel estimation circuitry 307b.

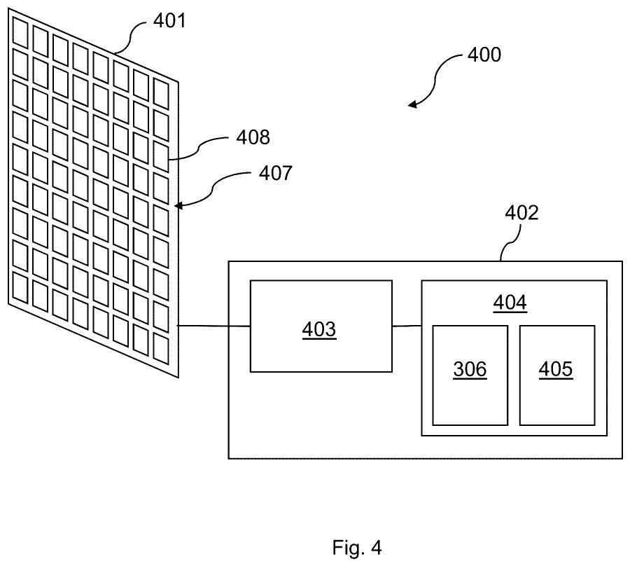

The present disclosure is not limited to embodiments wherein the assignment circuitry 306 is provided in a CN. In other embodiments, the assignment circuitry 306 can be provided in a DCS, as will be described in more detail below with reference to FIG. 4. In still further embodiments, the assignment circuitry or at least parts thereof can be provided in network entities that are different from CNs and DCSs. For example, the base phase shift pattern assignment circuitry 306a can be provided in a DCS control entity, the codeword assignment circuitry 306b and the coding time assignment circuitry 306c can be provided in a channel estimation entity and the transmission signal assignment circuitry 306d can be provided in the CN. In some embodiments wherein a channel estimation entity is provided, the signal component separation and channel estimation circuitry 307 or at least parts thereof can also be provided in the channel estimation entity.

Furthermore, the present disclosure is not limited to embodiments wherein the assignment circuitry 306 and the signal component separation and channel estimation circuitry 307 are provided in all CNs of the communication arrangement. For example, they can be provided in only one of the CNs which can be a BS or a UE.

FIG. 4 schematically illustrates a DCS 400 which can be implemented in the form of an Intelligent Reflective Surface (IRS) or Reflective Intelligent Surface (RIS). In embodiments, some or all of the DCSs 201, 202, 203 of the communication arrangement 200 can have features corresponding to those of the DCS 400. The DCS 400 includes a scattering surface 401 and a controller 402. The scattering surface 401 includes a plurality of scattering elements 407, one of which is exemplarily denoted by reference numeral 408. The plurality of scattering elements 407 can be adapted such that scattering phase shifts of the scattering elements of the plurality of scattering elements 407 (which will be denoted as “scattering elements 407” in the following) for electromagnetic radiation are electronically controllable. In some embodiments, each of the scattering elements 407 can include an antenna based scattering circuitry and phase shifting circuitry. The phase shift provided by the phase shifting circuitry can be electronically controlled so as to provide the scattering phase shift of the scattering element. In other embodiments, the scattering elements 407 can include meta-material elements configured to provide a scattering phase shift for electromagnetic radiation in the predetermined frequency range that can be electronically controlled. By controlling the scattering phase shifts of the scattering elements 407, directions into which electromagnetic radiation impinging on the scattering surface 401 of the DCS is scattered and a phase of the scattered electromagnetic radiation can be controlled.

The DCS 400 can further include a controller 402. The controller 402 can include interface circuitry 403 for connecting the controller 403 to the scattering elements 407 of the DCS 400, and computation circuitry 404, which can include a processor and a memory so that the computation circuitry 404 can be configured as circuitry for various purposes. The computation circuitry 404 can include assignment circuitry 306 which can have features as described above with reference to FIG. 3. In particular, the assignment circuitry 306 can include base phase shift pattern assignment circuitry 306a, codeword assignment circuitry 306b, coding time interval assignment circuitry 306c and/or transmission signal assignment circuitry 306d (see FIG. 3). Additionally, the computation circuitry 404 can include DCS control circuitry 405.

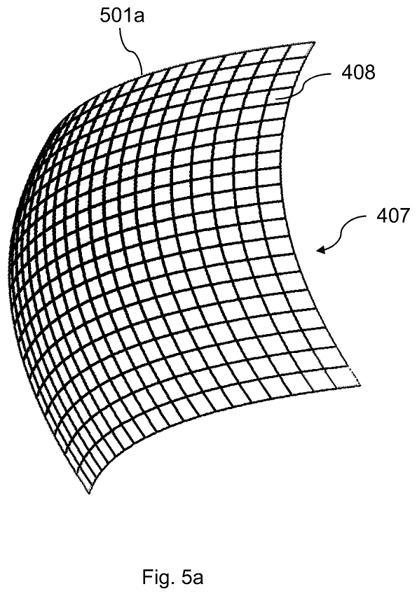

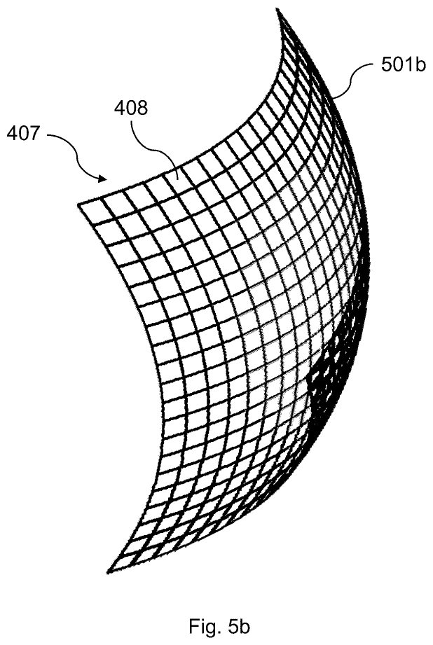

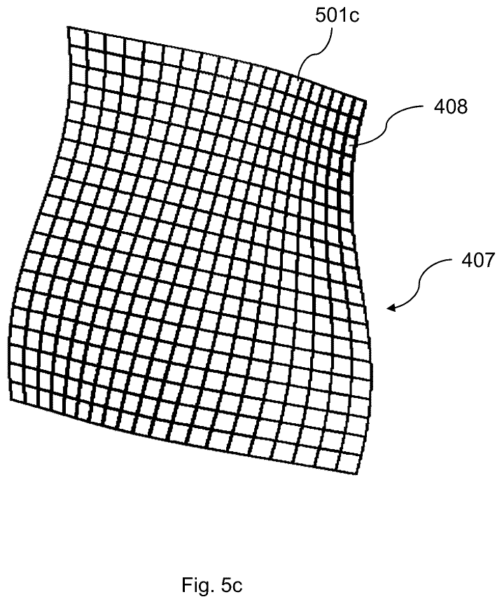

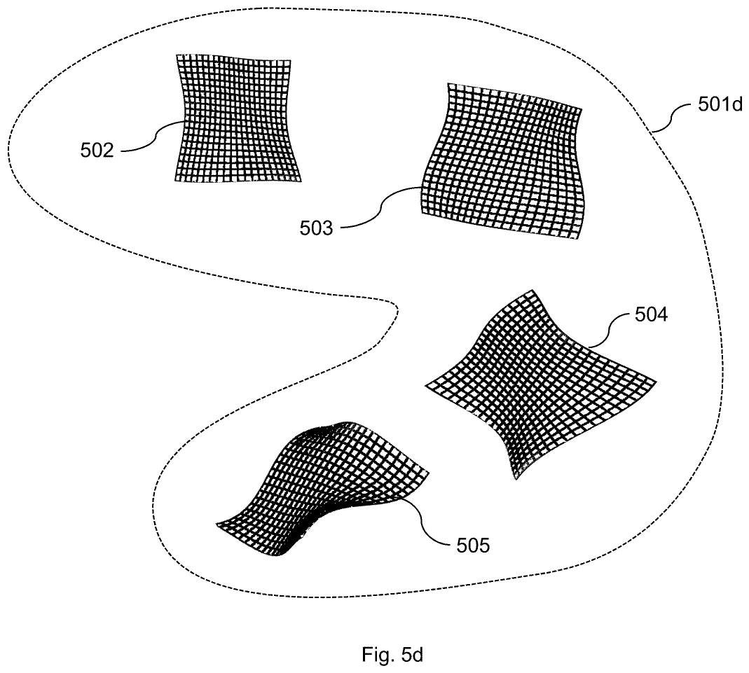

The present disclosure is not limited to embodiments wherein each of the DCSs 201, 202, 203 has a scattering surface 401 that is substantially planar, as shown in FIG. 4. In other embodiments, some or all of the DCSs can include scattering surfaces having a non-planar configuration, as will be described in the following with reference to FIGS. 5a, 5b and 5c.

FIG. 5a schematically illustrates a scattering surface 501a, which can be used as an alternative to the scattering surface 401 of the DCS 400 shown in FIG. 4. The scattering surface 501a includes a plurality of scattering elements 407, one of which is exemplarily denoted by reference numeral 408. The scattering surface 501a has a non-planar configuration, wherein a front side of the scattering surface 501a is convex. The front side of the scattering surface 501a is the side on which, in the operation of the DCS 400, the electromagnetic radiation reflected at the scattering surface 501a impinges. For example, in embodiments, the scattering surface 501a can be mounted on a wall of a building. In such embodiments, the front side of the scattering surface 501a is the side of the scattering surface that is averted from the wall.

FIG. 5b schematically illustrates a scattering surface 501b, which can be used as another alternative to the scattering surface 401 of the DCS 400 shown in FIG. 4. The scattering surface 501b includes a plurality of scattering elements 407, one of which is exemplarily denoted by reference numeral 408. The scattering surface 501b has a non-planar configuration, wherein the front side of the scattering surface 501b is concave.

FIG. 5c schematically illustrates a scattering surface 501c, which can be used as a further alternative to the scattering surface 401 of the DCS 400 shown in FIG. 4. The scattering surface 501c includes a plurality of scattering elements 407, one of which is exemplarily denoted by reference numeral 408. The scattering surface 501c has a non-planar configuration, wherein the front side of the scattering surface 501c includes portions having a different curvature. For example, the front side of the scattering surface 501c can include convex portions, concave portions and/or saddle-shaped portions.

Moreover, the present disclosure is not limited to embodiments wherein the scattering surface of the DCS 400 is provided as a single piece. FIG. 5d schematically illustrates a scattering surface 501d, which can be used as a further alternative to the scattering surface 401 of the DCS 400 shown in FIG. 4. The scattering surface 501d includes a plurality of DCS blocks 502, 503, 504, 505, which can be distributed. Thus, the scattering surface 501d is not provided as a single piece. The scattering surface 501d includes a plurality of scattering elements, wherein each of the DCS blocks 502-505 includes a subset of the scattering elements. The DCS blocks 502-505 can have a non-planar configuration, as shown in FIG. 5d. In other implementations, some or all of the DCS blocks 502-505 can be planar. The scattering elements of the DCS blocks 502-505 can be operated in a coordinated manner, so that the scattering surface 501d is provided as a virtual DCS scattering surface.

Referring to FIG. 2 again, the controllable scattering phase shifts of the scattering elements of each of the DCSs 201, 202, 203 provide a way to modify the scattering pattern of the respective DCS, and hence to modify the communication channel between the BS 204 and the UEs 205-207 in order to improve the downlink and uplink communication. Knowing the contribution of each DCS 201, 202, 203 to the overall communication channel between the BS 204 and each UE 205-207 can be important for designing the communication algorithms that exploit the presence of DCSs 201-203 for improved downlink and uplink performance. The achieved improvement depends on the available channel state information (CSI).

Embodiments described herein provide solutions for estimating the contribution of each DCS 201, 202, 203 to the overall communication channel between BS 204 and UEs 205-207. This can be a challenging task, in particular when the scattering elements of the DCSs 201-203 are not connected to radio frequency (RF) chains. In this case, the DCSs 201-203 cannot estimate propagation conditions and cannot transmit pilot signals either. This means that the contribution of each DCS 201, 202, 203 to the overall communication channel can only be measured either at the BS 204 or at the UEs 205-207 via signals transmitted either by the BS 204 or the UEs 205-207. This complicates the task of characterizing the overall communication channel via each of the DCSs 201, 202, 203.

In the following, the index d will be used to denote the DCSs. The total number of DCSs will be denoted as D and the number of scattering elements of DCS d will be denoted as S_{d}. The index k will be used to denote user equipments (UEs) and the total number of UEs will be denoted as K.

The phase shift pattern of the S_{d} scattering elements of DCS d can be represented by a vector ϕ_{d} whose components are the scattering phase shifts provided by the individual scattering elements of DCS d. The controllable phase shift pattern configuration of the scattering elements provides a way to control the scattering pattern of the DCSs and hence to modify the communication channel between the BS and the UEs in order to improve the downlink and uplink communication. In the following, the scattering pattern obtained by providing the phase shift pattern represented by ϕ_{d} at DCS d will be denoted as F_{d}(ϕ_{d}). In the downlink, the signal received from the BS at the k^{th} UE can be modeled as

$${y}_{k} = {y}_{0 , k} + {\sum }_{d = 1}^{D} {y}_{{DCS}_{d} , k} , \qquad Equation ( 1 )$$

where y_{0,k} represents the signal received via the non-DCS paths and y_{DCS}_{_{d}}_{,k} represents the signal received via DCS d. In the uplink, a model like the one in Equation (1) can also be used to describe the signal received at the BS from the k^{th} UE. Observing yₖ provides only information about the aggregate received signal, that is, the sum of the contributions of all DCS and non-DCS paths. Obtaining the decomposed information related to the signal component y_{0,k} received via the non-DCS channel and the signal components from the D DCSs, namely y_{DCS}_{₁}_{,k}, y_{DCS}_{₂}_{,k}, . . . , y_{DCS}_{_{D}}_{,k} is of interest because it facilitates knowing the contribution of each DCS and hence facilitates estimating the communication channel via each DCS.

The present disclosure provides a DCS coding scheme that allows a receiver to obtain an estimate of the received non-DCS signal component y_{0,k} and all signal components y_{DCS}_{₁}_{,k}, y_{DCS}_{₂}_{,k}, . . . , y_{DCS}_{_{D}}_{,k} received through the D DCSs using only the aggregate received signal yₖ described in Equation (1) and the knowledge of the coding used at the different DCSs.

Furthermore, the present disclosure provides a way to estimate both the non-DCS and DCS channels using the obtained signals y_{0,k}, y_{DCS}_{₁}_{,k}, y_{DCS}_{₂}_{,k}, . . . , y_{DCS}_{_{D}}_{,k}. In embodiments, this can be done when these signals carry data information instead of training or pilot signals. The present disclosure provides a way to decompose and obtain the contribution from each DCS to the received signal and to estimate the non-DCS and DCS channels.

In embodiments, some or all of the following steps can be performed.

### 1. Base Phase Shift Pattern Assignment Step

In the base phase shift pattern assignment step, a respective base phase shift pattern ϕ_{d} is assigned to each DCS d=1, 2, . . . , D. The base phase shift pattern ϕ_{d} can define a respective phase shift value for at least a part of the scattering elements of the DCS d. In embodiments, the base phase shift pattern ϕ_{d} can define a respective phase shift value for each of the scattering elements of the DCS d. Thus, a base scattering pattern F_{d} (ϕ_{d}) is set for each DCS. The base scattering pattern F_{d} (ϕ_{d}) of DCS d is a scattering pattern that is obtained when the DCS is operated to provide the base phase shift pattern ϕ_{d}, which can be done by controlling the scattering phase shifts of the scattering elements of the DCS d so that they provide the phase shift values defined by the base phase shift pattern ϕ_{d}. The coding for each DCS will be applied on top of the base scattering pattern. If the base phase shift pattern is assigned by a network entity different from the DCSs, then signaling is performed to inform the DCSs of the defined base phase shift patterns. In embodiments, the base phase shift pattern assignment step can be performed by the base phase shift pattern assignment circuitry 306a of the assignment circuitry 306 described above with reference to FIGS. 3 and 4.

### 2. Codeword Assignment Step

In the codeword assignment step, a respective codeword from a set of codewords is assigned to each DCS d=1, 2, . . . , D. This can be done by choosing D orthogonal or semi-orthogonal codewords of length T and assigning to each DCS d=1, 2, . . . , D one of the codewords. Different DCSs are assigned different codewords. The codewords are vectors of size 1×T and can be represented in a codebook structure [symbol] as in Equation (2):

$$𝒞 = {\vec{[ \begin{matrix}{c}_{1}^{1} & ⋯ & {c}_{1}^{T} \\ ⋮ & ⋱ & ⋮ \\ {c}_{D}^{1} & ⋯ & {c}_{D}^{T}\end{matrix} ] ↓}}^{T time intervals} D Codewords \qquad Equation ( 2 )$$

In the following, c_{d} is used to denote the codeword assigned to DCS d. This codeword is represented by a vector c_{d}=[c_{d}¹, c_{d}², . . . c_{d}^{T}], the components of which define a sequence of codeword components c_{d}¹, c_{d}², . . . c_{d}^{T}. Signaling can be performed to inform each DCSs of its assigned codeword. In embodiments, the codeword assignment step can be performed by the codeword assignment circuitry 306b of the assignment circuitry 306 described above with reference to FIGS. 3 and 4.

### 3. Coding Time Interval Assignment Step

In the coding time interval assignment step, one or more coding time intervals, which, in the following, will be denoted as T, are defined. A coding time interval is a time interval during which all D DCS devices will apply the codewords chosen in the codeword assignment step to the base phase shift pattern chosen in the base phase shift pattern assignment step.

Signaling can be used to inform the DCSs of the one or more coding time intervals. As will be described in more detail in the embodiments below, since the codewords have a length T, each coding time interval includes a sequence of T time intervals τ₁, . . . , τ_{T} which are subintervals of the respective coding time interval. In the DCS operating step, which will be described below, during each of the time intervals τ₁, . . . , τ_{T}, an additional phase shift from a sequence of additional phase shifts that is based on the sequence of codeword components c_{d}¹, . . . c_{d}^{T} is applied to the base phase shift pattern ϕ_{d} of DCS d, d=1, 2, . . . , D. Thus, a sequence of phase shift patterns of the DCS d is provided. In embodiments with more than one coding time interval, the applying of the additional phase shifts is repeated during each of the coding time intervals. The duration of the one, τ₁, or more, τ₁, τ₂, τ₃, . . . coding time intervals therefore depends on the length T of the codewords and the duration of the time interval τₜ, which is the time interval during which the DCSs d=1, 2, . . . , D apply each the corresponding codeword component [symbol] . In embodiments, the one or more coding time intervals assignment step can be performed by the coding time interval assignment circuitry 306c of the assignment circuitry 306 described above with reference to FIGS. 3 and 4.

### 4. Transmission Signal Assignment Step

In the transmission signal assignment step, the signal that will be transmitted by one or more transmitting CNs during the one, τ₁, or more, τ₁, τ₂, τ₃, . . . coding time intervals is defined. If the transmission is in the downlink, then the signal transmitted by the BS is defined in the transmission signal assignment step. If the transmission is in the uplink, then the signal transmitted by the UEs is defined in the transmission signal assignment step. In some embodiments, a plurality of orthogonal frequency division multiplexing (OFDM) symbols is transmitted in one coding time interval, wherein the number of OFDM symbols corresponds to the total number of antennas of the transmitting CNs. In other embodiments, a single OFDM symbol is transmitted in each of a plurality of coding time intervals, wherein the number of coding time intervals corresponds to the total number of antennas of the transmitting CNs.

### 5. DCS Operation Step

In the DCS operation step, during each of the time intervals τ₁, . . . , τ_{T} that are subintervals of a respective coding time interval of the one, τ₁, or more, τ₁, τ₂, τ₃, coding time intervals, an additional phase shift from a sequence of additional phase shifts that is based on the sequence of codeword components c_{d}¹, . . . c_{d}^{T} is applied to the base phase shift pattern ϕ_{d} of DCS d, d=1, 2, . . . , D, for providing a sequence of phase shift patterns of the DCS d. The additional phase shifts can be applied to the base phase shift pattern of DCS d by adding, for each scattering element of the at least a part of the scattering elements of DCS d, d=1, 2, . . . , D, the respective additional phase shift for the respective time interval from the sequence of additional phase shifts for DCS d to the phase shift value for the respective scattering element defined by the base phase shift pattern ϕ_{d}.

The additional phase shifts for DCS d are selected such that a phase shifted scattering pattern of DCS d is obtained which corresponds to a product of a codeword component of the codeword assigned to DCS d and the base scattering pattern ϕ_{d} of DCS d that is obtained when DCS d provides the base phase shift pattern ϕ_{d}. Thus, a sequence of scattering patterns [c_{d}¹F_{d}(ϕ_{d}), c_{d}²F_{d}(d), . . . c_{d}^{T}F_{d}(ϕ_{d})] of DCS d is obtained during the one or more coding time intervals. In embodiments, the operation of the scattering elements of each of the DCSs in the DCS operation step can be controlled by the DCS control circuitry 405 of the respective DCS. Additionally, over-the-air transmission of the transmission signal defined in the transmission signal defining step and a reception of yₖ, k=1, . . . , K by K CNs, for example UEs (see Equation (1)) are performed during the one or more coding time intervals.

### 6. Signal Component Separation and Channel Estimation Step

In the signal component separation and channel estimation step, knowledge of the received signal yₖ and the codewords used by the DCSs, namely c₁, c₂, . . . , c_{D}, is used to obtain the separated non-DCS and DCS signal components y_{0,k}, y_{DCS}_{₁}_{,k}, y_{DCS}_{₂}_{,k}, . . . , y_{DCS}_{_{D}}_{,k}. The knowledge of the received signal yₖ can be provided by obtaining reception information. For example, in the downlink, yₖ received at UE k can be obtained from reception information at UE k. As another example, in the uplink, the received signal at the BS contains the contribution yₖ from each UE k. For obtaining the separated non-DCS and DCS signal components y_{0,k}, y_{DCS}_{₁}_{,k}, y_{DCS}_{₂}_{,k}, . . . ,y_{DCS}_{_{D}}_{,k}, a transformation can be applied to a representation of the received signals. The transformation can be a linear transformation which can be based on a set of conjugate codewords for the codewords c₁, c₂, . . . , c_{D} or it can be based on a model of phase variations induced by the sequence of additional phase shifts during a transmission of a single OFDM symbol. In embodiments, the obtaining of the separated non-DCS and DCS signal components can be performed by the signal component separation circuitry 307a of the signal component separation and channel estimation circuitry 307 described above with reference to FIG. 3.

Based on the separated non-DCS and DCS signal components y_{0,k}, y_{DCS}_{₁}_{,k}, y_{DCS}_{₂}_{,k}, . . . , y_{DCS}_{_{D}}_{,k} and an aggregate communication channel that can be obtained via conventional training, a representation of the transmission signals assigned in the transmission signal assignment step can then be computed. The channel estimate can be computed from the representation of the transmission signals and the separated non-DCS and DCS signal components y_{0,k}, y_{DCS}_{₁}_{,k}, y_{DCS}_{₂}_{,k}, . . . , y_{DCS}_{_{D}}_{,k}. In embodiments, the computation of the channel estimate can be performed by the channel estimation circuitry 307b of the signal component separation and channel estimation circuitry 307 described above with reference to FIG. 3.

In the following, embodiments of the individual steps described above will be described in detail.

### Embodiments for the Base Phase Shift Pattern Assignment Step

As mentioned above, in the base phase shift pattern assignment step, a base scattering pattern F_{d}(ϕ_{d}) is provided for each DCS d=1, 2, . . . , D. In the following, three different ways to obtain F_{d}(ϕ_{d}) for each DCS d=1, 2, . . . , D are described:
(1) Randomly choose the initial DCS phase configuration by making a random choice of ϕ_{d}. The benefit of this embodiment is its simplicity. However, it might generate reduced SNR for the signals received via the DCSs, unless selected from a predefined set of potential configurations identified for communication.
(2) Choose ϕ_{d} based on previously or offline computed information or previously acquired information. Such a prior information can be, for example (i) Pd that previously resulted in good performance or (ii) statistical channel information or (iii) information about dominant directions for communication between the DCS and one or both of transceivers (TX) and receivers (RX), an example is the offline channel estimation in near field scenario described in PCT/EP2021/057912, the disclosure of which is incorporated herein by reference).
(3) Keep phases that have been selected for communicating and/or serving other UEs in the vicinity (use the one that has been set for communication serving other UEs).

### Embodiments for the Codeword Assignment Step

As mentioned above, in the codeword assignment step, D orthogonal or semi-orthogonal codewords of length T are chosen and one of the codewords is assigned to each DCS d=1, 2, . . . , D. In the following, two implementations of such sequences or codes that can be used are provided. The first one is based on Hadamard codes and the second one is based on Fourier matrices.
(1) Using Hadamard codes. The codewords c₁, c₂, . . . , c_{D} are chosen from a Hadamard matrix of size D+1. The codeword length is thus T=D+1. An advantage of selecting the codewords from a Hadamard matrix is that in such matrices the elements only take two values {+1, −1}which can be easily implemented via the phase shift at the DCS scattering elements by respectively choosing phase shifts of {0, π}. Since the Hadamard matrix is of size D+1, there are D+1 codewords that can be selected. The codeword (Hadamard matrix row) corresponding to all entries equal to +1 is not assigned to any DCS. In this way, this codeword implicitly becomes the codeword of the non-DCS path. If the non-DCS path is not of interest (for example, if it can be disregarded due to its negligible contribution in case of strong blockage) then a Hadamard matrix of size D can be used, and the corresponding rows of this matrix can be assigned as the c₁, c₂, . . . , c_{D} codewords. For some codeword lengths T, a Hadamard matrix of the required size of D or D+1 may not exist. One option in this case is to use a Hadamard code with length of 2^{[log}^{₂}^{D]} were [log₂D] is the nearest upper integer and to use only a subset of its codewords. Other Hadamard based constructions for different code sizes are reported in the literature and are known.
   As an example of a Hadamard based construction, consider the case of D=3 where the estimation of the non-DCS path is desired, so that T=D+1=4. A Hadamard matrix of size 4 is the following,

$$[ \begin{matrix}+ 1 & + 1 & + 1 & + 1 \\ + 1 & - 1 & + 1 & - 1 \\ + 1 & + 1 & - 1 & - 1 \\ + 1 & - 1 & - 1 & + 1\end{matrix} ] . \qquad Equation ( 3 )$$

The codewords c₁, c₂, c₃ assigned respectively to DCSs d=1, d=2, d=3 are respectively the second to fourth rows of the Hadamard matrix in Equation (3) thus

$${c}_{1} = [ + 1 , - 1 , + 1 , - 1 ] \qquad Equation ( 4 )$$

$${c}_{2} = [ + 1 , + 1 , - 1 , - 1 ] \qquad Equation ( 5 )$$

$${c}_{3} = [ + 1 , - 1 , - 1 , + 1 ] \qquad Equation ( 6 )$$

(2) Using DFT matrices. The codewords are selected from a DFT matrix of size D+1 so the codeword length is T=D+1. The codeword (DFT matrix row) corresponding to all entries equal to +1 is not assigned to a DCS so that this codeword implicitly becomes the codeword of the non-DCS paths. If the non-DCS path is not of interest (for example, if it can be disregarded due to its negligible contribution in case of strong blockage) then a DFT matrix of size D can be used and the corresponding rows of this matrix can be assigned as the c₁, c₂, . . . , c_{D} codewords. An advantage of the use of DFT matrices is that the entries of such matrices are unit norm exponentials of the form e^{jθ}. This facilitates implementation via DCS phases since e^{jθ} can be implemented at a scattering element by applying a phase shift of θ. For implementing DFT based phase shifts, a number of different phase shifts greater than two may need to be provided by the scattering elements of the DCSs, whereas with Hadamard codes the phase shift θ is further restricted to {0, π}.

### Embodiments for the Coding Time Interval Assignment Step and the Transmission Signal Assignment Step

These will be presented later at the same time as the embodiments for the signal component separation and channel estimation step, since embodiments for the coding time interval assignment step, the transmission signal assignment step, and the signal component separation and channel estimation step are related as they depend on the waveform used for communication.

### Embodiment for the DCS Operation Step

As mentioned above, in the DCS operation step, over the air transmission and signal reception are performed, with each DCS d applying the corresponding coded scattering pattern sequence [c_{d}¹F_{d}(ϕ_{d}), c_{d}²F_{d}(ϕ_{d}), . . . c_{d}^{T}F_{d}(ϕ_{d})] during each of the one or more coding time intervals. In the following, an implementation of this coded scattering pattern sequence at a DCS d is explained.

As mentioned above, the scattering pattern of DCS d is denoted F_{d} (ϕ_{d}) where ϕ_{d} represents the phase shift pattern applied at the scattering elements of DCS d. More specifically, ϕ_{d} can be represented as a vector with S_{d} elements as follows,

$${ϕ}_{d} = [ {ϕ}_{d}^{1} , {ϕ}_{d}^{2} , … , , … , {ϕ}_{d}^{{S}_{d}} ] \qquad Equation ( 7 )$$

where [symbol] is the phase shift configured at the [symbol] -th scattering element of DCS d. As also mentioned above, c_{d} denotes the codeword of length T used for DCS d, where c_{d}=[c_{d}¹, c_{d}², . . . , c_{d}^{T}] and [symbol] is the [symbol] -th component of c_{d}. When Hadamard or DFT based codes are used, where the codeword components are of the form [symbol] = [symbol] , then c_{d}=[e^{jθ}^{_{d}}^{¹}, e^{jθ}^{_{d}}^{²}, . . . , e^{jθ}^{_{d}}^{^{T}}]. A codeword component [symbol] is applied on top of the scattering pattern F_{d}(ϕ_{d}) by adding to the phases of the scattering elements an additional phase shift of [symbol] , thus obtaining the phase shifts [symbol] to be applied to DCS d at time interval [symbol] as follows:

$$\begin{matrix}= {ϕ}_{d} + & = [ {ϕ}_{d}^{1} , {ϕ}_{d}^{2} , … , {ϕ}_{d}^{S} ] + \\ & = [ {ϕ}_{d}^{1} + , {ϕ}_{d}^{2} + , … , {ϕ}_{d}^{S} + ]\end{matrix} \qquad Equation ( 8 )$$

The equation above represents the coded phase shift at DCS d due to codeword component [symbol] = [symbol] . As can be seen from Equation (8), the phase of each scattering element is shifted by the same amount [symbol] and thus does not change the scattering pattern of the DCS, apart from a phase shift.

A model of the scattering pattern F_{d}(ϕ_{d}) for a DCS d with S_{d} scattering elements is given by a diagonal matrix

$${F}_{d} ( {ϕ}_{d} ) = diag ( {σ}_{d}^{1} {e}^{j {ϕ}_{d}^{1}} , {σ}_{d}^{2} {e}^{j {ϕ}_{d}^{2}} , … , , … , {σ}_{d}^{{S}_{d}} {e}^{j {ϕ}_{d}^{{S}_{d}}} ) , \qquad Equation ( 9 )$$

where, as mentioned above, ϕ_{d}=[ϕ_{d}¹, ϕ_{d}², . . . , [symbol] , . . . , ϕ_{d}^{S}^{_{d}}] and [symbol] is the phase shift configured at the [symbol] -th scattering element of DCS d, and where [symbol] represents the amplitude change due to DCS d element [symbol] which is related to the radar cross section of the scattering element. Using the coded phase shift [symbol] defined in Equation (8) in the model in Equation (9) results in the following coded scattering pattern at DCS d due to codeword component [symbol] :

$$\begin{matrix}( ) & = {F}_{d} ( {ϕ}_{d} + ) \\ & = diag ( {σ}_{d}^{1} {e}^{j {ϕ}_{d}^{1} + j} , {σ}_{d}^{2} {e}^{j {ϕ}_{d}^{2} + j} , … , {+ j}^{} , … , {σ}_{d}^{{S}_{d}} {e}^{j {ϕ}_{d}^{{S}_{d}} +} ) \\ & = {e}^{j} diag ( {σ}_{d}^{1} {e}^{j {ϕ}_{d}^{1}} , {σ}_{d}^{2} {e}^{j {ϕ}_{d}^{2}} , … , {j}^{} , … , {σ}_{d}^{{s}_{d}} {e}^{j {ϕ}_{d}^{{S}_{d}}} ) \\ & = {e}^{j} {F}_{d} ( {ϕ}_{d} )\end{matrix} . \qquad Equation ( 10 )$$

Thus, since [symbol] = [symbol] the coded scattering pattern at DCS d due to codeword component [symbol] can also be written as

$$( ) = {F}_{d} ( {ϕ}_{d} ) \qquad Equation ( 11 )$$

Applying the codeword c_{d}=[c_{d}¹, c_{d}², . . . , [symbol] , . . . , c_{d}^{T}] for DCS at time intervals 1, 2, . . . , T results in the coded scattering pattern sequence described as

$$[ {F}_{d}^{1} ( {ϕ}_{d}^{1} ) , {F}_{d}^{2} ( {ϕ}_{d}^{2} ) , … , ( ) , … , {F}_{d}^{T} ( {ϕ}_{d}^{T} ) ] = [ {c}_{d}^{1} {F}_{d} ( {ϕ}_{d} ) , {c}_{d}^{2} {F}_{d} ( {ϕ}_{d} ) , … , {F}_{d} ( {ϕ}_{d} ) , … , {c}_{d}^{T} {F}_{d} ( {ϕ}_{d} ) ] , \qquad Equation ( 12 )$$

or equivalently as

$$[ {F}_{d}^{1} ( {ϕ}_{d}^{1} ) , {F}_{d}^{2} ( {ϕ}_{d}^{2} ) , … , ( ) , … , {F}_{d}^{T} ( {ϕ}_{d}^{T} ) ] = [ {e}^{j {θ}_{d}^{1}} {F}_{d}^{1} ( {ϕ}_{d}^{1} ) , , {e}^{j {θ}_{d}^{2}} {F}_{d}^{2} ( {ϕ}_{d}^{2} ) , … , {e}^{j} ( ) , … , {e}^{j {θ}_{d}^{T}} {F}_{d}^{T} ( {ϕ}_{d}^{T} ) ] \qquad Equation ( 13 )$$

when the codeword components are of the form [symbol] = [symbol] .

### Embodiment for the Coding Time Interval Assignment Step, the Transmission Signal Assignment Step and the Signal Component Separation and Channel Estimation Step for the Case of Downlink, SISO and DCS Coding Over Multiple OFDM Symbols

As mentioned above, in the coding time interval assignment step, one or more coding time intervals are defined during which the DCSs will apply the coded scattering pattern sequence. In this embodiment, a single coding time interval τ₁ is used. Given the codewords c₁, c₂, . . . , c_{D} defined in the codeword assignment step where, as mentioned above, each codeword is of size T, a duration of τ₁ equal to the duration of T OFDM symbols is defined. The coding time interval τ₁ is divided into T subintervals labeled as τ₁, τ2, . . . , τₜ, . . . τ_{T}. Thus, if the duration of one OFDM symbol is equal to μ_{OFDM} seconds, then the duration of τ₁ is equal to Tμ_{OFDM} seconds and the duration of a subinterval it is equal to μ_{OFDM} seconds. Furthermore, in this embodiment, as part of the coding time interval assignment step, the coding interval τ₁ is defined to start at the ( [symbol] +1)-th OFDM symbol.

In the transmission signal assignment step, the signal that is transmitted during the coding time interval τ₁ is defined. In this embodiment, the single input, single output (SISO) case is considered, where the BS has one transmit antenna and each of the UEs has one receive antenna. The signal transmitted during the [symbol] -th OFDM symbol by the BS is denoted as [symbol] (t).

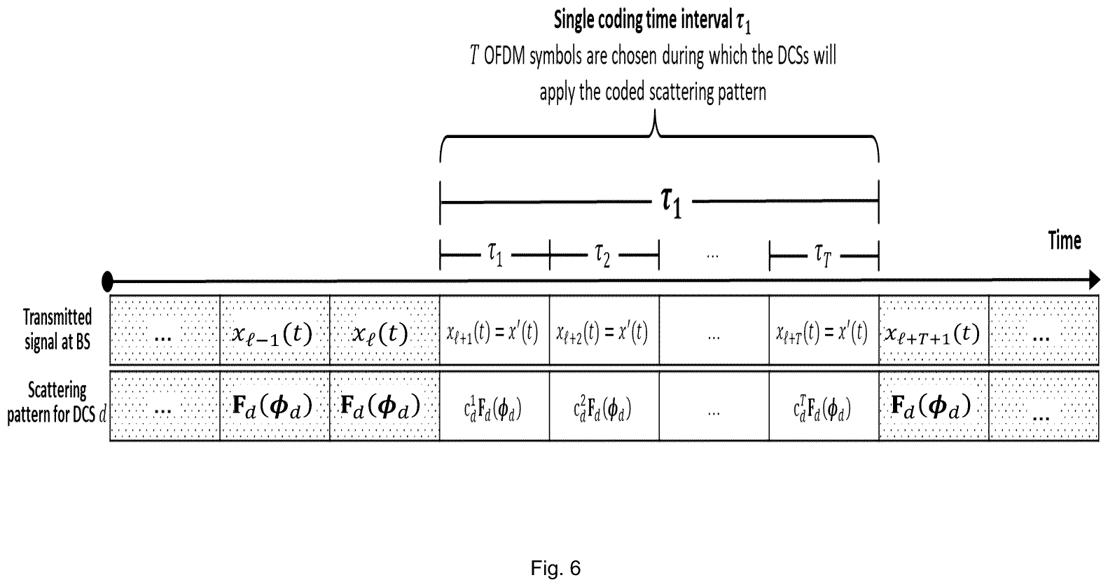

Since the coding interval τ₁ has been defined in the coding time interval assignment step to start at symbol [symbol] +1 and to last T OFDM symbols in the transmission signal assignment step, the signals [symbol] (t), [symbol] xe+₂(t), . . . , [symbol] (t) are defined. In this embodiment, the signal transmitted during the coding interval τ₁ is defined to be the same and equal to x′(t) for all the T OFDM symbols, hence [symbol] +(t)= [symbol] (t)= . . . = [symbol] (t)=x′(t). FIG. 6 shows a time diagram of the transmitted signal and the coded scattering pattern sequence at the DCS d applied during coding time interval τ₁ as defined in this embodiment. In this embodiment, DCS d applies the coded scattering pattern sequence [c_{d}¹F_{d}(ϕ_{d}), c_{d}²F_{d}(ϕ_{d}), . . . , c_{d}^{t}F_{d}(ϕ_{d}), . . . , c_{d}^{T}F_{d}(ϕ_{d})] during transmission of the OFDM symbols [symbol] +1, [symbol] +2 until [symbol] +T which correspond to the coding time interval τ₁. The signal transmitted during that time interval is equal to x′(t).

Since, in this embodiment, OFDM waveforms are used, the transmitted and received signals can be expressed as follows. For an OFDM symbol consisting of N_{c} orthogonal subcarriers, the frequency domain representation [symbol] of the transmitted signal [symbol] (t) [symbol] can be written as [symbol] ==[ [symbol] , [symbol] , . . . , [symbol] , . . . , [symbol] ] where [symbol] is a complex scalar that represents the information transmitted on the ω-th subcarrier, and the [symbol] -th OFDM symbol. Assuming all non-DCS and DCS paths arrive within the cyclic prefix, then, after proper cyclic prefix removal, the frequency domain representation of the received signal in the downlink at user k subcarrier ω due to transmission of [symbol] by the BS can be written as

$${y}_{ℓ , k , ω} = {H}_{0 , k , ω} {X}_{ℓ , ω} + {\sum }_{d = 1}^{D} {H}_{{DCS}_{d} , k , ω} {X}_{ℓ , ω} = ( {H}_{0 , k , ω} + {\sum }_{d = 1}^{D} {H}_{{DCS}_{d} , k , ω} ) {X}_{ℓ , ω} \qquad Equation ( 14 )$$

where H_{0,k,ω} and H_{DCS}_{_{d}}_{,k,ω} are scalars that represent the non-DCS and the DCS d channel frequency response, respectively, at subcarrier ω for user k. Equation (14) has the same form as Equation (1), but is written in the frequency domain.

In the following, the effect that the scattering pattern F_{d}(ϕ_{d}) and the coded scattering pattern [symbol] F_{d}(ϕ_{d}) have on the DCS channel H_{DCS}_{_{d}}_{,k} will be described. For a given scattering pattern F_{d} (ϕ_{d}), the DCS channel can be written as a product of three matrices

$${H}_{D C {S}_{d} , k , ω} = {H}_{D C {S}_{d} \to U {E}_{k} , ω} {F}_{d} ( {ϕ}_{d} ) {H}_{B S \to {DCS}_{d} , ω} \qquad Equation ( 15 )$$

where H_{DCS}_{_{d}}_{→UE}_{ₖ}_{,ω} is the channel between DCS d and UE k at subcarrier ω and H_{BS→DCS}_{_{d}}_{,ω} is the channel between the BS and DCS d at subcarrier a. In the case of SISO and a DCS d with S_{d} scattering elements, the matrix H_{DCS}_{_{d}}_{→UE}_{ₖ}_{,ω} is of size 1×S_{d} and the matrix H_{BS→DCS}_{_{d}}_{,ω} is of size S_{d}×1. If, instead of using the scattering pattern F_{d}(ϕ_{d}), the coded scattering pattern [symbol] F_{d} (ϕ_{d}) is used, then the channel can be written as

$${c}_{d}^{𝓉} {H}_{D C {S}_{d} , k , ω} \qquad Equation ( 16 )$$

since this is what is obtained by replacing F_{d}(ϕ_{d}) with [symbol] F_{d}(ϕ_{d}) in Equation (15) and then simplifying as follows, using that [symbol] is a scalar.

$${H}_{D C {S}_{d} \to U {E}_{k} , ω} ( {c}_{d}^{𝓉} {F}_{d} ( {ϕ}_{d} ) ) {H}_{B S \to D C {S}_{d} , ω} = {c}_{d}^{𝓉} ( {H}_{D C {S}_{d} \to U {E}_{k} , ω} {F}_{d} ( {ϕ}_{d} ) {H}_{B S \to {DCS}_{d} , ω} ) = {c}_{d}^{𝓉} {H}_{D C {S}_{d} , k , ω} \qquad Equation ( 17 )$$

Assuming all transmissions of interest happen within the channel coherence time (i.e. the channels H_{0,k,ω}, H_{DCS}_{_{d}}_{→UE}_{ₖ}_{,ω} and H_{BS→DCS}_{_{d}}_{,ω} remain constant), the signal received at UE k at the DCS operation step (as mentioned above this step corresponds to over-the-air transmission and reception and applying DCS coding during the coding time interval τ₁) can be written as in Equation (14) when using the scattering pattern without coding, F_{d}(ϕ_{d}), and as

$${y}_{ℓ , k , ω} = {H}_{0 , k , ω} {X}_{ℓ , ω} + {\sum }_{d = 1}^{D} {c}_{d}^{𝓉} {H}_{D C {S}_{d} , k , ω} {X}_{ℓ , ω} = ( {H}_{0 , k , ω} + {\sum }_{d = 1}^{D} {c}_{d}^{𝓉} {H}_{D C {S}_{d} , k , ω} ) {X}_{ℓ , ω} \qquad Equation ( 18 )$$

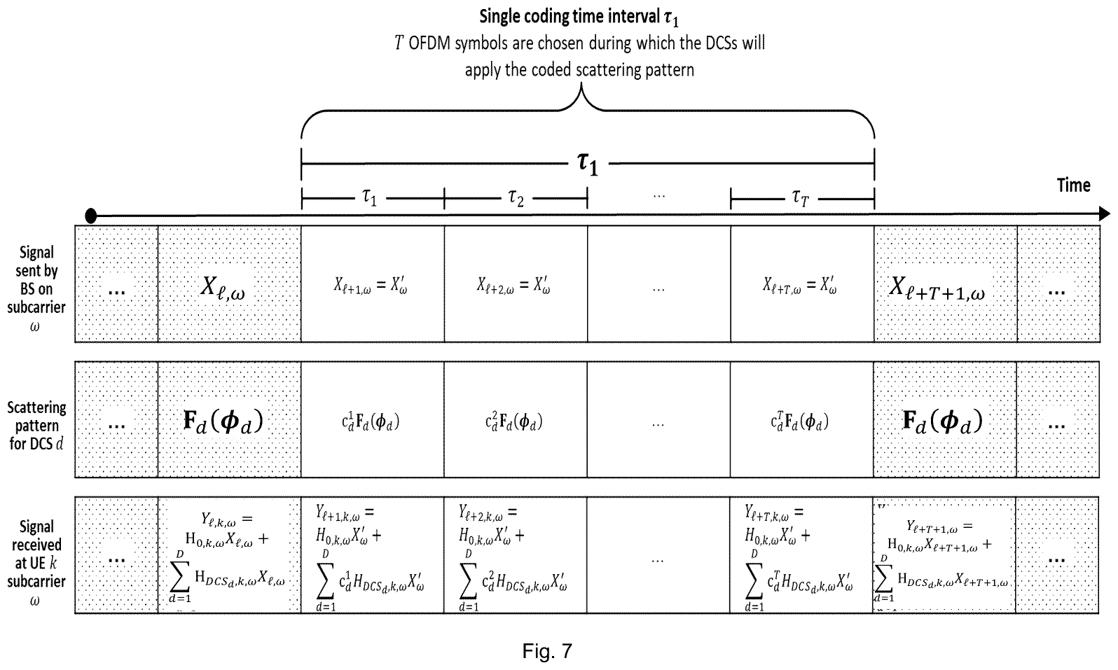

when using the scattering pattern [symbol] F_{d}(ϕ_{d}) with coding. This follows from the derivations in Equation (15), Equation (16) and Equation (17). For illustration, a time diagram with transmitted and received signals in the downlink is shown in FIG. 7. The timing diagram illustrates the signal sent by the BS on subcarrier ω and the signal received at UE k subcarrier ω during OFDM symbols without DCS coding (outside the coding time interval τ₁) and with DCS coding (inside the coding time interval τ₁) for the downlink SISO case.

Using Y_{∈τ}_{₁}_{,k,ω} to denote the received downlink signal for an OFDM symbol outside the coding time interval τ₁ and [symbol] to denote the received downlink signal for subinterval [symbol] (which corresponds to OFDM symbol [symbol] + [symbol] t), Equation (14) and Equation (18), respectively, are rewritten as below, where the signals are further rewritten in matrix form, hence

$${Y}_{∉ {τ}_{1} , k , ω} = ( {H}_{0 , k , ω} + {\sum }_{d = 1}^{D} {H}_{D C {S}_{d} , k , ω} ) {X}_{ℓ , ω} = [ 1 , 1 , … , 1 ] [ \begin{matrix}{H}_{0 , k , ω} \\ {H}_{{DCS}_{1} , k , ω} \\ ⋮ \\ {H}_{{DCS}_{D} , k , ω}\end{matrix} ] {X}_{ℓ , ω} \qquad Equation ( 19 )$$

$$and$$

$${Y}_{∈ {τ}_{𝓉} , k , ω} = {Y}_{ℓ + 𝓉 , k , ω} = ( {H}_{0 , k , ω} + {\sum }_{d = 1}^{D} {c}_{d}^{𝓉} {H}_{D C {S}_{d} , k , ω} ) {X}_{ℓ + 𝓉 , ω} = [ 1 , {c}_{1}^{𝓉} , … , {c}_{D}^{𝓉} ] [ \begin{matrix}{H}_{0 , k , ω} \\ {H}_{{DCS}_{1} , k , ω} \\ ⋮ \\ {H}_{{DCS}_{D} , k , ω}\end{matrix} ] {X}_{ℓ + t , ω} = [ 1 , {c}_{1}^{𝓉} , … , {c}_{D}^{𝓉} ] [ \begin{matrix}{H}_{0 , k , ω} \\ {H}_{{DCS}_{1} , k , ω} \\ ⋮ \\ {H}_{{DCS}_{D} , k , ω}\end{matrix} ] {X}_{ω}^{′} \qquad Equation ( 20 )$$

where it was used that during the coding interval τ₁ the transmitted signal is fixed to x′(t) which is an OFDM symbol and, hence, can be written in the frequency domain as X′=[X′₁, X′₂, . . . , X′_{ω}, . . . , X′_{N}_{_{c}}] so that [symbol] +τ, ω=X′_{ω}. Also in Equation (20), it was used that at OFDM symbol [symbol] + [symbol] (i.e. at subinterval [symbol] ) the DCS d uses codeword component [symbol] .

In the following, the signal component separation and channel estimation step where knowledge of the received signals, Y_{∈τ}_{₁}_{,k,ω}, Y_{∈τ}_{₂}_{,k,ω}, . . . , Y_{∈τ}_{_{T}}_{,k,ω}, and the codewords used by the DCSs, namely c₁, c₂, . . . , c_{D}, is used to obtain the non-DCS signal component H_{0,k,ω}X′_{ω} and the DCS signal components H_{Dcs}_{₁}_{,k,ω}X′_{ω}, H_{DCS}_{₂}_{,k,ω}X′_{ω}, . . . , H_{DCS}_{_{D}}_{,k,ω}X′_{ω}, and to further estimate the non-DCS channel H_{0,k,ω}, and DCS channels H_{DCS}_{₁}_{,k,ω}, H_{DCS}_{₂}_{,k,ω}, . . . , H_{DCS}_{_{D}}_{,k,ω} will be described. If the T observations Y_{∈τ}_{₁}_{,k,ω}, Y_{∈τ}_{₂}_{,k,ω}, . . . , Y_{∈τ}_{_{T}}_{,k,ω} are stacked as follows,

$${Y}_{∈ {τ}_{1} , k , ω} = [ \begin{matrix}{Y}_{∈ {τ}_{1} , k , ω} \\ {Y}_{∈ {τ}_{2} , k , ω} \\ ⋮ \\ {Y}_{∈ {τ}_{T} , k , ω}\end{matrix} ] = [ \begin{matrix}1 , {c}_{1}^{1} , … , {c}_{D}^{1} \\ 1 , {c}_{1}^{2} , … , {c}_{D}^{2} \\ ⋮ \\ 1 , {c}_{1}^{T} , … , {c}_{D}^{T}\end{matrix} ] [ \begin{matrix}{H}_{0 , k , ω} \\ {H}_{{DCS}_{1} , k , ω} \\ ⋮ \\ {H}_{{DCS}_{D} , k , ω}\end{matrix} ] {X}_{ω}^{′} \qquad Equation ( 21 )$$

the signal received via DCS d during the entire coding interval τ₁ and without the effect of coding, namely H_{DCS}_{_{d}}_{,k,ω}X′_{ω}, can be obtained by using Y_{∈τ}_{₁}_{,k,ω} defined above and the knowledge the code for DCS d, which is c_{d}. Due to the orthogonality of the chosen codewords (for example Hadamard or DFT as explained in the embodiments for the codeword assignment step), this is obtained as follows:

$$\begin{matrix}{c}_{d}^{*} {Y}_{∈ {τ}_{1} , k , ω} = {[ {c}_{d}^{T} , … , {c}_{d}^{T} ]}^{*} {Y}_{∈ {τ}_{1} , k , ω} \\ = {[ {c}_{d}^{T} , … , {c}_{d}^{T} ]}^{*} [ \begin{matrix}{Y}_{∈ {τ}_{1} , k , ω} \\ {Y}_{∈ {τ}_{2} , k , ω} \\ ⋮ \\ {Y}_{∈ {τ}_{T} , k , ω}\end{matrix} ] \\ = {[ {c}_{d}^{T} , … , {c}_{d}^{T} ]}^{*} [ \begin{matrix}1 , {c}_{1}^{1} , … , {c}_{D}^{1} \\ 1 , {c}_{1}^{2} , … , {c}_{D}^{2} \\ ⋮ \\ 1 , {c}_{1}^{T} , … , {c}_{D}^{T}\end{matrix} ] [ \begin{matrix}{H}_{0 , k , ω} \\ {H}_{{DCS}_{1} , k , ω} \\ ⋮ \\ {H}_{{DCS}_{D} , k , ω}\end{matrix} ] {X}_{ω}^{′} \\ = {1}_{d + 1 , T} [ \begin{matrix}{H}_{0 , k , ω} \\ {H}_{{DCS}_{1} , k , ω} \\ ⋮ \\ {H}_{{DCS}_{D} , k , ω}\end{matrix} ] {X}_{ω}^{′} \\ = {H}_{{DCS}_{d} , k , ω} {X}_{ω}^{′}\end{matrix} \qquad Equation ( 22 )$$

where in the last steps of Equation (22), it was used that

$$[ {c}_{d}^{1} , … , {c}_{d}^{T} ] [ \begin{matrix}{c}_{{d}^{′}}^{1} \\ ⋮ \\ {c}_{{d}^{′}}^{T}\end{matrix} ] = \{ \begin{matrix}0 for d \neq {d}^{′} \\ 1 for d = {d}^{′}\end{matrix} \qquad Equation ( 23 )$$

and also

$${[ {c}_{d}^{1} , … , {c}_{d}^{T} ]}^{*} [ \begin{matrix}1 \\ ⋮ \\ 1\end{matrix} ] = 0 unless {c}_{d}^{1} = {c}_{d}^{2} = … = {c}_{d}^{T} = 1. \qquad Equation ( 24 )$$

Here, [ ]* is used to denote the conjugate of [ ] and 1_{d+1,T} is a row vector of size T with entry d+1 equal to one and all other entries equal to zero. The multiplication of Y_{∈τ}_{₁}_{,k,ω}, which is a representation of the signals received at the UE k during the coding time interval τ₁ by [c_{d}¹, . . . , c_{d}^{T}]* is an application of a linear transformation that is based on conjugate codewords to the representation of the signals received at the UE k during the coding time interval τ₁.

From Equation (22), it can be seen that by computing c*_{d}Y_{∈τ}_{₁}_{,k,ω} one obtains

$${H}_{D C {S}_{d} , k , ω} {X}_{ω}^{′} \qquad Equation ( 25 )$$

which is a signal component received by the UE k via the DCS d. By computing [1, 1, . . . , 1]Y_{∈τ}_{₁}_{,k,ω}, which is also an application of a linear transformation, one obtains

$${H}_{0 , k , ω} {X}_{ω}^{′} \qquad Equation ( 26 )$$

which is a representation of the signal component received by the UE k via the non-DCS channel. Thus, by applying linear transformations to the representation of the received signals, signal components received via the individual DCSs and via the non-DCS channel can be separated.

By adding Equation (26) and Equation (25) computed for all D DCSs, one obtains

$$( {H}_{0 , k , ω} + {\sum }_{d = 1}^{D} {H}_{D C {S}_{d} , k , ω} ) {X}_{ω}^{′} \qquad Equation ( 27 )$$

In the equation above, (H_{0,k,ω}+Σ_{d=1}^{D}H_{DCS}_{_{d}}_{,k,ω}) is the aggregate channel observed before the coding time interval τ₁. The aggregate channel can be obtained by means of conventional training which can be performed at an earlier point in time for decoding earlier symbols, or it can be computed from previously received information (e.g. via joint data and channel estimation for OFDM symbols before the coding time interval τ₁ starts). Using the knowledge of this aggregate channel (H_{0,k,ω}+=Σ_{d=1}^{D}H_{DCS}_{_{d}}_{,k,ω}), Equation (27) can be solved for X′_{ω}. Using the computed X′_{ω}, Equation (26) can be solved for H_{0,k,ω} and Equation (25) can be solved for H_{DCS}_{_{d}}_{,k,ω} for all the D DCS. Thus, an estimate of the non-DCS and DCS channels can be obtained.

These estimates can later be used for further post-processing to enhance the decoding of X′_{ω}. In this embodiment a tradeoff is observed: the data symbol X′_{ω} spans multiple OFDM symbols which reduces the communication rate but results in improved SNR. Thus, a higher Modulation and Coding Scheme (MCS) can be used to avoid rate loss due to the repetition of data during the time slots of coded DCS phases, i.e. during the coding time interval.

### Embodiments for the Coding Time Interval Assignment Step, the Transmission Signal Assignment Step and the Signal Component Separation and the Channel Estimation Step for the Case of Downlink, MIMO and DCS Coding Over Multiple OFDM Symbols

In this embodiment, the downlink multiple input multiple output (MIMO) case is described where the BS has N transmit antennas and the UEs have multiple receive antennas, with Mₖ denoting the number of receive antennas at each UE k. As part of the coding time interval assignment step, a single coding time interval τ₁ is defined during which the DCSs will apply the coded scattering pattern sequence. Given codewords c₁, c₂, . . . , c_{D} defined in the codeword assignment step where, as mentioned above, each codeword is of size T, a duration of τ₁ equal to the duration of T*N OFDM symbols is defined and the T subintervals of the coding time interval τ are labeled as τ₁, τ2, . . . , [symbol] , . . . τ_{T}. Furthermore, each of the subintervals is further divided into N subintervals, where [symbol] is used to denote the n-th subinterval within subinterval [symbol] . Thus, if the duration of one OFDM symbol is equal to μ_{OFDM} seconds, then the duration of [symbol] is also equal to μ_{OFDM}, the duration of [symbol] is equal to N*μ_{OFDM} seconds and the duration of τ is equal to T*N*μ_{OFDM} seconds.

Furthermore, in this embodiment, as part of the coding time interval assignment step, it is defined that the coding time interval τ₁ starts at the [symbol] +1-th OFDM symbol, and it is defined that at subinterval [symbol] each of the DCSs applies its corresponding codeword components [symbol] .

In the transmission signal assignment step, the signal that is transmitted during the coding time interval τ₁ is defined. A vector [symbol] (t) of length N is used to denote the signal transmitted at time t and during the [symbol] -th OFDM symbol by the BS. Since the coding time interval τ₁ has been defined in the coding time interval assignment step to start at symbol [symbol] +1 and to last T*N OFDM symbols, in the transmission signal assignment step, the signals [symbol] (t), [symbol] (t), . . . , [symbol] (t) are defined as follows:

$${x}_{ℓ + ( 𝓉 - 1 ) N + n} ( t ) = {x}_{n}^{′} ( t ) for \\ 𝓉 = 1 , 2 , … , T and for n = 1 , 2 , … , N \qquad Equation ( 28 )$$

Therefore,

$${x}_{ℓ + n} ( t ) = {x}_{ℓ + N + n} ( t ) = {x}_{ℓ + 2 N + n} ( t ) = … = {x}_{ℓ + ( T - 1 ) N + n} ( t ) = {x}_{n}^{ℓ} ( t ) for n = 1 , 2 , … , N , \qquad Equation ( 29 )$$

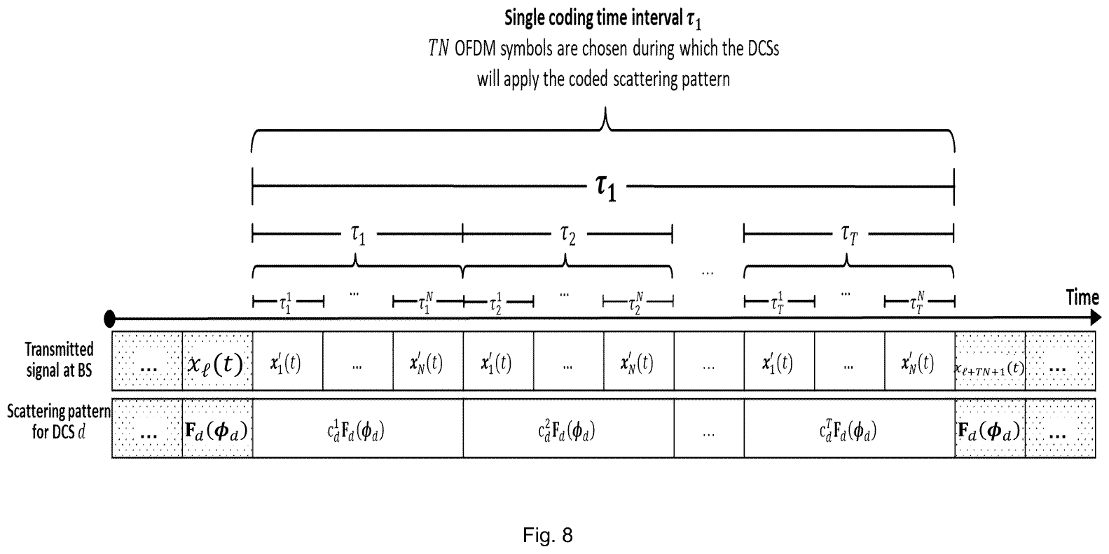

which means that at time subinterval [symbol] the transmitted signal is equal to x′ₙ(t). In the equations above, x′ₙ(t) is a vector of length N representing the signal transmitted by each of the transmitter antennas at time t. FIG. 8 shows a timing diagram of the transmitted signal and the coded scattering pattern sequence at DCS d that is applied during the coding time interval τ₁ as defined in this embodiment. DCS d applies the coded scattering pattern sequence [c_{d}¹F_{d}(ϕ_{d}), c_{d}²F_{d}(ϕ_{d}), . . . , [symbol] F_{d}(ϕ_{d}), . . . , c_{d}^{T}F_{d}(ϕ_{d})] during the transmission of the downlink OFDM symbols [symbol] +1, [symbol] +2 until [symbol] +T*N which correspond to the coding time interval τ₁.

Since this embodiment uses OFDM waveforms, the transmitted and received signals can be expressed as follows. For an OFDM symbol consisting of N_{c} orthogonal subcarriers the frequency domain representation [symbol] of the transmitted signal [symbol] (t) can be written as [symbol] =[ [symbol] , [symbol] , . . . , [symbol] , . . . , [symbol] ], where [symbol] is a complex matrix of size N×1 and N is the number of BS transmitter antennas. This matrix [symbol] represents the information transmitted on the ω-th subcarrier at the [symbol] -th OFDM symbol. Assuming all non-DCS and DCS paths arrive within the cyclic prefix, after proper cyclic prefix removal, the frequency domain representation of the received signal in the downlink at user k and subcarrier ω due to the transmission of [symbol] by the BS can be written as

$${Y}_{ℓ , k , ω} = {H}_{0 , k , ω} {X}_{ℓ , ω} + {\sum }_{d = 1}^{D} {H}_{D C {S}_{d} , k , ω} {X}_{ℓ , ω} = ( {H}_{0 , k , ω} + {\sum }_{d = 1}^{D} {H}_{D C {S}_{d} , k , ω} ) {X}_{ℓ , ω} \qquad Equation ( 30 )$$

where H_{0,kω} and H_{DCS}_{_{d}}_{,k,ω} are Mₖ×N matrices, Mₖ is the number of antennas at UE k and these matrices represent the non-DCS and DCS d channel frequency response at subcarrier ω for user k. Equation (30) has the same form as Equation (1), but is written in the frequency domain.

In the following, the effect that the scattering pattern F_{d}(ϕ_{d}) and the coded scattering pattern [symbol] F_{d}(ϕ_{d}) have on the DCS channel H_{Dcs}_{_{d}}_{,k} will be explained. For a given scattering pattern F_{d} (ϕ_{d}), the DCS channel can be written as a cascade of three matrices as

$${H}_{{DCS}_{d} , k , ω} = {H}_{{DCS}_{d} \to {UE}_{k} , ω} {F}_{d} ( {ϕ}_{d} ) {H}_{BS \to {DCS}_{d} , ω} \qquad \begin{matrix}Equation \\ ( 31 )\end{matrix}$$

where, in this case of MIMO downlink, the channel between DCS d and UE k at subcarrier ω, namely H_{DCS}_{_{d}}_{→UE}_{ₖ}_{,ω}, and the channel between the BS and DCS_{d} at subcarrier ω, namely H_{BS→DCS}_{_{d}}_{,ω}, are matrices of size Mₖ×S_{d} and S_{d}×N, respectively. As mentioned above, S_{d} is the number of scattering elements at DCS d. If, instead of using the scattering pattern F_{d}(ϕ_{d}), the coded scattering pattern [symbol] (ϕ_{d}) is used, then the channel can be written as

$${H}_{{DCS}_{d} , k , ω} \qquad \begin{matrix}Equation \\ ( 32 )\end{matrix}$$

since this is what is obtained by replacing F_{d}(ϕ_{d}) with [symbol] F_{d}(ϕ_{d}) in Equation (31) and then simplifying as follows, using that [symbol] is a scalar.

$${H}_{{DCS}_{d} \to {UE}_{k} , ω} ( {F}_{d} ( {ϕ}_{d} ) ) {H}_{BS \to {DCS}_{d} , ω} = ( {H}_{{DCS}_{d} \to {UE}_{k} , ω} {F}_{d} ( {ϕ}_{d} ) {H}_{BS \to {DCS}_{d} , ω} ) = {H}_{{DCS}_{d} , k , ω} \qquad \begin{matrix}Equation \\ ( 33 )\end{matrix}$$

Assuming all transmissions of interest happen within the channel coherence time (i.e. the channels H_{0,k,ω}, H_{DCS}_{_{d}}_{→UE}_{ₖ}_{,ω} and H_{BS→DCS}_{_{d}}_{,ω} remain constant), the signal received at UE k at the DCS operation step (as mentioned above, this step corresponds to over-the-air transmission and reception and to the application of the DCS coding during the coding time interval τ₁) can be written as in Equation (30) when using the scattering pattern without coding, F_{d}(ϕ_{d}), and as

$${Y}_{ℓ , k , ω} = {H}_{0 , k , ω} {X}_{ℓ , ω} + {\sum }_{d = 1}^{D} {X}_{ℓ , ω} = ( {H}_{0 , k , ω} + {\sum }_{d = 1}^{D} {H}_{{DCS}_{d} , k , ω} ) {X}_{ℓ , ω} \qquad \begin{matrix}Equation \\ ( 34 )\end{matrix}$$

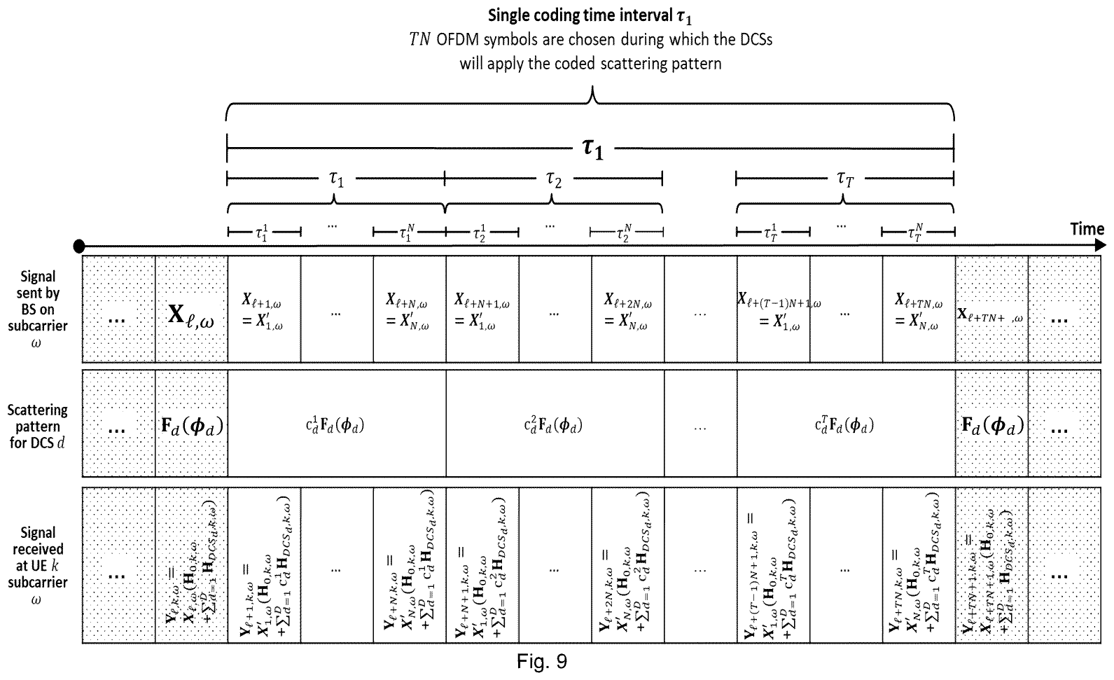

when using the scattering pattern with coding, [symbol] F_{d}(ϕ_{d}). This follows from Equation (31), Equation (32) and Equation (33). For illustration, a timing diagram with transmitted and received signals in the downlink MIMO scenario is shown in FIG. 9. The timing diagram illustrates the signal sent by the BS on subcarrier ω and the signal received at UE k subcarrier ω during OFDM symbols without DCS coding (outside time interval τ₁) and with DCS coding (inside time interval τ₁) for the downlink MIMO case.

Using Y_{∈τ}_{₁}_{,k,ω} to denote the received downlink signal for an OFDM symbol outside interval τ₁ and [symbol] denote the received downlink signal for subinterval [symbol] (which is the received signal for OFDM symbol [symbol] +( [symbol] −1)N+n), Equation (30) and Equation (34), respectively, can be rewritten as below, where the signals are further rewritten in matrix form so that

$${Y}_{∉ {τ}_{1} , k , ω} = ( {H}_{0 , k , ω} + {\sum }_{d = 1}^{D} {H}_{{DCS}_{d} , k , ω} ) {X}_{ℓ , ω} = [ {I}_{{M}_{k}} , {I}_{{M}_{k}} , … , {I}_{{M}_{k}} ] [ \begin{matrix}{H}_{0 , k , ω} \\ {H}_{{DCS}_{1} , k , ω} \\ ⋮ \\ {H}_{{DCS}_{D} , k , ω}\end{matrix} ] {X}_{ℓ , ω} \qquad \begin{matrix}Equation \\ ( 35 )\end{matrix}$$

$$and$$

$${Y}_{∈ {τ}_{n}^{} , k , ω} = {Y}_{ℓ + ( - 1 ) N + n , k , ω} = ( {H}_{0 , k , ω} + {\sum }_{d = 1}^{D} ) {X}_{ℓ + ( - 1 ) N + n , ω} = ( {H}_{0 , k , ω} + {\sum }_{d = 1}^{D} ) {X}_{n , ω}^{′} = [ {I}_{{M}_{k}} , {c}_{1}^{} {I}_{{M}_{k}} , … , {c}_{D}^{} {I}_{{M}_{k}} ] [ \begin{matrix}{H}_{0 , k , ω} \\ {H}_{{DCS}_{1} , k , ω} \\ ⋮ \\ {H}_{{DCS}_{D} , k , ω}\end{matrix} ] {X}_{n , ω}^{′} \qquad \begin{matrix}Equation \\ ( 36 )\end{matrix}$$

where I_{M}_{ₖ} is the identity matrix of size Mₖ and where it was used that during the interval [symbol] , the transmitted signal is fixed to x′ₙ(t) which is an OFDM symbol and, hence, can be written in the frequency domain as X′ₙ=[X′_{n,1}, X′_{n,2}, . . . , X′_{n,ω}, . . . , X′_{n,N}_{_{c}}]. X′_{n,ω} is a complex matrix of size N×1 and N is the number of BS transmitter antennas. The matrix X′_{n, ω} represents the information transmitted on the ω-th subcarrier at time subinterval [symbol] . In Equation (36), it was further used that at time subinterval [symbol] , DCS d uses codeword component. [symbol] .

In the following, the signal component separation and channel estimation step will be described, where knowledge of the received signals, [symbol] for [symbol] =1, 2, . . . , T and for n=1, 2, . . . , N (i.e. the signals received during the coding time interval τ₁) and the codewords used by the DCSs, namely c₁, c₂, . . . , c_{D}, are used to separate the non-DCS signal component H_{0,k,ω}X′_{n,ω} and the DCS signal components H_{Dcs}_{₁}_{,k,ω}X′_{n,ω}, H_{DCS}_{₂}_{,k,ω}X′_{n, ω}, . . . , H_{DCS}_{_{D}}_{,k,ω}X′_{n,ω} from the signals received by the UEs, and to further estimate the non-DCS channel H_{0,k,ω} and the DCS channels H_{DCS}_{₁}_{,k,ω}, H_{DCS}_{₂}_{,k,ω}, . . . , H_{DCS}_{_{D}}_{,k,ω}. Stacking the T*N observations [symbol] for [symbol] =1, 2, . . . , T and for n=1, 2, . . . , N and rewriting them as follows

$${Y}_{∈ {τ}_{1} , k , ω} = [ \begin{matrix}{Y}_{∈ {τ}_{1}^{1} , k , ω} & {Y}_{∈ {τ}_{1}^{2} , k , ω} & … & {Y}_{∈ {τ}_{1}^{N} , k , ω} \\ {Y}_{∈ {τ}_{2}^{1} , k , ω} & {Y}_{∈ {τ}_{2}^{2} , k , ω} & … & {Y}_{∈ {τ}_{2}^{N} , k , ω} \\ ⋮ & ⋮ & … & ⋮ \\ {Y}_{∈ {τ}_{T}^{1} , k , ω} & {Y}_{∈ {τ}_{T}^{2} , k , ω} & … & {Y}_{∈ {τ}_{T}^{N} , k , ω}\end{matrix} ] = [ \begin{matrix}{I}_{{M}_{k}} , {c}_{1}^{1} {I}_{{M}_{k}} , … , {c}_{D}^{1} {I}_{{M}_{k}} \\ {I}_{{M}_{k}} , {c}_{1}^{2} {I}_{{M}_{k}} , … , {c}_{D}^{2} {I}_{{M}_{k}} \\ ⋮ \\ {I}_{{M}_{k}} , {c}_{1}^{T} {I}_{{M}_{k}} , … , {c}_{D}^{T} {I}_{{M}_{k}}\end{matrix} ] [ \begin{matrix}{H}_{0 , k , ω} \\ {H}_{{DCS}_{1} , k , ω} \\ ⋮ \\ {H}_{{DCS}_{D} , k , ω}\end{matrix} ] [ {X}_{1 , ω}^{′} , {X}_{2 , ω}^{′} , … , {X}_{N , ω}^{′} ] \qquad \begin{matrix}Equation \\ ( 37 )\end{matrix}$$

it can be seen that the signal received via DCS d during the entire coding interval τ₁ and without the effect of coding, namely H_{Dcs}_{_{d}}_{,k,ω}[X′_{1,ω}, X′_{2,ω}, . . . , X′_{N,ω}], can be obtained by using Y_{∈τ}_{₁}_{,k,ω} defined above and the knowledge of the code for DCS d, which is c_{d}. This is obtained as follows due to the orthogonality of the chosen codewords (for example Hadamard or DFT as explained in the embodiments for the codeword assignment step).

$${[ {c}_{d}^{1} {I}_{{M}_{k}} , … , {c}_{d}^{T} {I}_{{M}_{k}} ]}^{*} {Y}_{∈ {τ}_{1} , k , ω} = {[ {c}_{d}^{1} {I}_{{M}_{k}} , … , {c}_{d}^{T} {I}_{{M}_{k}} ]}^{*} [ \begin{matrix}{I}_{{M}_{k}} , {c}_{1}^{1} {I}_{{M}_{k}} , … , {c}_{D}^{1} {I}_{{M}_{k}} \\ {I}_{{M}_{k}} , {c}_{1}^{2} {I}_{{M}_{k}} , … , {c}_{D}^{2} {I}_{{M}_{k}} \\ ⋮ \\ {I}_{{M}_{k}} , {c}_{1}^{T} {I}_{{M}_{k}} , … , {c}_{D}^{T} {I}_{{M}_{k}}\end{matrix} ] [ \begin{matrix}{H}_{0 , k , ω} \\ {H}_{{DCS}_{1} , k , ω} \\ ⋮ \\ {H}_{{DCS}_{D} , k , ω}\end{matrix} ] [ {X}_{1 , ω}^{′} , {X}_{2 , ω}^{′} , … , {X}_{N , ω}^{′} ] = [ \begin{matrix}{1}_{{dM}_{k} + 1 , {M}_{k} ( D + 1 )} \\ {1}_{{dM}_{k} + 2 , {M}_{k} ( D + 1 )} \\ ⋮ \\ {1}_{{dM}_{k} + {M}_{k} ( D + 1 )}\end{matrix} ] [ \begin{matrix}{H}_{0 , k , ω} \\ {H}_{{DCS}_{1} , k , ω} \\ ⋮ \\ {H}_{{DCS}_{D} , k , ω}\end{matrix} ] [ {X}_{1 , ω}^{′} , {X}_{2 , ω}^{′} , … , {X}_{N , ω}^{′} ] = {H}_{{DCS}_{d} , k , ω} [ {X}_{1 , ω}^{′} , {X}_{2 , ω}^{′} , … , {X}_{N , ω}^{′} ] \qquad \begin{matrix}Equation \\ ( 38 )\end{matrix}$$

In the last steps of Equation (38) it was used that

$${[ {c}_{d}^{1} {I}_{{M}_{k}} , … , {c}_{d}^{T} {I}_{{M}_{k}} ]}^{*} [ \begin{matrix}{c}_{d}^{1} , {I}_{{M}_{k}} \\ ⋮ \\ {c}_{d}^{T} , {I}_{{M}_{k}}\end{matrix} ] = \{ \begin{matrix}{0}_{{M}_{k}} for d \neq {d}^{′} \\ {I}_{{M}_{k}} for d = {d}^{′}\end{matrix} \qquad \begin{matrix}Equation \\ ( 39 )\end{matrix}$$

$$and also$$

$${[ {c}_{d}^{1} {I}_{{M}_{k}} , … , {c}_{d}^{T} {I}_{{M}_{k}} ]}^{*} [ \begin{matrix}{I}_{{M}_{k}} \\ ⋮ \\ {I}_{{M}_{k}}\end{matrix} ] = {0}_{{M}_{k}} unless {c}_{d}^{1} = {c}_{d}^{2} = … = {c}_{d}^{T} = 1 , \qquad \begin{matrix}Equation \\ ( 40 )\end{matrix}$$

where 0_{M}_{ₖ} is an Mₖ×Mₖ matrix of all zeros. Here, [ ]* was used to denote the conjugate of [ ] and 1_{dM}_{ₖ}_{+i,M}_{ₖ}_{(D+1)} is a row vector of size Mₖ (D+1) with entry d*Mₖ+i equal to one and all other entries equal to zero. The multiplication with [c_{d}¹I_{M}_{ₖ}, . . . , c_{d}^{T}I_{M}_{ₖ}]* is a linear transformation that is based on conjugate codeword components.

From Equation (38), it can be seen that by computing [c_{d}¹I_{M}_{ₖ}, . . . , c_{d}^{T}I_{M}_{ₖ}]*Y_{∈τ}_{₁}_{,k,ω}, one obtains

$${H}_{{DCS}_{d} , k , ω} [ {X}_{1 , ω}^{′} , {X}_{2 , ω}^{′} , … , {X}_{N , ω}^{′} ] \qquad \begin{matrix}Equation \\ ( 41 )\end{matrix}$$

and by computing [I_{M}_{ₖ}, . . . ,I_{M}_{ₖ}]*Y_{∈τ}_{₁}_{,k,ω}, one obtains

$${H}_{0 , k , ω} [ {X}_{1 , ω}^{′} , {X}_{2 , ω}^{′} , … , {X}_{N , ω}^{′} ] . \qquad \begin{matrix}Equation \\ ( 42 )\end{matrix}$$

Thus, by applying the linear transformation that is based on the conjugate codeword components, the signal components that are received by the UEs via the non-DCS channel and via the individual DCSs can be separated from each other.

By adding Equation (42) and Equation (41) computed for all D DCSs, one obtains

$$( {H}_{0 , k , ω} + {\sum }_{d = 1}^{D} {H}_{{DCS}_{d} , k , ω} ) [ {X}_{1 , ω}^{′} , {X}_{2 , ω}^{′} , … , {X}_{N , ω}^{′} ] \qquad \begin{matrix}Equation \\ ( 43 )\end{matrix}$$

In the equation above, (H_{0,k,ω}+1H_{DCS}_{_{d}}_{,k,ω}) is the aggregate channel observed before time interval τ₁. This channel can be obtained via conventional training that can be performed at an earlier point in time, since it is needed to decode earlier symbols, or it can be computed from previously received information (e.g. via joint data and channel estimation for OFDM symbols before the coding time interval τ₁ starts). Using the knowledge of the aggregate channel (H_{0,k,ω}+Σ_{d=1}^{D}H_{DCS}_{_{d}}_{,k,ω}), Equation (43) can be solved for [X′_{1,ω}, X′_{2,ω}, . . . , X′_{N,ω}]. Using the computed [X′_{1,ω}, X′_{2,ω}, . . . , X′_{N,ω}], Equation (42) can be solved for H_{0,k,ω} and Equation (41) can be solved for H_{DCS}_{_{d}}_{,k,ω} for all D DCS, for example by multiplying by the inverse or pseudo-inverse of [X′_{1,ω}, X′_{2,ω}, . . . , X′_{N,ω}]. Thus, estimates of the non-DCS and DCS channels are obtained. These estimates can later be used for further post-processing to enhance the decoding of [X′_{1,ω}, X′_{2,ω}, . . . , X′_{N,ω}]. In this embodiment, there is a tradeoff: the data symbols [X′_{1,ω}, X′_{2,ω}, . . . , X′_{N,ω}] span multiple OFDM symbols. This reduces the communication rate but results in improved SNR. Thus, a higher Modulation and Coding Scheme (MCS) can be used to avoid rate loss due to the repetition of data during the time slots of coded DCS phases, i.e. during the coding time interval

### Embodiments for the Coding Time Interval Assignment Step, the Transmission Signal Assignment Step and the Signal Component Separation and Channel Estimation Step for the Case of Uplink, MIMO and DCS Coding Over Multiple OFDM Symbols

In this embodiment, an uplink multiple input multiple output (MIMO) case is considered where the BS has N receive antennas and the UEs have multiple transmit antennas. Mₖ denotes the number of transmit antennas at the k-th UE. Thus, a total number of M=Σₖ₌₁^{K}Mₖ transmit antennas is used for the uplink. As part of the coding time interval assignment step, a single coding time interval τ₁ during which the DCSs will apply the coded scattering pattern sequence is defined. Given the codewords c₁, c₂, . . . , c_{D} defined in the codeword assignment step where, as mentioned above, each codeword is of size T, in this embodiment a duration of T₁ equal to the duration of T*M OFDM symbols is defined. This coding time interval τ₁ is divided into T subintervals labeled as τ₁, τ₂, . . . , [symbol] , . . . , τ_{T}. Each of the subintervals is further divided into M subintervals where [symbol] is used to denote the m-th subinterval within subinterval [symbol] . Thus, if the duration of one OFDM symbol is equal to μ_{OFDM} seconds, then the duration of [symbol] is also equal to μ_{OFDM}, the duration of [symbol] is equal to M*μ_{OFDM} and the duration of τ₁ is equal to T*M*μ_{OFDM} seconds. Furthermore, in this embodiment, as part of the coding time interval assignment step, the coding time interval τ₁ is defined to start at the [symbol] +1-th OFDM symbol and it is defined that at subinterval τₜ, each of the DCSs applies each its corresponding codeword component [symbol] .

In the transmission signal assignment step, the signal that is transmitted during the coding time interval τ₁ is defined. A vector [symbol] (t) of length Mₖ is used to denote the signal transmitted at time t and during the [symbol] -th OFDM symbol by UE k. Since the coding time interval τ₁ has been defined in the coding time interval assignment step to start at symbol [symbol] +1 and to last T*M OFDM symbols, in the transmission signal assignment step the signals [symbol] (t), [symbol] (t), . . . , [symbol] (t) for all users k=1, 2, . . . K are defined as follows:

$${x}_{ℓ + ( - 1 ) M + m , k} ( t ) = {x}_{m , k}^{′} ( t ) for = 1 , 2 , … , T , for m = 1 , 2 , … , M and for k = 1 , 2 , … , K \qquad \begin{matrix}Equation \\ ( 44 )\end{matrix}$$

Thus,

$${x}_{ℓ + m , k} ( t ) = {x}_{ℓ + M + m , k} ( t ) = {x}_{ℓ + 2 M + m , k} ( t ) = … = {x}_{ℓ + ( T - 1 ) M + m , k} ( t ) = {x}_{m , k}^{′} ( t ) \qquad \begin{matrix}Equation \\ ( 45 )\end{matrix}$$

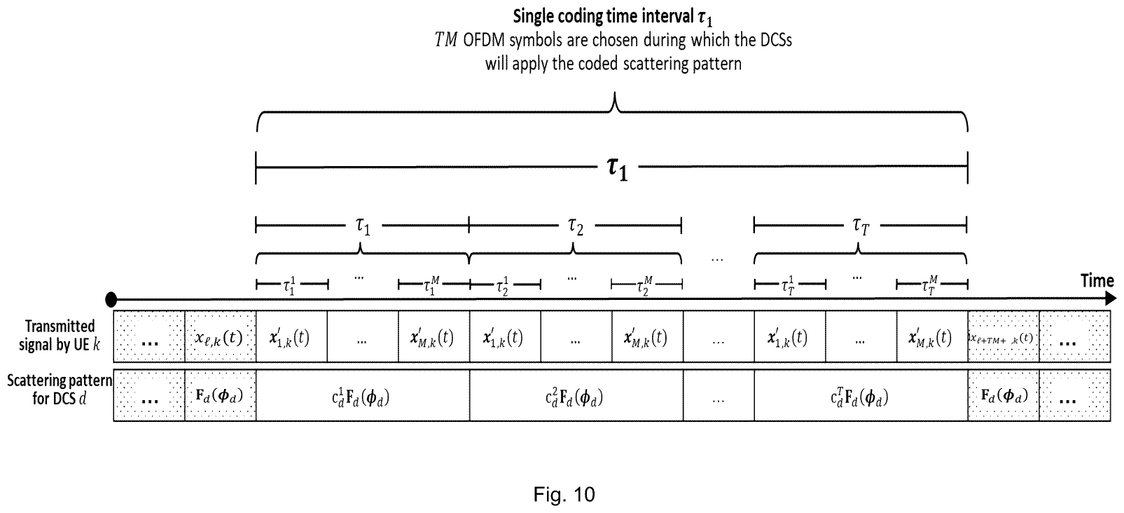

for m=1, 2, . . . , M and for k=1, 2, . . . K, which means that at the time subinterval [symbol] the transmitted signal by UE k is equal to x′_{m,k}(t). In the equations above, x′_{m,k}(t) is a vector of length Mₖ representing the signal transmitted by each of the transmitter antennas of user k at time t. FIG. 10 shows a time diagram of the transmitted signal and the coded scattering pattern sequence at a DCS d that is applied during the coding time interval τ₁ as defined in this embodiment. The timing diagram shows an example where DCS d applies the coded scattering pattern sequence [c_{d}¹F_{d}(ϕ_{d}), c_{d}²F_{d}(ϕ_{d}), . . . , [symbol] F_{d}(ϕ_{d}), . . . , c_{d}^{T}F_{d}(ϕ_{d})] during transmission of UE k's uplink OFDM symbols [symbol] +1, [symbol] +2 until [symbol] +TM which correspond to the coding time interval τ₁.

Since this embodiment uses OFDM waveforms, the transmitted and received signals can be expressed as follows. For an OFDM symbol consisting of N_{c} orthogonal subcarriers, the frequency representation [symbol] of the transmitted signal [symbol] (t) can be written as [symbol] =[ [symbol] , [symbol] , . . . , [symbol] , . . . , [symbol] ], where [symbol] is a complex matrix of size Mₖ×1 that represents the information transmitted on the Mₖ transmitters antenans of UE k on the ω-th subcarrier at the [symbol] -th OFDM symbol. Assuming signal components of all non-DCS and DCS paths from all users arrive within the cyclic prefix then, after proper cyclic prefix removal, the frequency domain representation of the received signal in the uplink from UE k at subcarrier ω due to transmission of [symbol] by user k can be written as

$${Y}_{ℓ , k , ω} = {H}_{0 , k , ω} {X}_{ℓ , k , ω} + {\sum }_{d = 1}^{D} {H}_{{DCS}_{d} , k , ω} {X}_{ℓ , k , ω} = ( {H}_{0 , k , ω} + {\sum }_{d = 1}^{D} {H}_{{DCS}_{d} , k , ω} ) {X}_{ℓ , k , ω} \qquad \begin{matrix}Equation \\ ( 46 )\end{matrix}$$

where H_{0,k,ω} and H_{DCS}_{_{d}}_{,k,ω} are N×Mₖ matrices. These matrices represent the non-DCS and DCS d channel frequency response, respectively, at subcarrier ω for user k. Equation (46) has the same form as Equation (1) but is written in the frequency domain.

In the following, the effect that the scattering pattern F_{d}(ϕd) and the coded scattering pattern [symbol] (ϕ_{d}) have on the DCS channel H_{Dcs}_{_{d}}_{,k} will be explained. It is known that for a given scattering pattern F_{d} (ϕ_{d}), the DCS channel can be written as a cascade of three matrices as

$${H}_{{DCS}_{d} , k , ω} = {H}_{{DCS}_{d} \to BS , ω} {F}_{d} ( {ϕ}_{d} ) {H}_{{UE}_{k} \to {DCS}_{d} , ω} \qquad \begin{matrix}Equation \\ ( 47 )\end{matrix}$$

where, in this case of MIMO uplink, the channel between DCS d and the BS at subcarrier a, namely H_{DCS}_{_{d}}_{→BS,ω}, and the channel between UE k and DCS d at subcarrier a, namely H_{UE}_{ₖ}_{→DCS}_{_{d}}_{,ω} are matrices of size N×S_{d} and S_{d}×Mₖ, respectively. As mentioned above, S_{d} is the number of scattering elements at DCS d. If, instead of using the scattering pattern F_{d}(ϕ_{d}), the coded scattering pattern [symbol] (ϕ_{d}) is used, then the channel can be written as

$${H}_{{DCS}_{d} , k , ω} \qquad Equation ( 48 )$$

since this is what is obtained by replacing F_{d}(ϕ_{d}) with [symbol] F_{d}(ϕ_{d}) in Equation (47) and then simplifying as follows using the fact that [symbol] is a scalar:

$${H}_{{DCS}_{d} \to BS , ω} ( {F}_{d} ( {ϕ}_{d} ) ) {H}_{{UE}_{k} \to {DCS}_{d} , ω} = ( {H}_{{DCS}_{d} \to BS , ω} {F}_{d} ( {ϕ}_{d} ) {H}_{{UE}_{k} \to {DCS}_{d} , ω} ) = {H}_{{DCS}_{d} , k , ω} \qquad Equation ( 49 )$$

Assuming all transmissions of interest happen within the channel coherence time (i.e. the channels H_{0,k,ω}, H_{DCS}_{_{d}}_{→BSω} and H_{UE}_{ₖ}_{→DCS}_{_{d}}_{,ω} remain constant), the signal received at the BS at the DCS operation step (as mentioned above this step corresponds to over-the-air transmission and reception and applying DCS coding during the coding time interval τ₁) can be written as in Equation (46) when using the scattering pattern without coding, F_{d}(ϕ_{d}), and as

$${Y}_{ℓ , k , ω} = {H}_{0 , k , ω} {X}_{ℓ , k , ω} + {\sum }_{d = 1}^{D} {X}_{ℓ , k , ω} = ( {H}_{0 , k , ω} + {\sum }_{d = 1}^{D} ) {X}_{ℓ , k , ω} \qquad Equation ( 50 )$$

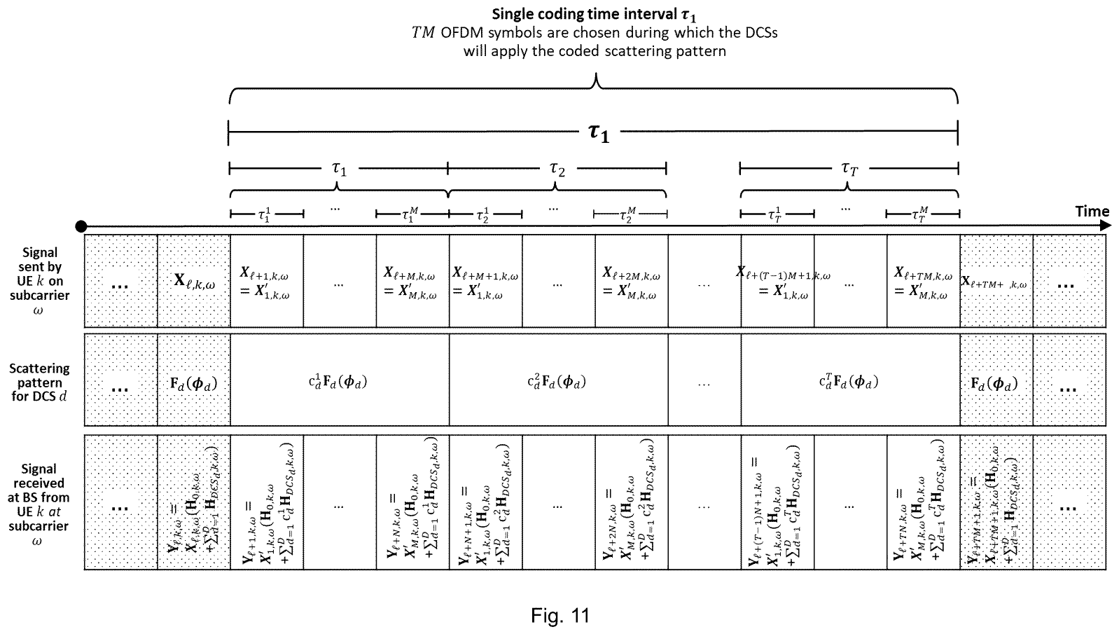

when using the scattering pattern with coding, [symbol] F_{d}(ϕ_{d}). This follows from Equation (47), Equation (48) and Equation (49). For illustration, a timing diagram with transmitted and received signals in the uplink MIMO scenario is shown in FIG. 11. The timing diagram illustrates the signal sent by UE k on subcarrier ω and the signal received at BS from UE k at subcarrier ω during OFDM symbols without DCS coding (outside time interval τ₁) and with DCS coding (inside time interval τ₁) for the uplink MIMO case.

Using Y_{∈τ}_{₁}_{,k,ω} to denote the received uplink signal for an OFDM symbol outside the coding time interval τ₁ and [symbol] to denote the received uplink signal for subinterval [symbol] (which is the received signal for OFDM symbol [symbol] +( [symbol] −1)M+m), Equation (46) and Equation (50), respectively, can be rewritten as below where the signals have further been rewritten in matrix form. Accordingly,

$$= ( {H}_{0 , k , ω} + {\sum }_{d = 1}^{D} {H}_{{DCS}_{d} , k , ω} ) {X}_{ℓ , k , ω} = [ {I}_{N} , {I}_{N} , ... , {I}_{N} ] [ \begin{matrix}{H}_{0 , k , ω} \\ {H}_{{DCS}_{1} , k , ω} \\ ⋮ \\ {H}_{{DCS}_{D} , k , ω}\end{matrix} ] {X}_{ℓ , k , ω} \qquad Equation ( 51 )$$

$$and$$

$$= = ( {H}_{0 , k , ω} + {\sum }_{d = 1}^{D} ) = ( {H}_{0 , k , ω} + {\sum }_{d = 1}^{D} ) {X}_{m , k , ω}^{′} = [ {I}_{N} , , ... , {I}_{N} ] [ \begin{matrix}{H}_{0 , k , ω} \\ {H}_{{DCS}_{1} , k , ω} \\ ⋮ \\ {H}_{{DCS}_{D} , k , ω}\end{matrix} ] {X}_{m , k , ω}^{′} \qquad Equation ( 52 )$$

where I_{N} is the identity matrix of size N. Here, it was used that during the interval [symbol] the transmitted signal for user k is fixed to x′_{m,k}(t) which is an OFDM symbol that can be written in the frequency domain as X′_{m,k}=[X′_{m,k,1}, X′_{m,k,2}, . . . , X′_{m,k,ω}, . . . , X′_{m,k,N}_{_{c}}]. X′_{m,k,ω} is a complex matrix of size Mₖ×1. Mₖ is the number of transmitter antennas at the UE and the matrix X′_{m,k,ω} represents the information transmitted on the ω-th subcarrier at time subinterval [symbol] from UE k. Also, in Equation (52), it was used that at time subinterval [symbol] DCS d uses codeword component [symbol] .

Taking into account the contribution from all the K users for an OFDM symbol outside interval τ₁, the received signal is obtained using Equation (51) as follows:

$${Y}_{∉ {τ}_{1} , ω} = {\sum }_{k = 1}^{K} {Y}_{∉ {τ}_{1} , k , ω} = [ {I}_{N} , {I}_{N} , ... , {I}_{N} ] [ \begin{matrix}{H}_{0 , 1 , ω} \\ {H}_{{DCS}_{1} , 1 , ω} \\ ⋮ \\ {H}_{{DCS}_{D} , 1 , ω}\end{matrix} ] {X}_{ℓ , 1 , ω} + … + [ {I}_{N} , {I}_{N} , ... , {I}_{N} ] [ \begin{matrix}{H}_{0 , K , ω} \\ {H}_{{DCS}_{1} , K , ω} \\ ⋮ \\ {H}_{{DCS}_{D} , K , ω}\end{matrix} ] {X}_{ℓ , K , ω} = [ {I}_{N} , {I}_{N} , ... , {I}_{N} ] [ \begin{matrix}{H}_{0 , 1 , ω} & {H}_{0 , 2 , ω} & … & {H}_{0 , K , ω} \\ {H}_{{DCS}_{1} , 1 , ω} & {H}_{{DCS}_{1} , 2 , ω} & ⋱ & {H}_{{DCS}_{1} , K , ω} \\ ⋮ & ⋮ & ⋱ & ⋮ \\ {H}_{{DCS}_{D} , 1 , ω} & {H}_{{DCS}_{D} , 2 , ω} & … & {H}_{{DCS}_{D} , K , ω}\end{matrix} ] [ \begin{matrix}{X}_{ℓ , 1 , ω} \\ {X}_{ℓ , 2 , ω} \\ ⋮ \\ {X}_{ℓ , K , ω}\end{matrix} ] = {H}_{∉ {τ}_{1} , ω} [ \begin{matrix}{X}_{ℓ , 1 , ω} \\ {X}_{ℓ , 2 , ω} \\ ⋮ \\ {X}_{ℓ , K , ω}\end{matrix} ] \qquad Equation ( 53 )$$

Herein, H_{∈τ}_{₁}_{, ω}, is a matrix of size N×M. The received signal taking account the contribution from all the K users inside interval τ₁ is obtained using Equation (52) as follows:

$$= {\sum }_{k = 1}^{K} = [ {I}_{N} , {I}_{N} , ... , {I}_{N} ] [ \begin{matrix}{H}_{0 , 1 , ω} \\ {H}_{{DCS}_{1} , 1 , ω} \\ ⋮ \\ {H}_{{DCS}_{D} , 1 , ω}\end{matrix} ] {X}_{m , 1 , ω}^{′} + … + [ {I}_{N} , {I}_{N} , ... , {I}_{N} ] [ \begin{matrix}{H}_{0 , K , ω} \\ {H}_{{DCS}_{1} , K , ω} \\ ⋮ \\ {H}_{{DCS}_{D} , K , ω}\end{matrix} ] {X}_{m , K , ω}^{′} = [ {I}_{N} , {I}_{N} , ... , {I}_{N} ] [ \begin{matrix}{H}_{0 , 1 , ω} & {H}_{0 , 2 , ω} & … & {H}_{0 , K , ω} \\ {H}_{{DCS}_{1} , 1 , ω} & {H}_{{DCS}_{1} , 2 , ω} & ⋱ & {H}_{{DCS}_{1} , K , ω} \\ ⋮ & ⋮ & ⋱ & ⋮ \\ {H}_{{DCS}_{D} , 1 , ω} & {H}_{{DCS}_{D} , 2 , ω} & … & {H}_{{DCS}_{D} , K , ω}\end{matrix} ] [ \begin{matrix}{X}_{m , 1 , ω}^{′} \\ {X}_{m , 2 , ω}^{′} \\ ⋮ \\ {X}_{m , K , ω}^{′}\end{matrix} ] = {H}_{∈ {τ}_{1} , ω} [ \begin{matrix}{X}_{m , 1 , ω}^{′} \\ {X}_{m , 2 , ω}^{′} \\ ⋮ \\ {X}_{m , K , ω}^{′}\end{matrix} ] . \qquad Equation ( 54 )$$

Here, H_{∈τ}_{₁}_{,ω} is a matrix of size N×M.

In the signal component separation and channel estimation step, knowledge of the received signals, [symbol] is used for [symbol] =1, 2, . . . , T and for m=1, 2, . . . , M (i.e. the signals received during the coding time interval τ₁) and the codewords used by the DCSs, namely c₁, c₂, . . . , c_{D} are used in order to obtain for each user k the non-DCS signal H_{0,k,ω}X′_{m,k,ω} and the DCS signals H_{DCS}_{₁}_{,k,ω}X′_{m,k,ω}, H_{Dcs}_{₂}_{,k,ω}X′_{m,k,ω}, . . . , H_{DCS}_{_{D}}_{,k,ω}X′_{m,k,ω}, and to further estimate the non-DCS channel H_{0,k,ω}, and the DCS channels H_{DcS}_{₁}_{,k,ω}, H_{DCS}_{₂}_{,k,ω}, . . . , H_{DCS}_{_{D}}_{,k,ω}.

Stacking the TM observations [symbol] for [symbol] =1, 2, . . . , T and for m=1, 2, . . . , the received signals can be rewritten as follows:

$${Y}_{∈ {τ}_{1} , ω} = [ \begin{matrix}{Y}_{∈ {τ}_{1}^{1} , ω} & {Y}_{∈ {τ}_{1}^{2} , ω} & … & {Y}_{∈ {τ}_{1}^{M} , ω} \\ {Y}_{∈ {τ}_{2}^{1} , ω} & {Y}_{∈ {τ}_{2}^{2} , ω} & … & {Y}_{∈ {τ}_{2}^{M} , ω} \\ ⋮ & ⋮ & … & ⋮ \\ {Y}_{∈ {τ}_{T}^{1} , ω} & {Y}_{∈ {τ}_{T}^{2} , ω} & … & {Y}_{∈ {τ}_{T}^{M} , ω}\end{matrix} ] = [ \begin{matrix}{I}_{N} , {c}_{1}^{1} {I}_{N} , ... , {c}_{D}^{1} {I}_{N} \\ {I}_{N} , {c}_{1}^{2} {I}_{N} , ... , {c}_{D}^{2} {I}_{N} \\ ⋮ \\ {I}_{N} , {c}_{1}^{T} {I}_{N} , ... , {c}_{D}^{T} {I}_{N}\end{matrix} ] [ \begin{matrix}{H}_{0 , 1 , ω} & {H}_{0 , 2 , ω} & … & {H}_{0 , K , ω} \\ {H}_{{DCS}_{1} , 1 , ω} & {H}_{{DCS}_{1} , 2 , ω} & ⋱ & {H}_{{DCS}_{1} , K , ω} \\ ⋮ & ⋮ & ⋱ & ⋮ \\ {H}_{{DCS}_{D} , 1 , ω} & {H}_{{DCS}_{D} , 2 , ω} & … & {H}_{{DCS}_{D} , K , ω}\end{matrix} ] [ \begin{matrix}{X}_{1 , 1 , ω}^{′} & {X}_{2 , 1 , ω}^{′} & … & \text{?} \\ {X}_{1 , 2 , ω}^{′} & {X}_{2 , 2 , ω}^{′} & ⋱ & \text{?} \\ ⋮ & ⋮ & ⋱ & ⋮ \\ {X}_{1 , K , ω}^{′} & {X}_{2 , K , ω}^{′} & … & \text{?}\end{matrix} \text{?} \qquad Equation ( 55 )$$

$$\text{?} \text{indicates text missing or illegible when filed}$$

The signal received via the DCS d due to the K users transmissions during the coding interval τ₁ and without the effect of coding, namely

$$[ {H}_{{DCS}_{1} , 1 , ω} , {H}_{{DCS}_{1} , 2 , ω} , ... , \\ {H}_{{DCS}_{1} , K , ω} ] [ \begin{matrix}{X}_{1 , 1 , ω}^{′} & {X}_{2 , 1 , ω}^{′} & … & {X}_{M , 1 , ω}^{′} \\ {X}_{1 , 2 , ω}^{′} & {X}_{2 , 2 , ω}^{′} & ⋱ & {X}_{M , 2 , ω}^{′} \\ ⋮ & ⋮ & ⋱ & ⋮ \\ {X}_{1 , K , ω}^{′} & {X}_{2 , K , ω}^{′} & … & {X}_{M , K , ω}^{′}\end{matrix} ] , \qquad Equation ( 56 \text{?}$$

$$\text{?} \text{indicates text missing or illegible when filed}$$

is obtained by using Y_{∈τ1,ω} defined above and the knowledge of the code for DCS d, c_{d}. It is obtained as follows due to the orthogonality of the chosen codewords (for example Hadamard or DFT as explained in the embodiments for the codeword assignment step):

$${[ {c}_{d}^{1} {I}_{N} , ... , {c}_{d}^{T} {I}_{N} ]}^{*} {Y}_{i ∈ {τ}_{1} , ω} = {[ {c}_{d}^{1} {I}_{N} , ... , {c}_{d}^{T} {I}_{N} ]}^{*} [ \begin{matrix}{I}_{N} , {c}_{1}^{1} {I}_{N} , ... , {c}_{D}^{1} {I}_{N} \\ {I}_{N} , {c}_{1}^{2} {I}_{N} , ... , {c}_{D}^{2} {I}_{N} \\ ⋮ \\ {I}_{N} , {c}_{1}^{T} {I}_{N} , ... , {c}_{D}^{T} {I}_{N}\end{matrix} ] [ \begin{matrix}{H}_{0 , 1 , ω} & {H}_{0 , 2 , ω} & … & {H}_{0 , K , ω} \\ {H}_{{DCS}_{1} , 1 , ω} & {H}_{{DCS}_{1} , 2 , ω} & ⋱ & {H}_{{DCS}_{1} , K , ω} \\ ⋮ & ⋮ & ⋱ & ⋮ \\ {H}_{{DCS}_{D} , 1 , ω} & {H}_{{DCS}_{D} , 2 , ω} & … & {H}_{{DCS}_{D} , K , ω}\end{matrix} ] [ \begin{matrix}{X}_{1 , 1 , ω}^{′} & \text{?} \\ {X}_{1 , 2 , ω}^{′} & \text{?} \\ ⋮ & ⋮ \\ {X}_{1 , K , ω}^{′} & \text{?}\end{matrix} \text{?} = [ \begin{matrix}{1}_{dN + 1 , N ( D + 1 )} \\ {1}_{dN + 2 , N ( D + 1 )} \\ ⋮ \\ {1}_{dN + N , N ( N + 1 )}\end{matrix} ] [ \begin{matrix}{H}_{0 , 1 , ω} & {H}_{0 , 2 , ω} & … & {H}_{0 , K , ω} \\ {H}_{{DCS}_{1} , 1 , ω} & {H}_{{DCS}_{1} , 2 , ω} & ⋱ & {H}_{{DCS}_{1} , K , ω} \\ ⋮ & ⋮ & ⋱ & ⋮ \\ {H}_{{DCS}_{D} , 1 , ω} & {H}_{{DCS}_{D} , 2 , ω} & … & {H}_{{DCS}_{D} , K , ω}\end{matrix} ] [ \begin{matrix}{X}_{1 , 1 , ω}^{′} & {X}_{2 , 1 , ω}^{′} & … & {X}_{M , 1 , ω}^{′} \\ {X}_{1 , 2 , ω}^{′} & {X}_{2 , 2 , ω}^{′} & ⋱ & {X}_{M , 2 , ω}^{′} \\ ⋮ & ⋮ & ⋱ & ⋮ \\ {X}_{1 , K , ω}^{′} & {X}_{2 , K , ω}^{′} & … & {X}_{M , K , ω}^{′}\end{matrix} ] = [ {H}_{{DCS}_{d} , 1 , ω} , {H}_{{DCS}_{d} , 2 , ω} , ... , {H}_{{DCS}_{d} , K , ω} ] [ \begin{matrix}{X}_{1 , 1 , ω}^{′} & {X}_{2 , 1 , ω}^{′} & … & {X}_{M , 1 , ω}^{′} \\ {X}_{1 , 2 , ω}^{′} & {X}_{2 , 2 , ω}^{′} & ⋱ & {X}_{M , 2 , ω}^{′} \\ ⋮ & ⋮ & ⋱ & ⋮ \\ {X}_{1 , K , ω}^{′} & {X}_{2 , K , ω}^{′} & … & {X}_{M , K , ω}^{′}\end{matrix} ] \qquad Equation ( 57 )$$

$$\text{?} \text{indicates text missing or illegible when filed}$$

In the last steps of Equation (57), it was used that

$${[ {c}_{d}^{1} {I}_{N} , ... , {c}_{d}^{T} {I}_{N} ]}^{*} [ \begin{matrix}{c}_{d}^{1} , {I}_{N} \\ ⋮ \\ {c}_{d}^{T} , {I}_{N}\end{matrix} ] = \{ \begin{matrix}{0}_{N} & for d \neq {d}^{′} \\ {I}_{N} & for d = {d}^{′}\end{matrix} \qquad Equation ( 58 )$$

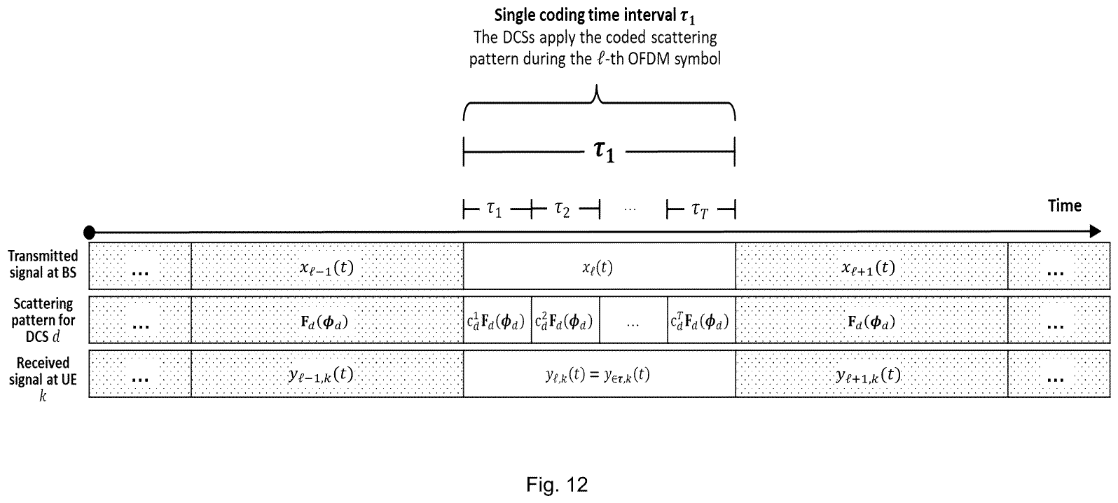

and also

$${[ {c}_{d}^{1} {I}_{N} , ... , {c}_{d}^{T} {I}_{N} ]}^{*} [ \begin{matrix}{I}_{N} \\ ⋮ \\ {I}_{N}\end{matrix} ] = {0}_{N} unless {c}_{d}^{1} = {c}_{d}^{2} = … = {c}_{d}^{T} = 1 , \qquad Equation ( 59 )$$

where θ_{N} is an N×N matrix of all zeros.
defined in the codeword assignment step are of size T, each DCS applies a codeword component [symbol] during a time duration equal to μ_{OFDM}/T seconds. Thus, the coding time interval τ₁ is divided into T subintervals τ₁, τ₂, . . . τₜ, . . . ,τ_{T}, each having a duration of μ_{OFDM}/T seconds. In this way, the DCSs are able to apply the coded scattering pattern within the duration of one (the [symbol] -th) OFDM symbol. A timing diagram showing the assignments for transmission and DCS coded scattering pattern and signal reception is shown in FIG. 12. The timing
diagram shows an example where DCS d applies the coded scattering pattern sequence [c_{d}¹F_{d}(ϕ_{d}), c_{d}²F_{d}(ϕ_{d}), . . . , [symbol] F_{d}(ϕ_{d}), . . . , c_{d}^{T}F_{d}(ϕ_{d})] during the [symbol] -th downlink OFDM symbol which corresponds to the coding time interval τ₁.

Assuming the entries of the codeword are of the form [symbol] =e^{jθ}^{_{d}}^{^{t}}, as for example is the case when Hadamard or DFT based codebooks are used, the signal received during the coding time interval τ₁, from DCS d at UE k can be written as From Equation (57), by computing [c_{d}¹I_{N}, . . . , c_{d}^{T}I_{N}]*Y_{∈τ}_{₁}_{,ω}, one obtains

$$[ {H}_{{DCS}_{d} , 1 , ω} , {H}_{{DCS}_{d} , 2 , ω} , ... , \\ {H}_{{DCS}_{d} , K , ω} ] [ \begin{matrix}{X}_{1 , 1 , ω}^{′} & {X}_{2 , 1 , ω}^{′} & … & {X}_{M , 1 , ω}^{′} \\ {X}_{1 , 2 , ω}^{′} & {X}_{2 , 2 , ω}^{′} & ⋱ & {X}_{M , 2 , ω}^{′} \\ ⋮ & ⋮ & ⋱ & ⋮ \\ {X}_{1 , K , ω}^{′} & {X}_{2 , K , ω}^{′} & … & {X}_{M , K , ω}^{′}\end{matrix} ] \qquad Equation ( 60 )$$

and by computing [I_{N}, . . . , I_{N}]*Y_{∈τ}_{₁}_{,ω} one obtains

$$[ {H}_{0 , 1 , ω} , {H}_{0 , 2 , ω} , ... , {H}_{0 , K , ω} ] [ \begin{matrix}{X}_{1 , 1 , ω}^{′} & {X}_{2 , 1 , ω}^{′} & … & {X}_{M , 1 , ω}^{′} \\ {X}_{1 , 2 , ω}^{′} & {X}_{2 , 2 , ω}^{′} & ⋱ & {X}_{M , 2 , ω}^{′} \\ ⋮ & ⋮ & ⋱ & ⋮ \\ {X}_{1 , K , ω}^{′} & {X}_{2 , K , ω}^{′} & … & {X}_{M , K , ω}^{′}\end{matrix} ] \qquad Equation ( 61 )$$

The multiplication of the received signals Y_{∈τ}_{₁}_{,ω} with [c_{d}¹I_{N}, . . . , c_{d}^{T}I_{N}]* is a linear transformation that is based on conjugate codewords. By applying this linear transformation, the signal components that are received by the BS via the individual UEs are separated.

After the separation of the signal components, the data (matrix on the right side in Equation (60) and Equation (61)) are obtained. By adding Equation (61) and Equation (60) computed for all D DCSs, one obtains

$$( [ {H}_{0 , 1 , ω} , {H}_{0 , 2 , ω} , ... , {H}_{0 , K , ω} ] + {\sum }_{d = 1}^{D} [ {H}_{{DCS}_{d} , 1 , ω} , {H}_{{DCS}_{d} , 2 , ω} , ... , {H}_{{DCS}_{d} , K , ω} ] ) [ \begin{matrix}{X}_{1 , 1 , ω}^{′} & {X}_{2 , 1 , ω}^{′} & … & {X}_{M , 1 , ω}^{′} \\ {X}_{1 , 2 , ω}^{′} & {X}_{2 , 2 , ω}^{′} & ⋱ & {X}_{M , 2 , ω}^{′} \\ ⋮ & ⋮ & ⋱ & ⋮ \\ {X}_{1 , K , ω}^{′} & {X}_{2 , K , ω}^{′} & … & {X}_{M , K , ω}^{′}\end{matrix} ] = [ {H}_{0 , 1 , ω} + {\sum }_{d = 1}^{D} {H}_{{DCS}_{d} , 1 , ω} , {H}_{0 , 2 , ω} + {\sum }_{d = 1}^{D} {H}_{{DCS}_{d} , 2 , ω} , ... , {H}_{0 , K , ω} + {\sum }_{d = 1}^{D} {H}_{{DCS}_{d} , K , ω} ] [ \begin{matrix}{X}_{1 , 1 , ω}^{′} & {X}_{2 , 1 , ω}^{′} & … & {X}_{M , 1 , ω}^{′} \\ {X}_{1 , 2 , ω}^{′} & {X}_{2 , 2 , ω}^{′} & ⋱ & {X}_{M , 2 , ω}^{′} \\ ⋮ & ⋮ & ⋱ & ⋮ \\ {X}_{1 , K , ω}^{′} & {X}_{2 , K , ω}^{′} & … & {X}_{M , K , ω}^{′}\end{matrix} ] = [ {I}_{N} , {I}_{N} , ... , {I}_{N} ] [ \begin{matrix}{H}_{0 , 1 , ω} & {H}_{0 , 2 , ω} & … & {H}_{0 , K , ω} \\ {H}_{{DCS}_{1} , 1 , ω} & {H}_{{DCS}_{1} , 2 , ω} & ⋱ & {H}_{{DCS}_{1} , K , ω} \\ ⋮ & ⋮ & ⋱ & ⋮ \\ {H}_{{DCS}_{D} , 1 , ω} & {H}_{{DCS}_{D} , 2 , ω} & … & {H}_{{DCS}_{D} , K , ω}\end{matrix} ] [ \begin{matrix}{X}_{1 , 1 , ω}^{′} & {X}_{2 , 1 , ω}^{′} & … & {X}_{M , 1 , ω}^{′} \\ {X}_{1 , 2 , ω}^{′} & {X}_{2 , 2 , ω}^{′} & ⋱ & {X}_{M , 2 , ω}^{′} \\ ⋮ & ⋮ & ⋱ & ⋮ \\ {X}_{1 , K , ω}^{′} & {X}_{2 , K , ω}^{′} & … & {X}_{M , K , ω}^{′}\end{matrix} ] = {H}_{∉ {τ}_{1} , ω} [ \begin{matrix}{X}_{1 , 1 , ω}^{′} & {X}_{2 , 1 , ω}^{′} & … & {X}_{M , 1 , ω}^{′} \\ {X}_{1 , 2 , ω}^{′} & {X}_{2 , 2 , ω}^{′} & ⋱ & {X}_{M , 2 , ω}^{′} \\ ⋮ & ⋮ & ⋱ & ⋮ \\ {X}_{1 , K , ω}^{′} & {X}_{2 , K , ω}^{′} & … & {X}_{M , K , ω}^{′}\end{matrix} ] \qquad Equation ( 62 )$$

In the equation above, H_{∈τ}_{₁}_{,ω} is the aggregate channel observed before the coding time interval τ₁, which is defined as in Equation (53). This aggregate channel can be determined via conventional training carried out at an earlier time since it is needed to decode earlier symbols, or it can be computed from previously received information (e.g. via joint data and channel estimation for OFDM symbols before the coding time interval τ₁ starts). Using the knowledge of this aggregate channel H_{∈τ}_{₁}_{, ω},W Equation (62) can be solved for

$${X}_{ω}^{′} = [ \begin{matrix}{X}_{1 , 1 , ω}^{′} & {X}_{2 , 1 , ω}^{′} & … & {X}_{M , 1 , ω}^{′} \\ {X}_{1 , 2 , ω}^{′} & {X}_{2 , 2 , ω}^{′} & ⋱ & {X}_{M , 2 , ω}^{′} \\ ⋮ & ⋮ & ⋱ & ⋮ \\ {X}_{1 , K , ω}^{′} & {X}_{2 , K , ω}^{′} & … & {X}_{M , K , ω}^{′}\end{matrix} ] \qquad Equation ( 63 )$$

Using these, Equation (61) can be solved for [H_{0,1,ω}, H_{0,2,ω}, . . . , H_{0,K,ω}] and Equation (60) can be solved for [H_{DCS}_{_{d}}_{,1,ω}, H_{DCS}_{_{d}}_{,2,ω}, . . . , H_{DCS}_{_{d}}_{,Kω}] for all D DCS, for example by multiplying by the inverse or pseudo-inverse of X. Thus, an estimate of the non-DCS and DCS channels is obtained. These estimates can later be used for further post processing to enhance the decoding of X′_{ω}. In this embodiment, there is a tradeoff: the data symbols in X′_{ω} span multiple OFDM symbols. This reduces the communication rate but results in improved SNR thus higher Modulation and Coding Scheme (MCS) can be used to avoid rate loss due to the repetition of data during the time slots of coded DCS phases, i.e. during the coding time interval

### Embodiments for the Coding Time Interval Assignment Step, the Transmission Signal Assignment Step and the Signal Component Separation and Channel Estimation Step for the Case of DCS Coding Over a Single OFDM Symbol and a Downlink SISO Scenario

As mentioned above, in the coding time interval assignment step, one, τ₁, or more, τ₁, τ₂, τ₃, . . . coding time intervals during which the DCSs will apply the coded scattering pattern sequence is defined. In this embodiment, there is a single coding time interval τ₁, the duration of which is equal to the duration of one OFDM symbol. Thus, if the duration of one OFDM symbol is equal to μ_{OFDM} seconds, then the duration of the coding time interval τ₁ is also equal to μ_{OFDM} seconds. Furthermore, in this embodiment, as part of the coding time interval assignment step, the coding time interval τ₁ is defined to correspond to the [symbol] -th OFDM symbol.

In the transmission signal assignment step, the signal that is transmitted during the coding time interval τ₁ is defined. In this embodiment, there is no constraint the signal transmitted in this interval. Hence, any OFDM symbol [symbol] (t) of duration μ_{OFDM} can be transmitted. Since the codewords c₁, c₂, . . . , c_{D}

$${y}_{∈ {τ}_{1} , {DCS}_{d} , k} ( t ) = {e}^{j {Θ}_{d} ( t )} {y}_{{DCS}_{d} , k , ℓ} ( t ) \qquad Equation ( 64 )$$

where [symbol] (t) corresponds to the theoretically received signal due to transmission of [symbol] (t) for the baseline case of no DCS coding, where [symbol] = [symbol] =1. The phase shift due to

$${Θ}_{d} ( t ) = \{ \begin{matrix}{θ}_{d}^{1} , t ∈ {τ}_{1} \\ {θ}_{d}^{2} , t ∈ {τ}_{2} \\ ⋮ \\ {θ}_{d}^{𝓉} , t ∈ {τ}_{𝓉} \\ ⋮ \\ {θ}_{d}^{T} , t ∈ {τ}_{T}\end{matrix} . \qquad Equation ( 65 )$$

the DCS coding is captured by the term e^{jθ}^{_{d}}^{(t)} in Equation (64), where

Using y_{∈τ}_{₁}_{,DCS}_{_{d}}_{,k}(t) in Equation (64), the signal received during the coding time interval τ₁ at UE k when taking into account the signal component received via all non-DCS paths, which is y_{∈τ}_{₁}_{,0,k}(t) and the signal components received via the DCS paths can be written as

$$\begin{matrix}{y}_{∈ {τ}_{1} , k} ( t ) = {y}_{∈ {τ}_{1} , 0 , k} ( t ) + {\sum }_{d = 1}^{D} {y}_{∈ {τ}_{1} , {DCS}_{d} , k} ( t ) \\ = {y}_{∈ {τ}_{1} , 0 , k} ( t ) + {\sum }_{d = 1}^{D} {e}^{j {Θ}_{d} ( t )} {y}_{{DCS}_{d} , k , ℓ} ( t )\end{matrix} \qquad Equation ( 66 )$$

By multiplying this received signal y_{∈τ}_{₁}_{,k}(t) with e^{-jθ9}^{_{d′}}^{(t)}, one obtains

$$\begin{matrix}{y}_{∈ {τ}_{1} , k , {d}^{′}} ( t ) = {e}^{- j {Θ}_{d ′} ( t )} {y}_{∈ {τ}_{1} , k} ( t ) \\ = {e}^{- j {Θ}_{d ′} ( t )} {y}_{∈ {τ}_{1} , 0 , k} ( t ) + \\ {\sum }_{d = 1}^{D} {e}^{j ( {Θ}_{d} ( t ) - {Θ}_{d ′} ( t ) )} {y}_{{DCS}_{d} , k , ℓ} ( t )\end{matrix} \qquad Equation ( 67 )$$

The expressions e^{jθ}^{_{d′}}^{(t)}y_{∈τ0,k}(t) and e^{j(θ}^{_{d}}^{^{(t)−θ}}^{_{d′}}^{^{(t))}} [symbol] (t) correspond to received OFDM signals y_{∈τ}_{₁}_{,0,k}(t) and [symbol] (t), respectively, whose phase is modified by the complex exponentials e^{jθ}^{_{d}}^{^{′(t)}} and e^{j(θ}^{_{d}}^{^{(t)−θ}}^{_{d′}}^{^{(t))}}, respectively. The effects of phase variations that modify a received OFDM signal have been studied in OFDM literature that analyzes the effects of receiver phase noise. Using known expressions from the fields of OFDM and phase noise, the terms of the summation in Equation (67) can be written in the frequency domain. As mentioned above, in this embodiment, the downlink SISO case of one transmitter antenna at the BS and one receiver antenna at each UE k is considered. The signal e^{-jθ}^{_{d′}}^{^{(t)}}y_{∈τ}_{₁}_{,0,k}(t) can be written in the frequency domain as follows:

$${Y}_{∈ {τ}_{1} , 0 , k , {d}^{′}} = {G}_{{d}^{′}} {H}_{0 , k} {X}_{ℓ} \qquad Equation ( 68 )$$

$$where$$

$${X}_{ℓ} = {[ {X}_{ℓ , 1} , {X}_{ℓ , 2 ,} , … , {X}_{ℓ , ω} , … , {X}_{ℓ , {N}_{c}} ]}^{⊤} \qquad Equation ( 69 )$$

is the vector of information symbols per subcarrier with [symbol] transmitted on subcarrier ω of OFDM symbol [symbol] ,

$${H}_{0 , k} = diag \{ {H}_{0 , k , 1} , {H}_{0 , k , 2} , … , {H}_{0 , k , ω} , … , {H}_{0 , k , {N}_{c}} \} \qquad Equation ( 70 )$$

is a diagonal matrix where H_{0,k,ω} corresponds to the channel frequency response at subcarrier ω for the non-DCS channel between the BS and UE k, and

$${G}_{{d}^{′}} = \qquad Equation ( 71 )$$

$$[ \begin{matrix}{G}_{{d}^{′}} ( 0 ) & {G}_{{d}^{′}} ( 1 ) & {G}_{{d}^{′}} ( 2 ) & … & {G}_{{d}^{′}} ( {N}_{c} - 2 ) & {G}_{{d}^{′}} ( {N}_{c} - 1 ) \\ {G}_{{d}^{′}} ( {N}_{c} - 1 ) & {G}_{{d}^{′}} ( 0 ) & {G}_{{d}^{′}} ( 1 ) & … & {G}_{{d}^{′}} ( {N}_{c} - 3 ) & {G}_{{d}^{′}} ( {N}_{c} - 2 ) \\ {G}_{{d}^{′}} ( {N}_{c} - 2 ) & {G}_{{d}^{′}} ( {N}_{c} - 1 ) & {G}_{{d}^{′}} ( 0 ) & … & {G}_{{d}^{′}} ( {N}_{c} - 4 ) & {G}_{{d}^{′}} ( {N}_{c} - 3 ) \\ ⋮ & ⋮ & ⋮ & ⋱ & ⋮ & ⋮ \\ {G}_{{d}^{′}} ( 1 ) & {G}_{{d}^{′}} ( 2 ) & {G}_{{d}^{′}} ( 3 ) & … & {G}_{{d}^{′}} ( {N}_{c} - 1 ) & {G}_{{d}^{′}} ( 0 )\end{matrix} ]$$

$$where$$

$${G}_{{d}^{′}} ( Ω ) = \frac{1}{{N}_{c}} {\sum }_{u = 0}^{{N}_{c} - 1} {e}^{- j {Θ}_{{d}^{′}} [ u ]} {e}^{j 2 π u Ω / {N}_{c}} \qquad Equation ( 72 )$$

and Θ_{d′} [u] is simply a time sampled version of Θ_{d′} (t) given by

$${Θ}_{{d}^{′}} [ u ] = \{ \begin{matrix}{θ}_{{d}^{′}}^{1} , & 0 \leq u < \frac{{N}_{c}}{T} \\ {θ}_{{d}^{′}}^{2} , & \frac{{N}_{c}}{T} \leq u < \frac{2 {N}_{c}}{T} \\ ⋮ & ⋮ \\ {θ}_{{d}^{′}}^{𝓉} & \frac{𝓉 {N}_{c}}{T} \leq u < \frac{( 𝓉 + 1 ) {N}_{c}}{T} \\ ⋮ & ⋮ \\ {θ}_{{d}^{′}}^{T} & \frac{( T - 1 ) {N}_{c}}{T} \leq u < {N}_{c}\end{matrix} \qquad Equation ( 73 )$$

The signal e^{j(Θ}^{_{d}}^{^{(t)−Θ}}^{_{d′}}^{^{(t))}} [symbol] in Equation (67) can be written in the frequency domain as follows:

$${Y}_{∈ {τ}_{1} , {DCS}_{d} , k , {d}^{′}} = {G}_{{dd}^{′}} {H}_{{DCS}_{d} , k} {X}_{ℓ} \qquad Equation ( 74 )$$

where [symbol] is as defined in Equation (69), and

$${H}_{{DCS}_{d} , k} = diag \{ {H}_{{DCS}_{d} , k , 1} , {H}_{{DCS}_{d} , k , 2} , … , {H}_{{DCS}_{d} , k , ω} , … , {H}_{{DCS}_{d} , k , {N}_{c}} \} \qquad Equation ( 75 )$$

is a diagonal matrix. H_{DCS}_{_{d}}_{,k,1} corresponds to the channel frequency response due to DCS d at subcarrier ω for the non-DCS channel between the BS and UE k, and

$${G}_{d , {d}^{′}} = \qquad Equation ( 76 )$$

$$[ \begin{matrix}{G}_{d , {d}^{′}} ( 0 ) & {G}_{d , {d}^{′}} ( 1 ) & {G}_{d , {d}^{′}} ( 2 ) & … & {G}_{d , {d}^{′}} ( {N}_{c} - 2 ) & {G}_{d , {d}^{′}} ( {N}_{c} - 1 ) \\ {G}_{d , {d}^{′}} ( {N}_{c} - 1 ) & {G}_{d , {d}^{′}} ( 0 ) & {G}_{d , {d}^{′}} ( 1 ) & … & {G}_{d , {d}^{′}} ( {N}_{c} - 3 ) & {G}_{d , {d}^{′}} ( {N}_{c} - 2 ) \\ {G}_{d , {d}^{′}} ( {N}_{c} - 2 ) & {G}_{d , {d}^{′}} ( {N}_{c} - 1 ) & {G}_{d , {d}^{′}} ( 0 ) & … & {G}_{d , {d}^{′}} ( {N}_{c} - 4 ) & {G}_{d , {d}^{′}} ( {N}_{c} - 3 ) \\ ⋮ & ⋮ & ⋮ & ⋱ & ⋮ & ⋮ \\ {G}_{d , {d}^{′}} ( 1 ) & {G}_{d , {d}^{′}} ( 2 ) & {G}_{d , {d}^{′}} ( 3 ) & … & {G}_{d , {d}^{′}} ( {N}_{c} - 1 ) & {G}_{d , {d}^{′}} ( 0 )\end{matrix} ]$$

$$where$$

$${G}_{d , {d}^{′}} ( Ω ) = \frac{1}{{N}_{c}} {\sum }_{u = 0}^{{N}_{c} - 1} {e}^{j ( {Θ}_{d} [ u ] - {Θ}_{{d}^{′}} [ u ] )} {e}^{j 2 π u Ω / {N}_{c}} \qquad Equation ( 77 )$$

and Θ_{d} [u]−Θ_{d′}[u] is a time sampled version of Θ_{d} (t)−Θ_{d′}(t) given by

$${Θ}_{d} [ u ] - {Θ}_{{d}^{′}} [ u ] = \{ \begin{matrix}{θ}_{d}^{1} - {θ}_{{d}^{′}}^{1} , & 0 \leq u < \frac{{N}_{c}}{T} \\ {θ}_{d}^{2} - {θ}_{{d}^{′}}^{2} , & \frac{{N}_{c}}{T} \leq u < \frac{2 {N}_{c}}{T} \\ ⋮ & ⋮ \\ {θ}_{d}^{𝓉} - {θ}_{{d}^{′}}^{𝓉} & \frac{𝓉 {N}_{c}}{T} \leq u < \frac{( 𝓉 + 1 ) {N}_{c}}{T} \\ ⋮ & ⋮ \\ {θ}_{d}^{T} - {θ}_{{d}^{′}}^{T} & \frac{( T - 1 ) {N}_{c}}{T} \leq u < {N}_{c}\end{matrix} \qquad Equation ( 78 )$$

Using Equation (68) and Equation (74), the frequency domain representation of the signal received at user k during coding time interval τ₁ after time multiplication with e^{-jΘ}^{_{d′}}^{^{(t)}} can be written as

$$\begin{matrix}{Y}_{∈ {τ}_{1} , k , {d}^{′}} = {Y}_{∈ {τ}_{1} , k , 0 , {d}^{′}} + {\sum }_{d = 1}^{D} {Y}_{∈ {τ}_{1} , {DCS}_{d} , k , {d}^{′}} \\ = {G}_{{d}^{′}} {H}_{0 , k} {X}_{ℓ} + {\sum }_{d = 1}^{D} {G}_{d , {d}^{′}} {H}_{{DCS}_{d} , k} {X}_{ℓ} \\ = [ {G}_{{d}^{′}} , {G}_{1 , {d}^{′}} , … , {G}_{D , {d}^{′}} ] [ \begin{matrix}{H}_{0 , k} \\ {H}_{{DCS}_{1} , k} \\ ⋮ \\ {H}_{{DCS}_{D} , k}\end{matrix} ] {X}_{ℓ}\end{matrix} \qquad Equation ( 79 )$$

where in the last step the matrix form notation has been used.

From the derivations above, it is can be seen that without multiplication by e^{-jΘ}^{_{d′}}^{^{(t)}} (simply setting the term e^{-jΘ}^{_{d′}}^{^{(t)}}=1 in above expressions) the received signal in frequency domain is given by

$$\begin{matrix}{Y}_{∈ {τ}_{1} , k} = {Y}_{∈ {τ}_{1} , k , 0} + {\sum }_{d = 1}^{D} {Y}_{∈ {τ}_{1} , {DCS}_{d} , k} \\ = {H}_{0 , k} {X}_{ℓ} + {\sum }_{d = 1}^{D} {G}_{d} {H}_{{DCS}_{d} , k} {X}_{ℓ} \\ = [ {I}_{{N}_{c}} , {G}_{1} , … , {G}_{D} ] [ \begin{matrix}{H}_{0 , k} \\ {H}_{{DCS}_{1} , k} \\ ⋮ \\ {H}_{{DCS}_{D} , k}\end{matrix} ] {X}_{ℓ}\end{matrix} \qquad Equation ( 80 )$$

where G_{d} can be computed as in Equation (71) and I_{N}_{_{c}} is the identity matrix of size N_{c}. Equation (80) can also be interpreted as multiplying the received signal with the codeword for the non-DCS channel, which, as mentioned above, is implicitly assigned as the codeword with all entries equal to one.

By computing Y_{∈τ}_{₁}_{,k,d′} in Equation (79) for d′=1,2, . . . , D and stacking them up with Y_{∈τ}_{₁}_{,k} in Equation (80), one obtains

$$\begin{matrix}{Y}_{∈ {τ}_{1} , k}^{′} = [ \begin{matrix}{Y}_{∈ {τ}_{1} , k} \\ {Y}_{∈ {τ}_{1} , k , 1} \\ ⋮ \\ {Y}_{∈ {τ}_{1} , k , D}\end{matrix} ] = [ \begin{matrix}{I}_{{N}_{c}} & {G}_{1} & … & {G}_{D} \\ {G}_{1} & {G}_{1 , 1} & … & {G}_{D , 1} \\ {G}_{2} & {G}_{1 , 2} & … & {G}_{D , 2} \\ ⋮ & ⋮ & ⋱ & ⋮ \\ {G}_{D} & {G}_{1 , D} & … & {G}_{D , D}\end{matrix} ] [ \begin{matrix}{H}_{0 , k} \\ {H}_{{DCS}_{1} , k} \\ ⋮ \\ {H}_{{DCS}_{D} , k}\end{matrix} ] {X}_{ℓ} \\ = 𝒢 [ \begin{matrix}{H}_{0 , k} \\ {H}_{{DCS}_{1} , k} \\ ⋮ \\ {H}_{{DCS}_{D} , k}\end{matrix} ] {X}_{ℓ}\end{matrix} \qquad Equation ( 81 )$$

$$with$$

$$𝒢 = [ \begin{matrix}{I}_{{N}_{c}} & {G}_{1} & … & {G}_{D} \\ {G}_{1} & {G}_{1 , 1} & … & {G}_{D , 1} \\ {G}_{2} & {G}_{1 , 2} & … & {G}_{D , 2} \\ ⋮ & ⋮ & ⋱ & ⋮ \\ {G}_{D} & {G}_{1 , D} & … & {G}_{D , D}\end{matrix} ] \qquad Equation ( 82 )$$

The matrix [symbol] is known since it only depends on the coding used at the DCSs. Therefore, the matrix [symbol] can be computed and a multiplication of its inverse, given by [symbol] with Y′_{∈τ}_{₁}_{,k} in Equation (81) can be performed in order to obtain H_{0,k}, [symbol] , H_{DCS}_{₁}_{,k}, [symbol] , . . . , H_{DCS}_{_{D}}_{,k} [symbol] as follows:

$${𝒢}^{- 1} {Y}_{∈ {τ}_{1} , k}^{′} = {𝒢}^{- 1} 𝒢 [ \begin{matrix}{H}_{0 , k} \\ {H}_{{DCS}_{1} , k} \\ ⋮ \\ {H}_{{DCS}_{D} , k}\end{matrix} ] {X}_{ℓ} = [ \begin{matrix}{H}_{0 , k} \\ {H}_{{DCS}_{1} , k} \\ ⋮ \\ {H}_{{DCS}_{D} , k}\end{matrix} ] {X}_{ℓ} \qquad Equation ( 83 )$$

The multiplication with the inverse [symbol] of the matrix [symbol] is a linear transformation. As detailed above, the matrix [symbol] and, accordingly, also its inverse, is based on a model of phase variations induced by the application of the sequence of additional phase shifts during the transmission of a single OFDM symbol. By applying this linear transformation, the signal components received via the individual DCSs are obtained.

The invertibility of [symbol] is facilitated by the codeword construction which induces a strong diagonal component of matrix [symbol] and weak off-diagonal components of matrix [symbol] . The diagonal of matrix [symbol] is composed of all ones since

$$diagonal ( 𝒢 ) = [ diagonal ( {I}_{{N}_{c}} ) , diagonal ( {G}_{1 , 1} ) , … , diagonal ( {G}_{D , D} ) ] = [ 1 ⋯ 1 {G}_{1 , 1} ( 0 ) ⋯ {G}_{1 , 1} ( 0 ) {G}_{2 , 2} ( 0 ) ⋯ {G}_{2 , 2} ( 0 ) ⋯ {G}_{d , d} ( 0 ) ⋯ {G}_{D , D} ( 0 \qquad Equation ( 84 )$$

and, from Equation (77),

$${G}_{1 , 1} ( 0 ) = {G}_{2 , 2} ( 0 ) = ⋯ = {G}_{D , D} ( 0 ) = \frac{1}{{N}_{c}} {\sum }_{u = 0}^{{N}_{c} - 1} {e}^{j ( {Θ}_{d} [ u ] - {Θ}_{d} [ u ] )} {e}^{\frac{j 2 π u ( 0 )}{{N}_{c}}} = \frac{1}{{N}_{c}} {\sum }_{u = 0}^{{N}_{c} - 1} 1 = 1 \qquad Equation ( 85 )$$

Furthermore, the matrices that are in the diagonal of matrix [symbol] , namely I_{N}_{_{c}}, G_{1,1}, . . . , G_{D,D} have off-diagonal elements equal to zero since this is the case for I_{N}_{_{c}} and from Equation (77) one can easily verify that

$${G}_{d , d} ( Ω \neq 0 ) = \frac{1}{{N}_{c}} {\sum }_{u = 0}^{{N}_{c} - 1} {e}^{j ( {Θ}_{d} [ u ] - {Θ}_{d} [ u ] )} {e}^{j 2 π u Ω / {N}_{c}} = \frac{1}{{N}_{c}} {\sum }_{u = 0}^{{N}_{c} - 1} {e}^{j 2 π u Ω / {N}_{c}} \approx 0. \qquad Equation ( 86 )$$

Also, the off diagonal matrices in Equation (82), namely G₁, . . . , G_{D} and G_{d,d′} for d≠d′ have a main diagonal equal to zero since, from Equation (72),

$${G}_{d} ( Ω = 0 ) = \frac{1}{{N}_{c}} {\sum }_{u = 0}^{{N}_{c} - 1} {e}^{- j {Θ}_{{d}^{′}} [ u ]} {e}^{j 2 π u ( 0 ) / {N}_{c}} = \frac{1}{{N}_{c}} {\sum }_{u = 0}^{{N}_{c} - 1} {e}^{- j {Θ}_{{d}^{′}} [ u ]} \approx 0 \qquad Equation ( 87 )$$

where the last equality applies to Hadamard or DFT based codes (or codes with codeword average or zero) and

$$\begin{matrix}{G}_{d , {d}^{′} \neq d} ( Ω = 0 ) & = \frac{1}{{N}_{c}} {\sum }_{u = 0}^{{N}_{c} - 1} {e}^{j ( {Θ}_{d} [ u ] - {Θ}_{{d}^{′}} [ u ] )} {e}^{j 2 π u ( 0 ) / {N}_{c}} \\ & = \frac{1}{{N}_{c}} {\sum }_{u = 0}^{{N}_{c} - 1} {e}^{j ( {Θ}_{d} [ u ] - {Θ}_{{d}^{′}} [ u ] )} \approx 0\end{matrix} . \qquad Equation ( 88 )$$

where the last equality follows from codeword orthogonality. Finally, the terms G_{d}(Ω≠0) and G_{d,d′≠d}(Ω≠0) that compose the other off diagonal entries of matrix [symbol] are expected to be weaker than the elements on the main diagonal of [symbol] since the terms G_{d}(Ω≠0) and G_{d,d′≠d}(Ω≠0) are weighted summations that would give zero with unit weights but may deviate from zero for non-unit weights.

As mentioned above, the signal components H_{0,k} [symbol] , H_{DCS}_{₁}_{,k} [symbol] , . . . H_{DCS}_{_{D}}_{,k} [symbol] received via the non-DCS channel and the DCS channel are calculated in accordance with Equation (83). By adding all these terms, one obtains

$$( {H}_{0 , k} + {\sum }_{d = 1}^{D} {H}_{{DCS}_{d} , k} ) {X}_{ℓ} \qquad Equation ( 89 )$$

The channel matrix (H_{0,k}+Σ_{d=1}^{D}H_{Dcs}_{_{d}}_{,k}) is the channel for OFDM symbols arriving before the coding time interval τ₁. This channel can be determined by means of known techniques, and it can be used for decoding previous symbols. With the knowledge of (H_{0,k}+Σ_{d=1}^{D}H_{Dcs}_{_{d}}_{,k}), Equation (89) can be solved for [symbol] and, with the knowledge of [symbol] , Equation (83) can be solved for H_{0,k}, H_{DCS}_{₁}_{,k}, . . . , H_{DCS}_{_{D}}_{,k}. Thus, the non-DCS channel H_{0,k} and the DCS channels H_{DCS}_{₁}_{,k}, . . . , H_{DCS}_{_{D}}_{,k} can be estimated.

By comparing FIG. 6 and FIG. 12, it can be seen that the advantage of coding over one OFDM symbol is that less time is spent in the coding time interval τ₁, or, in other words, the coding time interval τ₁ is shorter.

### Embodiments for the Coding Time Interval Assignment Step, the Transmission Signal Assignment Step and the Signal Component Separation and Channel Estimation Step for the Case of DCS Coding Over a Single OFDM Symbol and a Downlink MIMO Scenario

As discussed in the previous SISO embodiment, an advantage of implementing DCS coding over a single OFDM symbol is that the duration of the coding time interval is shorter than when coding over multiple OFDM symbols. The previous embodiment of coding over a single OFDM symbol can be extended to the downlink MIMO case by, for example applying the coding over one OFDM symbol per transmitter antenna, as discussed in the following.

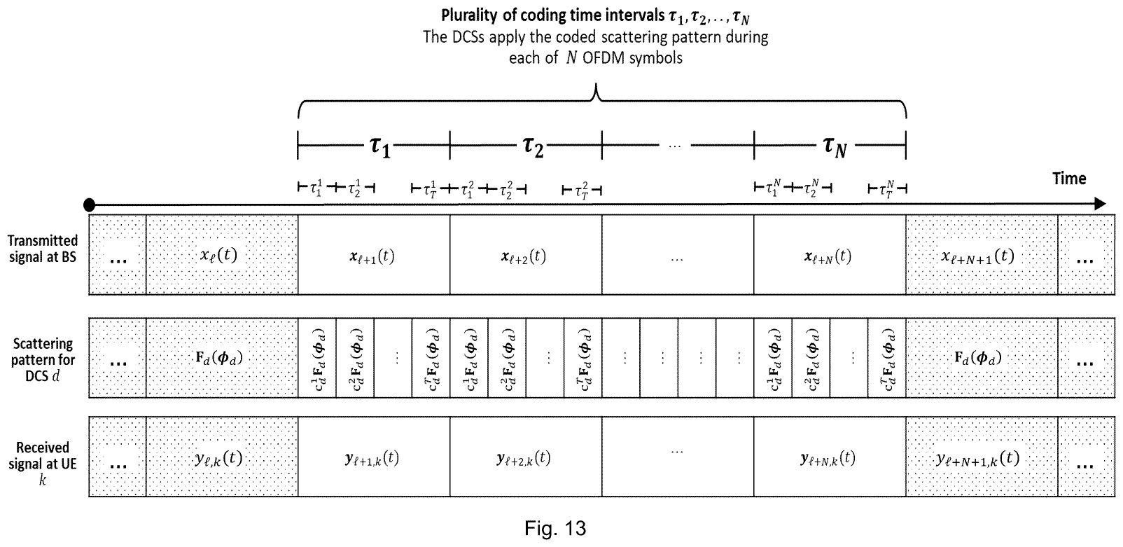

As in the previous embodiments, N is the number of transmitter antennas of the BS. The UEs have multiple receiver antennas, where Mₖ denotes the number of receiver antennas at each UE k. As part of the coding time interval assignment step, a plurality of coding time intervals τ₁, τ₂, τ₃, . . . τ_{N} are defined. During each of the plurality of coding time intervals, each of the DCSs will apply the defined coded scattering pattern sequence. Given N transmitter antennas, in this embodiment, a sequence of N coding time intervals that starts at OFDM symbol [symbol] +1 and has a duration equal to the duration of N OFDM symbols is defined. For each of these N coding time intervals, each of which corresponds to a respective OFDM symbol, T subintervals labeled as τ₁ⁿ, τ₂ⁿ, . . . , τ_{T}ⁿ are defined, where [symbol] is used to label the [symbol] -th subinterval during OFDM symbol [symbol] +n. Given the codewords c₁, c₂, . . . , c_{D} defined in the codeword assignment step where, as mentioned above, each codeword is of size T, it is defined in this embodiment that during each of the N OFDM symbols the DCSs will apply the DCS coding. This is shown in FIG. 13 which shows a timing diagram illustrating an example where DCS d applies the coded scattering pattern sequence [c_{d}¹F_{d}(ϕd), c_{d}²F_{d}(ϕ_{d}), . . . , [symbol] F_{d}(ϕ_{d}), . . . , c_{d}^{T}F_{d} (ϕ_{d})] at each of the N OFDM symbols which correspond to one of the coding time intervals of the plurality of coding time intervals τ₁, τ₂, τ₃, . . . τ_{N}.

In the transmission signal assignment step, the signals transmitted from the BS antennas during the N OFDM symbols, each of which correspond to one coding time interval of the plurality of coding time intervals, are defined. These signals are labeled as [symbol] (t), [symbol] (t), . . . , [symbol] (t) which are vectors of size N. In this embodiment, during OFDM symbol [symbol] +n, only the n-th transmitter antenna is active. Hence, during subintervals τ₁, τ2, . . . , τ_{T} only transmitter antenna n is transmitting and all others are silent. Thus, the SISO processing explained in the previous section can be applied in order to estimate the channel from the active antenna to each of the receiver antennas at each user. Specifically, the signals received during the plurality of coding time intervals and before can be used by applying the processing explained in the previous embodiment per transmitter-receiver antenna pair. Hence SISO processing as in the previous embodiment is performed, but applied per transmitter-receiver antenna pair.

By comparing FIG. 8 and FIG. 13, it can be seen that when the DCS codeword is applied within an OFDM symbol as in FIG. 13, the duration of the coding interval is less than when a codeword spans multiple OFDM symbols.

In this embodiment, a repetition of the coded scattering pattern sequence [c_{d}¹F_{d}(ϕ_{d}), c_{d}²F_{d}(ϕ_{d}), . . . , [symbol] F_{d}(ϕ_{d}), . . . , c_{d}^{T}F_{d}(ϕ_{d})] over N OFDM symbols is performed. The DCSs are informed of this repetition structure so that they apply the coded pattern as required for this embodiment.

### Embodiments for the Coding Time Interval Assignment Step, the Transmission Signal Assignment Step and the Signal Component Separation and Channel Estimation Step for the Case of DCS Coding Over a Single OFDM Symbol and a Uplink MIMO Scenario

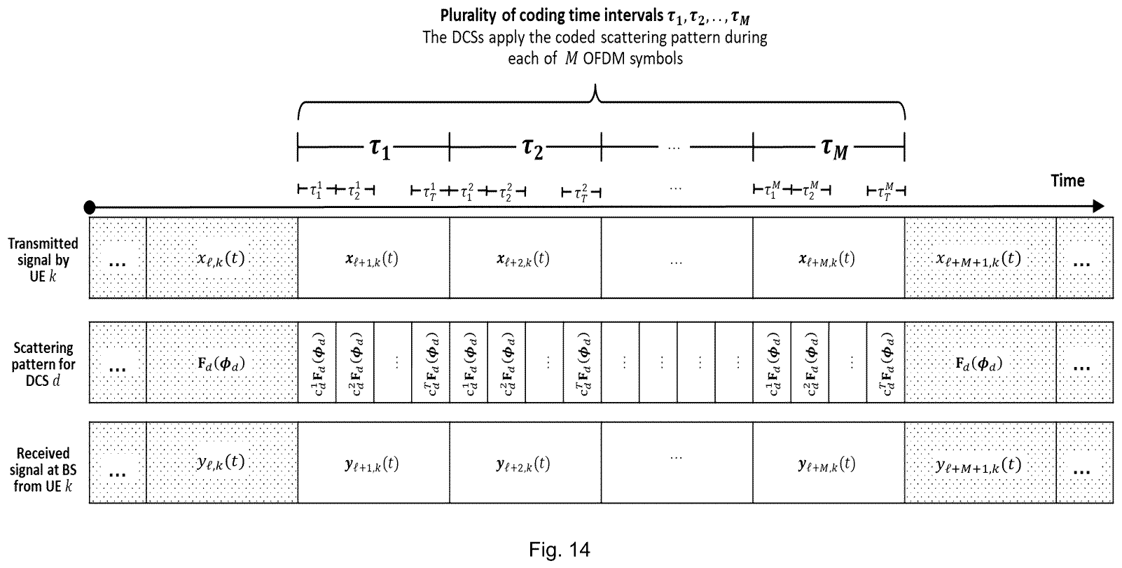

N denotes the number or receive antennas of the BS. The UEs have multiple transmit antennas, wherein Mₖ denotes the number of transmit antennas at UE k. Thus, the total number of transmitters for the uplink is M=Σₖ₌₁^{K}Mₖ. As part of the coding time interval assignment step, a plurality of M coding time interval is defined, denoted as τ₁, τ₂, τ₃, . . . τ_{M}. During each of the coding time intervals, the DCSs will apply the coded scattering pattern sequence. Given M transmitter antennas, in this embodiment a sequence of M coding time intervals is defined which starts at OFDM symbol [symbol] +1 and has a duration equal to the duration of M OFDM symbols. Thus, each of the coding time intervals has a duration of one OFDM symbol. For each of the M OFDM symbols, T subintervals labeled as τ₁^{m}, τ₂^{m}, . . . , τ_{T}^{m} are defined, where [symbol] is used to label the [symbol] -th subinterval during OFDM symbol [symbol] +m. Given the codewords c₁, c₂, . . . , c_{D} defined in the codeword assignment step where, as mentioned above, each codeword is of size T, during each of the M OFDM symbols of the M coding time intervals, the DCSs apply the DCS coding. This is shown in FIG. 14 which shows a timing diagram illustrating an example where DCS d applies the coded scattering pattern sequence [c_{d}¹F_{d}(ϕ_{d}), c_{d}²F_{d}(ϕ_{d}), . . . , [symbol] F_{d}(ϕ_{d}), . . . , c_{d}^{T}F_{d}(ϕ_{d})] at each of the M OFDM symbols of coding time intervals τ₁, τ₂, τ₃, . . . τ_{M}.

In the transmission signal assignment step, the signal that is transmitted during each of the plurality of coding time intervals T₁, τ₂, τ₃, . . . τ_{M} is defined. A vector [symbol] of length Mₖ is used to denote the signal transmitted during the [symbol] +m-th OFDM symbol by UE k. In this embodiment, during OFDM symbol [symbol] +m, only one antenna is transmitting and all other antennas are silent. Furthermore, each antenna is only active during a single OFDM symbol during the plurality of coding time intervals so the total M OFDM symbols are enough to allow each of the total of M transmitter antennas to be active at least once during the plurality of coding time intervals. Since only one transmitter antenna is active at a given time, this allows to apply the processing explained in the SISO embodiment in order to estimate the channel from the active antenna to each of the receiver antennas at the BS. Specifically, the signals received at the BS during the coding time intervals and before are used to obtain the desired channel estimates by applying the SISO processing explained in the two preceding embodiments earlier per transmitter-receiver antenna pair.

In this embodiment, a repetition of the coded scattering pattern sequence [c_{d}¹F_{d}(ϕ_{d}), c_{d}²F_{d}(ϕ_{d}), . . . , [symbol] F_{d}(ϕ_{d}), . . . , c_{d}^{T}F_{d}(ϕ_{d})] over M OFDM symbols is performed. The DCSs are informed of this repetition structure so that they apply the coded pattern as required for this embodiment.

### Embodiments for the Coding Time Interval Assignment Step, the Transmission Signal Assignment Step and the Signal Component Separation and Channel Estimation Step for the Case of DCS Coding within Waveform Samples in SISO

In the above-described uplink and downlink embodiments, OFDM waveforms which are the most commonly used waveforms in current cellular and Wi-Fi systems have been described. However, the present disclosure is not limited to OFDM waveforms and other waveforms can also be used. In this embodiment, a generic implementation that can be applied to any waveform by applying the DCS coding within consecutive waveform samples is described for the SISO case.

In the coding time interval assignment step, a coding time interval τ₁ during which the DCSs will apply the coded scattering pattern sequence is defined. In this embodiment, there is one coding time interval τ₁, the duration of which is equal to the duration of one time sample. Furthermore, in this embodiment, as part of the coding time interval assignment step, the coding time interval τ₁ is defined to correspond to the u-th time sample. The time sampled transmitted signal for the u-th time sample is defined as follows

$$x [ u ] = x ( {uT}_{sam} ) \qquad Equation ( 90 )$$

where Tₛₐₘ is the duration of one time sample (the sampling time). Since the coding time interval τ spans only one time sample, the duration of τ₁ is thus equal to Tₛₐₘ seconds.

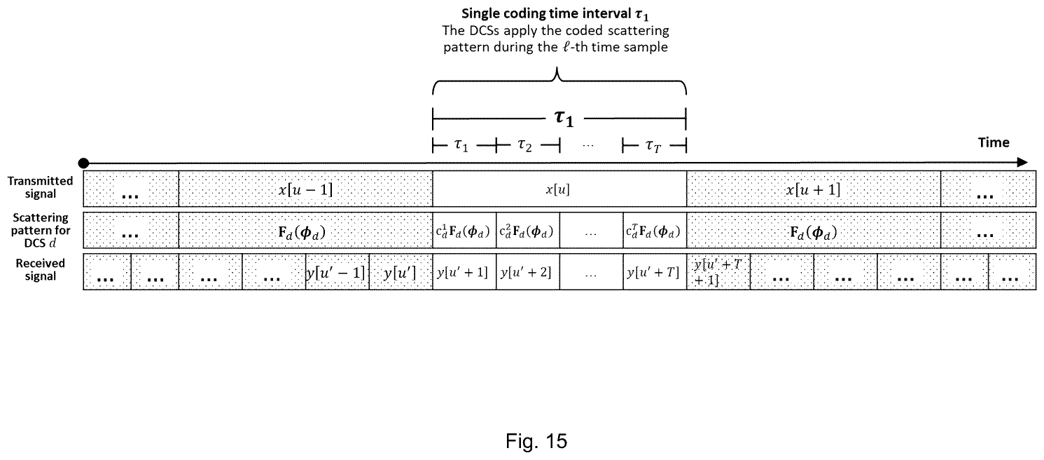

In the transmission signal assignment step, the signal that is transmitted during interval τ₁ is defined. In this embodiment, there is no constraint on the signal transmitted in this interval. Hence, any x[u] can be transmitted. Since the given codewords c₁, c₂, . . . , c_{D}defined in the codeword assignment step are of size T, each DCS applies a codeword component τ during a time duration that is equal to Tₛₐₘ/T seconds. Thus, the coding time interval τ is divided into T subintervals τ₁, τ₂, . . . τₜ, . . . , τ_{T}, each having a duration of Tₛₐₘ/T seconds. In this way, the DCSs are able to apply the coded scattering pattern within the duration of one (the u-th) time sample. A time diagram showing the assignments for transmission, DCS coded scattering patterns and signal reception is shown in FIG. 15 which shows a timing diagram illustrating an example where DCS d applies the coded scattering pattern sequence [c_{d}¹F_{d}(ϕ_{d}), c_{d}²F_{d}(ϕ_{d}), . . . , [symbol] F_{d}(ϕ_{d}), . . . , c_{d}^{T}F_{d}(ϕ_{d})] during the u-th time sample which corresponds to the coding time interval τ₁.

Since the receiver samples at a reduced sample time equal to Tₛₐₘ/T, during the coding time interval τ the receiver observes T time samples which are labeled as y[u′+1], y[u′+2], . . . , y[u′+T] as shown in FIG. 15. In a downlink scenario, signals x and y represented the signal transmitted from a BS and the signal received at a UE, respectively. In the uplink scenario signals, x and y represent the singal sent by a UE and the signal received by a BS, respectively.

Due to the assignments in the coding time interval assignment step and the transmission signal assignment step, the signal received during time subinterval [symbol] from DCS d can be written as

$${y}_{d} [ {u}^{′} + ] = x [ u ] \qquad Equation ( 91 )$$

where h_{DCS}_{_{d}} is the channel from DCS d without coding (i.e. using F_{d}(ϕ_{d})) and [symbol] h_{DCS}_{_{d}} is the channel from DCS d with coding (i.e. using [symbol] F_{d} (ϕ_{d})). Using h₀ to denote the non-DCS channel, the received signal including all non-DCS and DCS paths during time subinterval [symbol] is obtained as follows

$$\begin{matrix}{y}_{d} [ {u}^{′} + ] & = {h}_{0} x [ u ] + {\sum }_{d = 1}^{D} x [ u ] = ( {h}_{0} + {\sum }_{d = 1}^{D} ) x [ u ] \\ & = [ 1 , , … , ] [ \begin{matrix}{h}_{0} \\ {h}_{{DCS}_{1}} \\ ⋮ \\ {h}_{{DCS}_{D}}\end{matrix} ] x [ u ]\end{matrix} \qquad Equation ( 92 )$$

In the above equation, all the non-DCS and DCS signals are assumed to arrive at the same time. If this is not the case, then, for example, a Rake receiver structure can be used.

In order to obtain h_{DCS}_{_{d}} for all D DCSs, the signal component separation and channel estimation step is performed. Stacking the T observations y_{d}[u′+1],y_{d}[u′+2], . . . , y_{d}[u′+T], one obtains

$${y}_{∈ {τ}_{1}} = [ \begin{matrix}y [ {u}^{′} + 1 ] \\ y [ {u}^{′} + 2 ] \\ ⋮ \\ y [ {u}^{′} + T ]\end{matrix} ] = [ \begin{matrix}1 , {c}_{1}^{1} , … , {c}_{D}^{1} \\ 1 , {c}_{1}^{2} , … , {c}_{D}^{2} \\ ⋮ \\ 1 , {c}_{1}^{T} , … , {c}_{D}^{T}\end{matrix} ] [ \begin{matrix}{h}_{0} \\ {h}_{{DCS}_{1}} \\ ⋮ \\ {h}_{{DCS}_{D}}\end{matrix} ] x [ u ] \qquad Equation ( 93 )$$

The signal component received via DCS d can be obtained by applying a linear transformation to the stacked received signals y_{∈τ}_{₁}. The linear transformation is based on the known codeword c_{d}=[c_{d}¹, . . . , c_{d}^{T}] of DCS d and is applied by multiplying the conjugate thereof with the signal y_{∈τ}_{₁}

$$\begin{matrix}[ {c}_{d}^{1} , … , {c}_{d}^{T} ] * {y}_{∈ {τ}_{1}} & = [ {c}_{d}^{1} , … , {c}_{d}^{T} ] * [ \begin{matrix}1 , {c}_{1}^{1} , … , {c}_{D}^{1} \\ 1 , {c}_{1}^{2} , … , {c}_{D}^{2} \\ ⋮ \\ 1 , {c}_{1}^{T} , … , {c}_{D}^{T}\end{matrix} ] [ \begin{matrix}{h}_{0} \\ {h}_{{DCS}_{1}} \\ ⋮ \\ {h}_{{DCS}_{D}}\end{matrix} ] x [ u ] \\ & = {1}_{d + 1 , T} [ \begin{matrix}{h}_{0} \\ {h}_{{DCS}_{1}} \\ ⋮ \\ {h}_{{DCS}_{D}}\end{matrix} ] x [ u ] = {h}_{{DCS}_{d}} x [ u ]\end{matrix} \qquad Equation ( 94 )$$

where Equation (23) and Equation (24) have been used, [ ]* is used to denote the conjugate of [ ] and 1_{d+1,T} is a row vector of size T with entry d+1 equal to one and all other entries equal to zero. From Equation (94), it can be seen that by computing c*_{d}y_{∈τ}_{₁} one obtains

$${h}_{{DCS}_{d}} x [ u ] \qquad Equation ( 95 )$$

and by computing [1,1, . . . 1]y_{∈τ}_{₁} one obtains obtain (due to codeword orthogonality)

$${h}_{0} x [ u ] . \qquad Equation ( 96 )$$

Thus, the signal components received via the non-DCS channel and via the individual DCS channels can be separated. By adding Equation (96) and Equation (95) computed for all D DCSs, one obtains

$$( {h}_{0} + {\sum }_{d = 1}^{D} {h}_{{DCS}_{d}} ) x [ u ] \qquad Equation ( 97 )$$

In the equation above, (h₀+Σ_{d=1}^{D}h_{DCS}_{_{d}}) is the aggregate channel observed before time interval τ₁. This channel can be determined via conventional training that can be performed at an earlier point in time since it may be needed to decode earlier symbols. Alternatively, it can be computed from previously received information (e.g. via joint data and channel estimation for OFDM symbols before the coding time interval τ₁ starts). Using the knowledge of this aggregate channel (h₀+Σ_{d=1}^{D}h_{DCS}_{_{d}}), Equation (97) can be solved for x[u]. Using the computed x[u], Equation (96) can be solved for h₀ and for h_{DCS}_{_{d}} for all D DCS using Equation (95). Thus, an estimate of the non-DCS and DCS channels is obtained. The estimates can later be used for further post processing to enhance the decoding of x[u].

In this embodiment, the duration of the time interval τ₁ is only one sample which is much shorter than in previous embodiments. Furthermore, the DCS coding is applied during a time sample. Hence, the coding as described in this embodiment can be used with any waveform.

### Embodiments for the Coding Time Interval Assignment Step, the Transmission Signal Assignment Step and the Signal Component Separation and Channel Estimation Step for the Case of DCS Coding within Waveform Samples in MIMO

The previous embodiment can be extended to any MIMO system with N transmitter and M receiver antennas by making the time interval τ₁ span the duration of N samples and having only one antenna active at a given time sample. This way the SISO processing described in the previous embodiment can be applied per transmitter-receiver (TX-RX) antenna pair.

### Embodiment for One DCS Subdivided into Multiple DCS

The previous embodiments can also be applied to a single DCS composed of S scattering elements by creating D disjoint groups (not necessarily contigus) of scattering elements for providing virtual DCSs. For example, S_{d}/D scattering elements can be assigned to each group. The above-described embodiments can be applied by treating the D disjoint groups as different DCSs. For example, a first group of scattering elements of a DCS can be treated as scattering elements of one DCS, and one or more second groups of scattering elements can be treated as virtual DCSs. For this purpose, the assignment circuitry can be configured to assign, to each group of scattering elements providing a virtual DCS, a respective base phase shift pattern of a virtual DCS. The base phase shift pattern of the virtual DCS defines a respective phase shift value for each scattering element of the respective group of scattering elements. The DCS control circuitry is configured to add, during each time interval of the sequence of time intervals, a respective additional phase shift value from a sequence of additional phase shifts for the virtual DCS to the phase shift values for the scattering elements of the respective group of scattering elements that are defined by the base phase shift pattern of the virtual DCS assigned to the respective group. The sequences of additional phase shifts of the individual groups can be different, so that, for each virtual DCS, a signal component received via the virtual DCS can be separated DCS and a channel estimate can be computed for each virtual DCS.

### Embodiments for Signaling

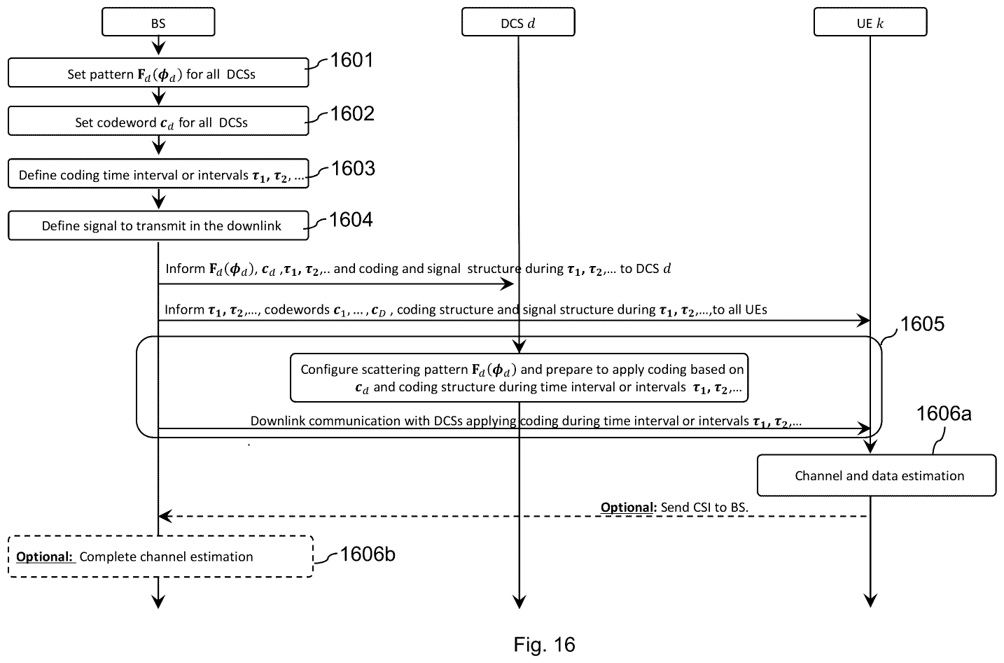

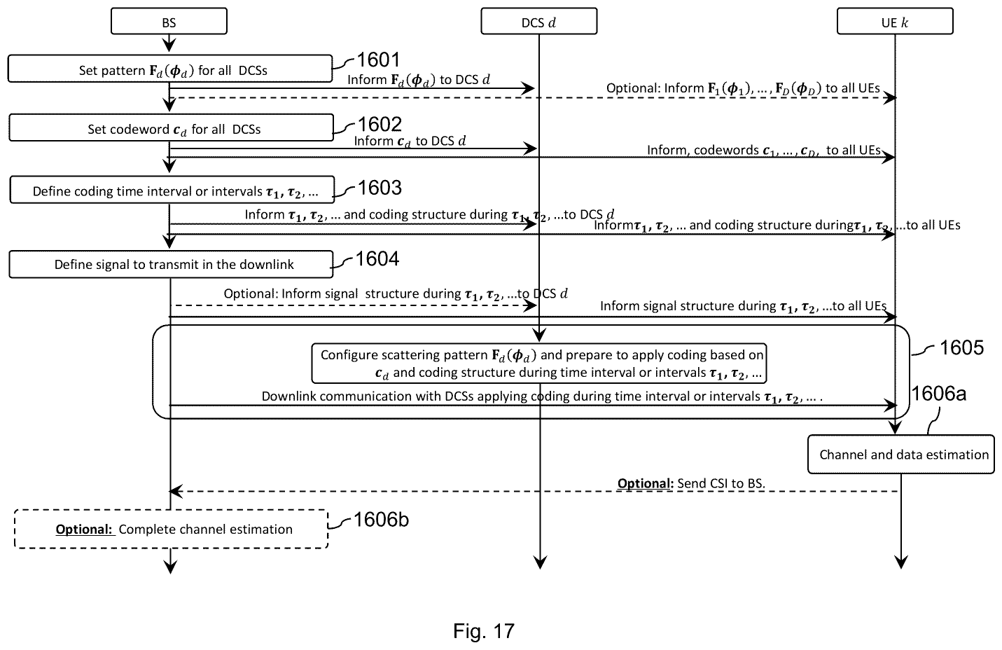

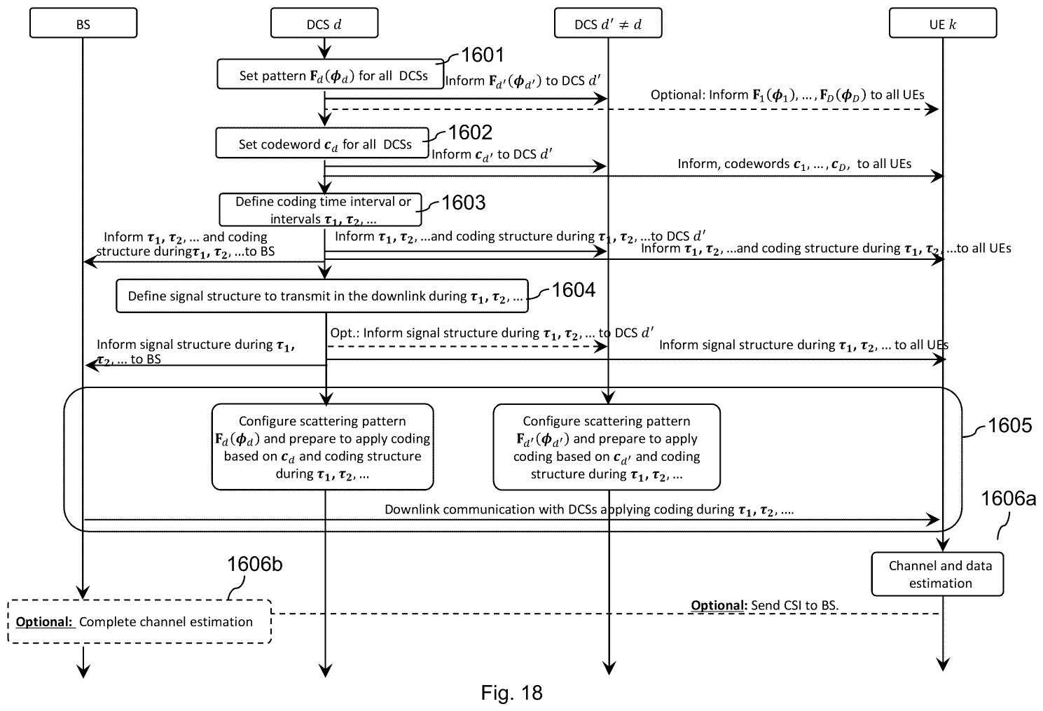

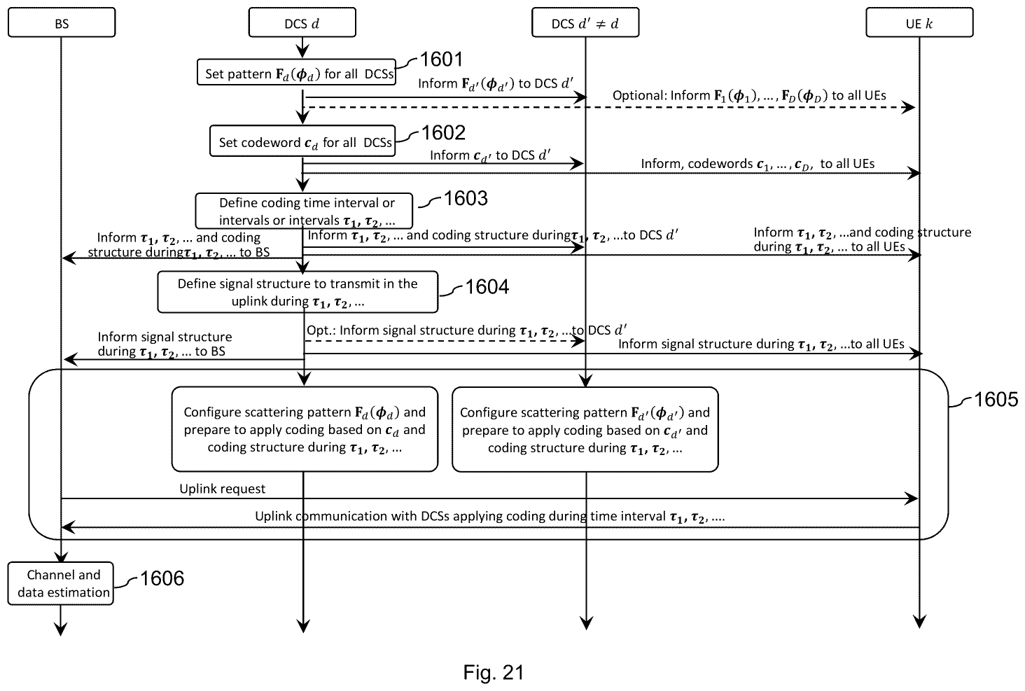

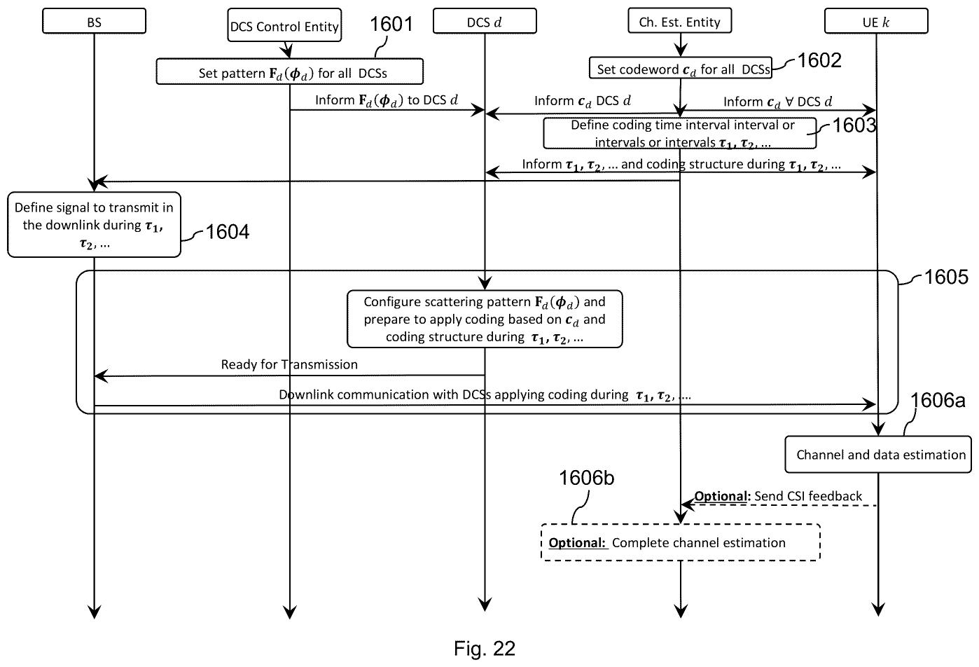

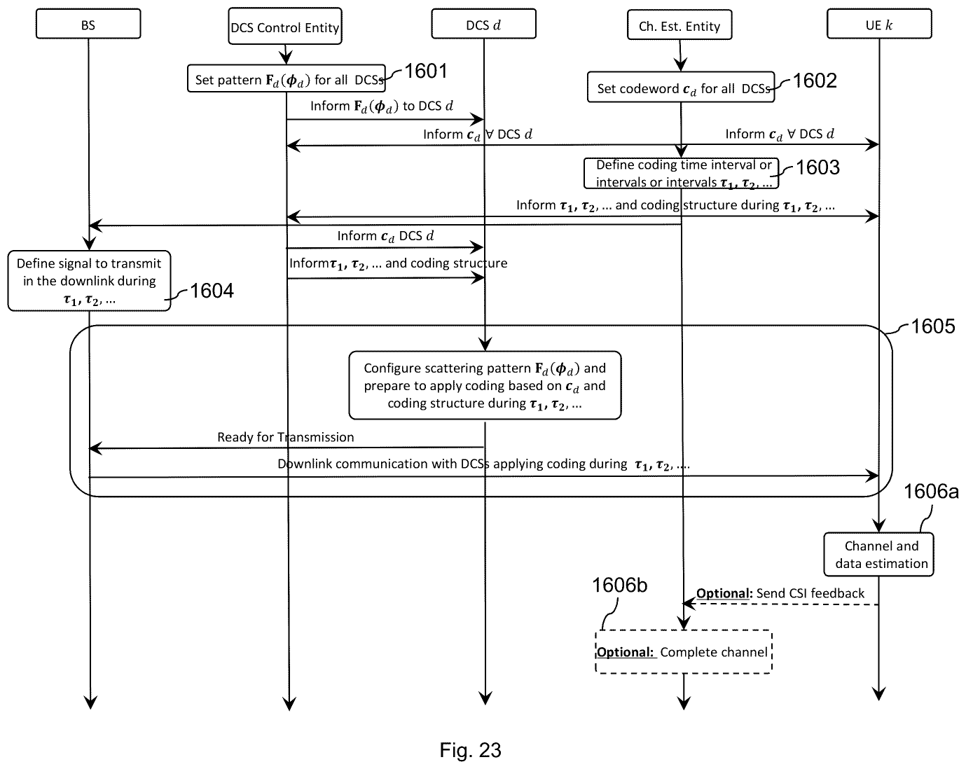

In the following, the signaling that can be performed in embodiments will be described with reference to FIGS. 16 to 23. For convenience, in FIGS. 16 to 23, like reference numerals have been used to denote corresponding steps. In particular, the base shift pattern assignment step is generally denoted by reference numeral 1601, the codeword assignment step is generally denoted by reference numeral 1602, the coding time interval assignment step is generally denoted by reference numeral 1603, the transmission signal assignment step is generally denoted by reference numeral 1604, the DCS operation step is generally denoted by reference numeral 1605 and the signal component separation and channel estimation step is generally denoted by reference numeral 1606. If parts of steps are performed by different entities, reference numerals with appended letters a and b will be used. For example, as shown in FIGS. 16, 17, 18, 22 and 23 parts of the signal component and channel estimation step can be performed by different entities such as a UE and a BS, as in FIGS. 16, 17 andl8, or by a UE and a channel estimation entity, as in FIGS. 22 and 23. Furthermore, parts of the DCS operations step 1605 can performed by the individual DCSs, as schematically shown in FIGS. 18 and 21.

### Embodiments for Signaling in a Downlink Scenario

FIG. 16 shows an example of a scenario for downlink where the BS performs the base phase shift pattern assignment step 1601, the codeword assignment step 1602, the coding time interval assignment step 1603, and the transmission signal assignment step 1604. The BS informs each DCS d=1, . . . , D of its assigned codeword c_{d} and the underlying scattering pattern F_{d} (ϕ_{d}) and informs each UE k=1, . . . , K of the codewords c₁, . . . , c_{D} that are used by the DCSs. The BS also informs each DCS d and UE k of the one τ₁ or more coding time intervals τ₁, τ₂, . . . in particular of the starting time and duration thereof, and of the coding structure during the coding time intervals. For example, in the embodiment described above with reference to FIG. 13, the coded scattering pattern sequence is repeated over multiple OFDM symbols. Hence, the DCSs and the UEs are informed accordingly. The BS also informs the UEs of the signal structure during the one or more coding time intervals. For example, in the embodiment described above with reference to FIG. 6, the same signal is repeated during the T OFDM symbols of the single coding time interval τ₁. Hence, the users are informed about this repetitive structure, but the exact data to be transmitted does not need to be prescribed.

In the DCS operation step 1605, downlink communication is performed, wherein each DCS d applies the scattering pattern F_{d}(ϕ_{d}) outside the one or more coding time intervals and applies coding based on the coded scattering patterns [c_{d}¹F_{d}(ϕ_{d}), c_{d}²F_{d}(ϕ_{d}), . . . , [symbol] F_{d}(ϕ_{d}), . . . , c_{d}^{T}F_{d}(ϕ_{d})] during the one or more coding time intervals. In implementations, GPS signals can be used in order to synchronize the DCSs. Such a GPS based synchronization is used, for example, in 5G to in order to synchronize eNBs, and corresponding techniques can be used for the synchronization of the DCSs in embodiments. In the signal component separation and channel estimation step, the signal received and the knowledge of c₁, . . . , c_{D} and τ₁, τ₂, . . . is used for separating signal components received via the individual DCSs and for channel estimation.

Another embodiment for signaling in the downlink is shown in FIG. 17 where the information about F_{d} (ϕ_{d}), c₁, . . . , c_{D}, τ₁, τ₂, . . . , and coding during τ₁, τ₂, . . . is communicated in different signaling exchanges that are performed after the completion of each of the base phase shift pattern assignment step 1601, the codeword assignment step 1602, the coding time interval assignment step 1603, and the transmission signal assignment step 1604.

As a further downlink signaling embodiment, FIG. 18 shows an embodiment wherein DCS d performs the base phase shift pattern assignment step 1601, the codeword assignment step 1602, the coding time interval assignment step 1603, and the transmission signal assignment step 1604.

### Embodiment for Signaling in an Uplink Scenario

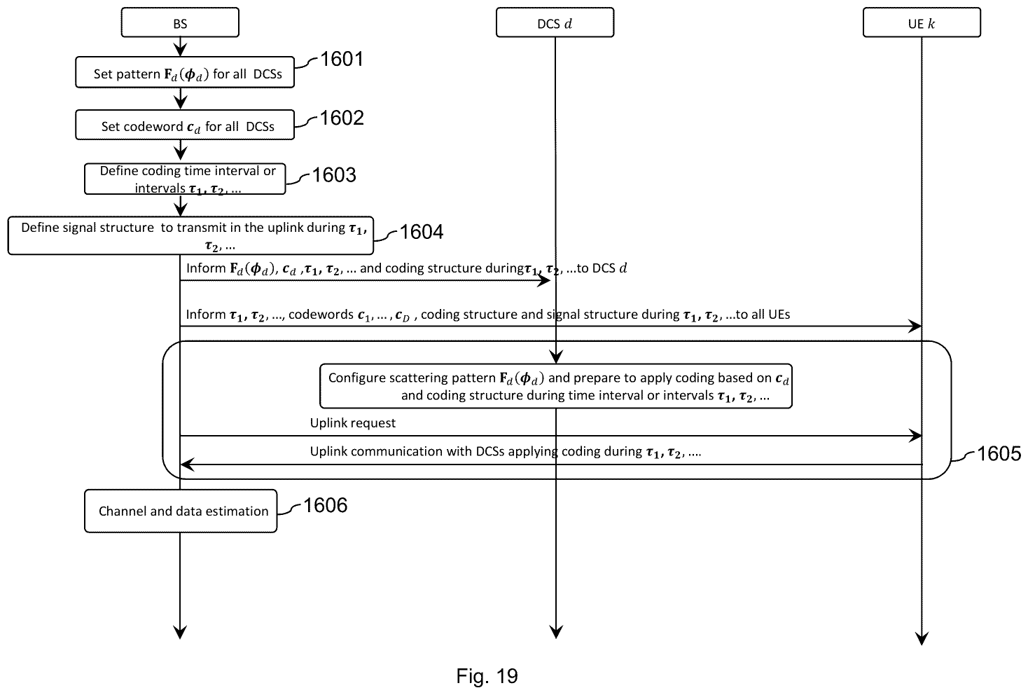

FIG. 19 shows an embodiment for uplink where the BS performs the base phase shift pattern assignment step 1601, the codeword assignment step 1602, the coding time interval assignment step 1603 and the transmission signal assignment step 1604. The BS informs each DCS d=1, . . . , D of its assigned codeword c_{d} and its underlying scattering pattern F_{d}(ϕ_{d}) and informs each UE k=1, . . . , K of the codewords c₁, . . . , c_{D} that are used by the DCSs. The BS also informs each DCS d and UE k of the one τ₁ or more coding time intervals τ₁, τ₂, . . . , in particular of its starting time and duration and of the coding structure during the one τ₁ or more coding time intervals τ₁, τ₂, . . . . For example, in the embodiment described above with reference to FIG. 14, the coded scattering pattern sequence is repeated over multiple OFDM symbols. Hence, this is communicated to the DCSs and the UEs. The BS also informs the UEs of the signal structure during the one or more coding time intervals r. For example, in the embodiment described above with reference to FIG. 10, M OFDM symbols are repeated T times during the one coding time interval τ₁. Hence, the users need to know about this repetitive structure, but the exact data to be transmitted does not need to be prescribed. GPS signals can be used in order to synchronize the DCSs. Such a GPS based synchronization is already used in 5G in order to synchronize eNBs. Corresponding techniques can be used for the synchronization of the individual DCSs. In the DCS operation step 1605, uplink communication is performed with each DCS d applying the scattering pattern F_{d} (ϕ_{d}) outside the one τ₁ or more coding time intervals τ₁, τ₂, . . . and coding based on the coded scattering pattern [c_{d}¹F_{d}(ϕ_{d}), c_{d}²F_{d}(ϕ_{d}), . . . , [symbol] F_{d}(ϕ_{d}), . . . , c_{d}^{T}F_{d}(ϕ_{d})] is applied during the one T₁ or more coding time intervals τ₁, τ₂, . . . In the signal component separation and channel estimation step 1606, the signal received and the knowledge of c₁, . . . , c_{D} and τ₁, τ₂, . . . is used for channel estimation.

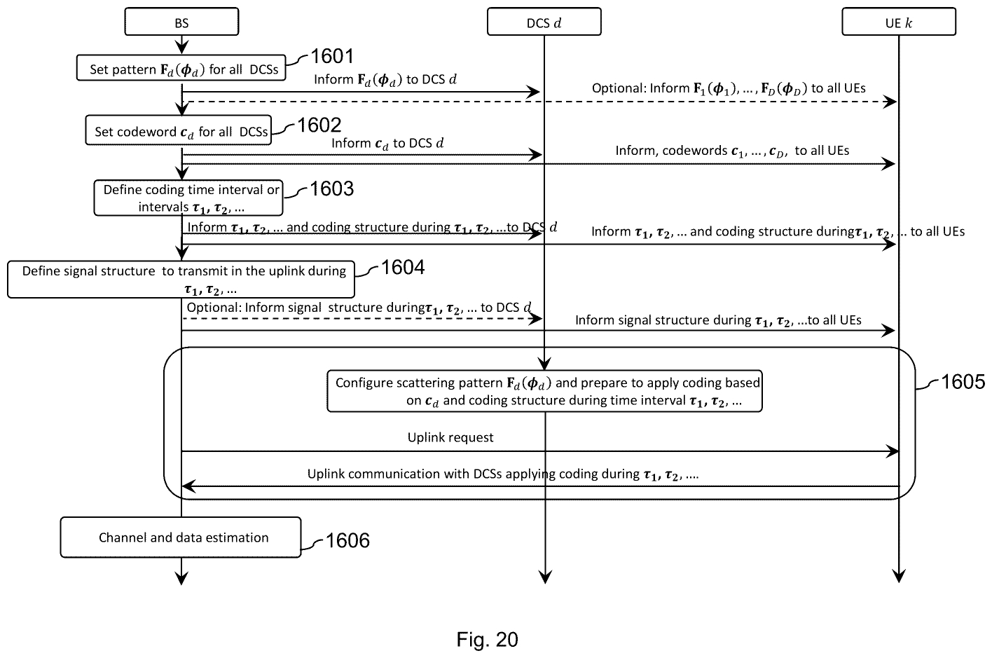

Another embodiment for signaling in the uplink is shown in FIG. 20 where the information about F_{d} (ϕ_{d}), c₁, . . . , c_{D}, τ₁, τ₂, . . . , and coding during τ₁, τ₂, . . . is communicated in different signaling exchanges that happen after the completion of each step. As another uplink signaling embodiment, FIG. 21 shows a case where DCS d performs the base phase shift pattern assignment step 1601, the codeword assignment step 1602, the coding time interval assignment step 1603, and the transmission signal assignment step 1604.

### Embodiments for Signaling when Extra Logical Entities Perform Part of the Steps

FIG. 22 and FIG. 23 depict a variation of the sinaling embodiments and the integration of the scheme into a cellular communication network. FIGS. 22 and 23 show that, in addition to the BS, UEs and DCS, two extra logical entities that are involved in the process. These two entities, which are denoted as DCS Control Entity and Channel Estimation Entity (abbreviated as “Ch. Est. Entity” in FIGS. 22 and 23) can be independent entities in the network or fully integrated into one or more of the BS, UEs and DCS.

FIGS. 22 and 23 illustrate a downlink scenario but the extra logical entities can also be present and perform some of the steps in an uplink scenario.

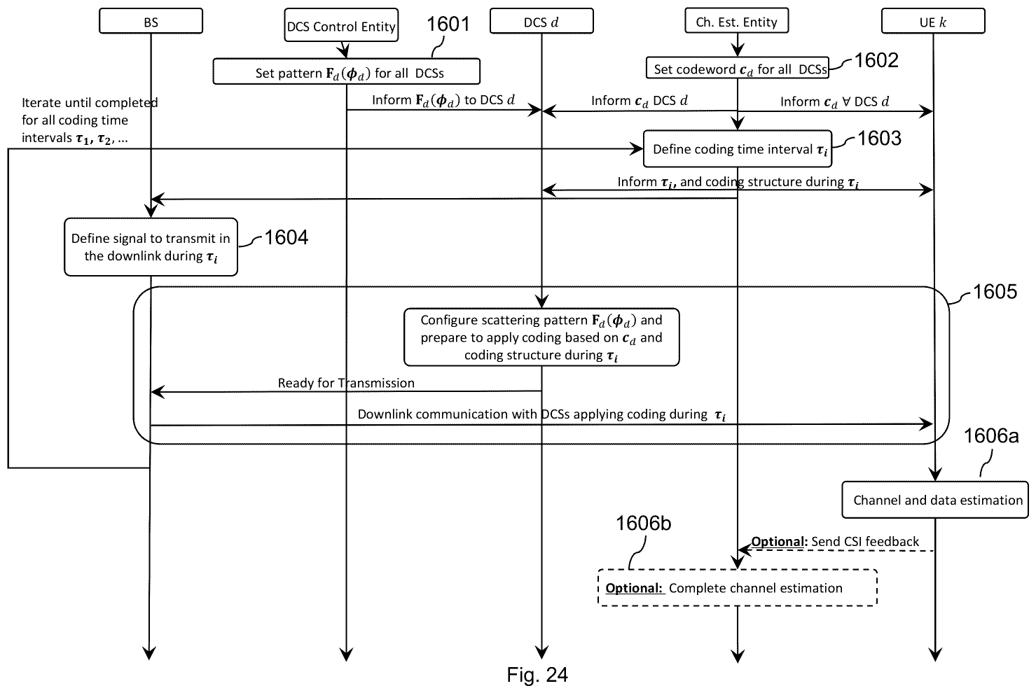

FIG. 24 depicts a variation of FIG. 22. In FIG. 24 one iteration per coding time interval consists of defining the interval, the signal to be transmitted during the interval, and performing the DCS operation and signal transmission step 1605 for the interval. Once iteration over each coding time interval is completed then the sytem can proceed to the signal sepration and channel estimation steps. In FIGS. 16 to 24, potential exchanges of signals are illustrated schematically. It is to be noted that as long as a logical order is respected such that the required information is present at the processing entities when needed, in embodiments, signal exchanges can be reordered, grouped and/or delayed.

The foregoing descriptions are merely specific implementations of this application, but are not intended to limit the scope of protection of this application. Any variation or replacement readily figured out by a person skilled in the art within the technical scope disclosed in this application shall fall within the scope of protection of this application. Therefore, the scope of protection of this application shall be subject to the scope of protection of the claims.

What is claimed is:

1. A communication arrangement, comprising:
one or more digitally controllable scatterers, DCSs;
assignment circuitry configured to assign a respective base phase shift pattern to each of the one or more DCSs; and
DCS control circuitry configured to operate, during a sequence of time intervals, each DCS of the one or more DCSs to provide a respective sequence of phase shift patterns that is obtained by applying, during each time interval of the sequence of time intervals, a respective additional phase shift from a sequence of additional phase shifts for the respective DCS to the base phase shift pattern assigned to the respective DCS.

2. The communication arrangement according to claim 1, wherein each of the one or more DCSs comprises a plurality of scattering elements, wherein the base phase shift pattern assigned to the respective DCS defines a respective phase shift value for each scattering element of at least a part of the plurality of scattering elements of the respective DCS, and wherein, for each time interval of the sequence of time intervals, the applying of the respective additional phase shift from the sequence of additional phase shifts for the respective DCS to the base phase shift pattern assigned to the respective DCS comprises adding, for each scattering element of the at least a part of the plurality of scattering elements, the respective additional phase shift for the respective time interval from the sequence of additional phase shifts for the respective DCS to the phase shift value for the respective scattering element defined by the base phase shift pattern.

3. The communication arrangement according to claim 2, wherein, for at least one of the one or more DCSs, the at least a part of the plurality of scattering elements of the respective DCS is a first part of the plurality of scattering elements of the respective DCS, a second part of the plurality of scattering elements of the respective DCS providing a virtual DCS, the assignment circuitry being configured to assign a base phase shift pattern of the virtual DCS to the virtual DCS, the base phase shift pattern of the virtual DCS defining a respective phase shift value for each scattering element of the second part of the plurality of scattering elements, and wherein the DCS control circuitry is configured to add, during each time interval of the sequence of time intervals, a respective additional phase shift from a sequence of additional phase shifts for the virtual DCS to each of the phase shift values for the scattering elements of the second part of the plurality of scattering elements that are defined by the base phase shift pattern for the virtual DCS, the sequence of additional phase shifts for the virtual DCS being different from the sequence of additional phase shifts for the respective DCS.

4. The communication arrangement according to claim 1, wherein the assignment circuitry is further configured to assign a respective codeword from a set of codewords to each of the one or more DCSs, and wherein, for each DCS, the sequence of additional phase shifts for the respective DCS is based on a sequence of codeword components of the codeword assigned to the respective DCS.

5. The communication arrangement according to claim 4, wherein the one or more DCSs are a plurality of DCSs, and each DCS is assigned a different codeword from the set of codewords.

6. The communication arrangement according to claim 4, wherein the codewords from the set of codewords are at least one of orthogonal and semi-orthogonal.

7. The communication arrangement according to claim 4, wherein, for each of the one or more DCSs, each additional phase shift of the sequence of additional phase shifts for the respective DCSs is selected such that by applying the respective additional phase shift to the base phase shift pattern assigned to the respective DCS, a phase shifted scattering pattern of the DCS is obtained which corresponds to a product of a codeword component of the codeword assigned to the respective DCS and a base scattering pattern of the DCS that is obtained when the DCS provides the base phase shift pattern of the DCS.

8. The communication arrangement according to claim 1, further comprising signal component separation circuitry configured to obtain reception information from one or more first communication nodes, CNs, the reception information being based on a reception, by the one or more first CNs, of one or more transmission signals transmitted by one or more second CNs during the sequence of time intervals, wherein the reception information comprises a representation of at least a part of one or more signals received by the one or more first CNs in response to the transmission of the one or more transmission signals by the one or more second CNs during the sequence of time intervals, and wherein the signal component separation circuitry is configured to apply a transformation to the representation of the at least a part of the one or more signals received by the one or more first CNs to separate one or more signal components of the at least a part of the one or more signals that were received by the one or more first CNs via the one or more DCSs.

9. The communication arrangement according to claim 8, wherein the transformation is a linear transformation.

10. The communication arrangement according to claim 8, further comprising:
channel estimation circuitry configured to compute, on the basis of the reception information and the set of codewords, a channel estimate that comprises, for at least one DCS of the one or more DCSs, an estimate of at least one respective communication channel between at least one of the one or more first CNs and at least one of the one or more second CNs via the at least one of the one or more DCSs.

11. The communication arrangement according to claim 10, wherein the channel estimation circuitry is further configured to compute a representation of the one or more transmission signals transmitted by the one or more second CNs on the basis of an aggregate communication channel and a result of the transformation, and to compute the channel estimate on the basis of the computed one or more transmission signals and the result of the transformation.

12. The communication arrangement according to claim 8, wherein the time intervals of the sequence of time intervals are subintervals of a coding time interval.

13. The communication arrangement according to claim 12, wherein at least one of the one or more second CNs transmits a plurality of orthogonal frequency division multiplexing, OFDM, symbols during the coding time interval.

14. The communication arrangement according to claim 13, wherein each of the one or more second CNs has one or more antennas, and each of the one or more second CNs transmits, during each time interval of the sequence of time intervals, a number of OFDM symbols that corresponds to a total number of the antennas of the one of more second CNs.

15. The communication arrangement according to claim 8, wherein the transformation is based on a set of conjugate codewords for the set of codewords.

16. The communication arrangement according to claim 12, wherein at least one of the one or more second CNs transmits a single OFDM symbol during the coding time interval.

17. The communication arrangement according to claim 16, wherein the applying of the additional phase shifts of the sequence of additional phase shifts is repeated during each of a plurality of coding time intervals, and the reception information is based on a reception, by the one or more first CNs, of one or more transmission signals transmitted by the one or more second CNs during the plurality of coding time intervals, the transformation being applied to a representation of the received one or more transmission signals.

18. The communication arrangement according to claim 17, wherein each of the one or more second CNs has one or more antennas, wherein each of the one or more second CNs transmits a single OFDM symbol during each coding time interval of the plurality of coding time intervals, and wherein a number of the plurality of coding time intervals corresponds to a total number of the antennas of the one or more first CNs.

19. The communication arrangement according to claim 18, wherein the transformation is based on a model of phase variations induced by the application of the sequence of additional phase shifts during the transmission of the single OFDM symbol.

20. The communication arrangement according to claim 12, wherein the coding time interval corresponds to a sampling interval wherein the one or more signals received by the one or more first CNs in response to the transmission of the one or more transmission signals by the one or more second CNs are sampled.

21. The communication arrangement according to claim 8, wherein at least one of the one or more first CNs is a user equipment and at least one of the one or more second CNs is a base station.

22. The communication arrangement according to claim 8, wherein at least one of the one or more first CNs is a base station and at least one of the one or more second CNs is a user equipment.

23. A method of communication, comprising:
assigning a respective base phase shift pattern to each of one or more DCSs;
operating, during a sequence of time intervals, each DCS of the one or more DCSs to provide a respective sequence of phase shift patterns that is obtained by applying, during each time interval of the sequence of time intervals, a respective additional phase shift from a sequence of additional phase shifts for the respective DCS to the base phase shift pattern assigned to the respective DCS.

24. A computer program comprising instructions which, when carried out on a computer, cause the computer to perform a method according to claim 23.
